(19) United States
(12) Patent Application Publication
(10) Pub. No.: US 2013/0268558 A1
(43) Pub. Date: Oct. 10, 2013

(54) Methods and Systems of Aggregating Information of Social Networks Based on Changing Geographical Locations of a Computing Device Via a Network

(71) Applicant: SNAP TRENDS, INC., Austin, TX (US)

(72) Inventor: Brandon C. Burris, Austin, TX (US)

(73) Assignee: SNAP TRENDS, INC., Austin, TX (US)

(21) Appl. No.: 13/787,896

(22) Filed: Mar. 7, 2013

Related U.S. Application Data
(63) Continuation-in-part of application No. 13/677,158, filed on Nov. 14, 2012.
(60) Provisional application No. 61/607,971, filed on Mar. 7, 2012.
(60) Provisional application No. 61/705,516, filed on Sep. 25, 2012.

(51) Int. Cl. G06F 17/30

(52) U.S. Cl. CPC G06F 17/30545
USPC 707/770

(57) ABSTRACT

One or more systems, devices, methods, and/or processes described can apply searches and/or filters to data of social networks with respect to one or more geographical locations, geospatial references, location-based contexts, and/or map-based references. A geographical search region can be associated with a computing device of a user and with locations of the computing device, including the ability to track the computing device with the geographical search region along a path of movement of the computing device. Other geographical search regions can be associated with other computing devices that were included within the geographical search region and can be associated with locations of the other computing devices. One or more social networks can be queried with search and/or filter parameters based on the geographical search regions of respective computing devices, and user-provided social network communications and information within the geographical search regions of the respective computing devices can be received based on the queries.

### PRIORITY

This application is a continuation-in-part and claims benefit of U.S. application Ser. No. 13/677,158, filed 14 Nov. 2012, titled “METHODS AND SYSTEMS OF AGGREGATING INFORMATION OF SOCIAL NETWORKS BASED ON GEOGRAPHICAL LOCATIONS VIA A NETWORK”, and claims benefit of U.S. Provisional Application Ser. No. 61/607,971, filed 7 Mar. 2012, titled “An automated web based software platform for aggregating content from social network via geospatial reference” and claims benefit of U.S. Provisional Application Ser. No. 61/705,516, filed on 25 Sep. 2012, titled “METHODS AND SYSTEMS OF AGGREGATING INFORMATION OF SOCIAL NETWORKS BASED ON GEOGRAPHICAL LOCATIONS VIA A NETWORK”. Each of U.S. application Ser. No. 13/677,158, filed 14 Nov. 2012, titled “METHODS AND SYSTEMS OF AGGREGATING INFORMATION OF SOCIAL NETWORKS BASED ON GEOGRAPHICAL LOCATIONS VIA A NETWORK”, U.S. Provisional Application Ser. No. 61/607,971, filed 7 Mar. 2012, titled “An automated web based software platform for aggregating content from social network via geospatial reference”, and U.S. Provisional Application Ser. No. 61/705,516, filed on 25 Sep. 2012, titled “METHODS AND SYSTEMS OF AGGREGATING INFORMATION OF SOCIAL NETWORKS BASED ON GEOGRAPHICAL LOCATIONS VIA A NETWORK” is hereby incorporated by reference in its entirety as though fully and completely set forth herein.

### BACKGROUND

1. Technical Field

This disclosure relates generally to the field of social media data search and/or analytics. More specifically, this disclosure relates to the field of searching and/or analyzing data of one or more social networks with references to geographical locations.

2. Description of the Related Art

Social networks receive data from their users and provide a social structure of sets of individuals, groups, and/or organizations with multiple dyadic associations and/or ties between or among the sets of individuals, groups, and/or organizations. For example, a social network can receive data provided by a user and share the received data with other users affiliated with the user and/or affiliated with other users affiliated with one or more groups and/or organizations. In one instance, the data provided by the user may include a status (e.g., a personal status), a picture, a motion picture (e.g., a video), a rating of a venue, a review of a venue, or an action or activity of the user. In another instance, the data provided by the user may include a message for one or more other users affiliated with and/or related to the user. Massive amounts of useful data have been accumulated on social networks but have not been strongly leveraged for use in security, marketing, or other applications. In particular, the related art has not used geospatial references, location-based context, or a map-based interface in ascertaining the meanings and relevance of this useful data or assisting in drawing conclusions based on the geographical aspects of this data.

### BRIEF DESCRIPTION OF THE DRAWINGS

The embodiments will become apparent upon reading the following detailed description and upon reference to the accompanying drawings as follows:

FIG. 1 provides a block diagram of one or more communications systems, according to one or more embodiments;

FIG. 2 provides a block diagram of a social media query system, according to one or more embodiments;

FIG. 3 provides a method of selecting a geographic area, according to one or more embodiments;

FIGS. 4-8 illustrate search regions of a map, according to one or more embodiments;

FIG. 9 provides an exemplary method of supporting a custom search region shape, according to one or more embodiments;

FIG. 10 illustrates edges of a custom search region shape covered by shapes of search regions supported by a social media data source, according to one or more embodiments;

FIG. 11 illustrates an interior of the custom search region shape covered by shapes of search regions supported by a social media data source;

FIG. 12 provides an exemplary block diagram of a computer system, according to one or more embodiments;

FIG. 13 illustrates a mobile computer system, according to one or more embodiments;

FIG. 14 provides an exemplary method of providing location-based information to a computing device, according to one or more embodiments;

FIG. 15 illustrates an exemplary diagram of computing devices at locations which can be included in a region, according to one or more embodiments;

FIG. 16 illustrates an exemplary method of providing location-based information to a computing device, according to one or more embodiments;

FIG. 17 provides an exemplary method of changing a position of a search region, according to one or more embodiments;

FIG. 18 provides an exemplary method of changing a size of a search region, according to one or more embodiments;

FIGS. 19-21 illustrates exemplary search regions at various positions and/or of various sizes, according to one or more embodiments;

FIG. 22 provides exemplary search results via a map, according to one or more embodiments;

FIG. 23 provides an exemplary illustration of search regions associated with computing devices, according to one or more embodiments;

FIGS. 24-26 provide exemplary portrayals of search regions moving and/or propagating with and/or when computing devices move and/or propagate, according to one or more embodiments;

FIG. 27 illustrates an exemplary scenario that groups multiple computing devices and/or users via multiple search regions, according to one or more embodiments;

FIG. 28A provides an exemplary diagram of a search region propagating through multiple positions and/or locations, according to one or more embodiments;

FIG. 28B provides an exemplary diagram of a search region propagating through multiple positions and/or locations and remaining for an amount of time transpiring, according to one or more embodiments;

FIG. 29 illustrates an exemplary search region associated with an exemplary path, according to one or more embodiments;

FIGS. 30 and 31 illustrate an exemplary search region at multiple positions associated with an exemplary path, according to one or more embodiments;

FIG. 32 illustrates an exemplary method that moves and/or propagates a search region corresponding to and/or associated with a computing device when the computing device moves and/or propagates, according to one or more embodiments;

FIG. 33 illustrates an exemplary method that associates and/or instantiates a search region corresponding to and/or associated with a computing device is illustrated, according to one or more embodiments;

FIG. 34 provides an exemplary block diagram of a monitor device, according to one or more embodiments;

FIGS. 35-38 illustrate exemplary network configurations that utilize a monitor device, according to one or more embodiments;

FIG. 39 illustrates an exemplary method of operating a monitor, according to one or more embodiments;

FIG. 40 illustrates an exemplary method of censoring information, according to one or more embodiments; and

FIG. 41 illustrates an exemplary method of generating one or more of an advertisement and a promotion based on at least two locations associated with a computing device, according to one or more embodiments; and

FIG. 42 provides an exemplary method of generating one or more of an advertisement and a promotion based on at least two locations associated with respective two computing devices utilized by a user, according to one or more embodiments.

While one or more embodiments may be susceptible to various modifications and alternative forms, specific embodiments thereof are shown by way of example in the drawings and will herein be described in detail. It should be understood, however, that the drawings and detailed description thereto are not intended to limit the disclosure to the particular form disclosed, but on the contrary, the disclosure is to cover all modifications, equivalents and alternatives falling within the spirit and scope of this disclosure.

### DETAILED DESCRIPTION

In one or more embodiments, systems, methods, and/or processes described herein can provide one or more interfaces that can search and/or filter data and/or communications of social networks (e.g., Facebook, Twitter, YouTube, Weibo, a blog, a wiki, Foursquare, Instagram, Flickr, Vimeo, Yelp, etc.) with respect to one or more of geospatial references, location-based contexts, and/or map-based references, among others. For example, user input can be received that can move a searchable eye of variable dimension about a map interface to denote a search region, and data associated with one or more social networks can be searched and/or filtered with respect to the denoted search region. For instance, one or more social networks can be queried with one or more search and/or filter parameters and one or more geographic locations associated with the denoted search region, and one or more results can be received from the one or more social networks, where the results can be based on the one or more search and/or filter parameters and one or more geographic locations associated with the denoted search region. In one or more embodiments, the results can include what users of one or more social networks have communicated (e.g., text, sounds, speech, singing, drawing, graphics, video, etc.) and where the users of the one or more social networks were when their respective communications (e.g., text, sounds, speech, singing, drawing, graphics, video, etc.) were provided to and/or received from the one or more social networks, among others.

In one or more embodiments, a search region corresponding to and/or associated with a computing device can move and/or propagate with and/or when the computing device moves and/or propagates. In one or more embodiments, one or more methods, processes, and/or systems provides and/or implements a search region that moves and/or propagates with a user and/or a computing device of the user, which can be included in a mobile lens system.

In one or more embodiments, subject-related groups can be defined and/or categorized by one or more of discussion and affinity criteria, among others. For example, one or more of time/subject phases of dominance by individuals, individual participant relationship to one or more groups, and individuals to their respective network of contacts, among others, can be mapped and/or stored. For instance, one or more phases of dominance can include one or more of a rating from a user, a number of followers, a number of posts, and a number of friends, among others.

In one or more embodiments, a first user or entity can monitor communications of a second user and/or associated with a second user via grouping and/or a mobile lens system. In one example, a parent can monitor, via grouping and/or a mobile lens system, social network communications of a child of the parent and/or social network communications of computing devices and/or users of the computing devices around the child over a period of time transpiring and/or as the child moves from place to place. In a second example, a school administrator can monitor, via grouping and/or a mobile lens system, social network communications of a student and/or social network communications of computing devices and/or users of the computing devices around the student over a period of time transpiring and/or as the student moves from place to place. In a third example, a law officer can monitor, via grouping and/or a mobile lens system, social network communications of a person (e.g., a confidential informant, a person of interest, a suspect, etc.) and/or social network communications of computing devices and/or users of the computing devices around the person over a period of time transpiring and/or as the person moves from place to place. In a fourth example, a rating entity (e.g., a television rating entity, Nielson rating entity, a music rating entity, Billboard rating entity, etc.) can monitor, via grouping and/or a mobile lens system, social network communications of one or more persons and/or social network communications of computing devices and/or users of the computing devices around the one or more persons over a period of time transpiring and/or as the one or more persons moves from place to place. For instance, the rating entity can determine and/or formulate a survey and/or an unbiased survey of one or more performances, of one or more advertisements, and/or of promotions, via grouping and/or a mobile lens system extracting and analyzing social network communications having geospacial and/or grouping associations.

In one or more embodiments, a search region corresponding to and/or associated with a computing device can move and/or propagate with and/or when the computing device moves and/or propagates through and/or via multiple positions with a location and/or through and/or via multiple locations. In one or more embodiments, utilization of a mobile lens system can provide information as to what people are communicating social network databases, including social network websites, about and/or related to a vehicle traversing a path (e.g., path 29310) and/or about the vehicle that traversed the path. For example, the vehicle can be associated with one or more of a corporation, an armed service, a country, a service, and an operator of the vehicle, among others, and a mobile lens system can provide information as to what people are communicating about the one or more of the corporation, the armed service, the country, the service, and the operator of the vehicle, among others. In one instance, the mobile lens system can provide one or more portions of social network data communications and/or one or more portions of information of one or more social networks that corresponds to one or more of the vehicle, the corporation, the armed service, the country, the service, and the operator of the vehicle, among others. For example, a mobile lens system can provide a search region tracking the movements of a vehicle such as a military vehicle and retrieve social network data communications originating from computing devices, such as computing devices of combatants, along the path of movement of the vehicle within a geographical area based on user-provided social network communications and/or data provided within the search region tracking the vehicle along the path.

In one or more embodiments, mood and/or sentiment relations can be correlated, interpreted, interpolated, and/or extrapolated with respect to what users of one or more social networks have communicated (e.g., text, sounds, speech, singing, drawing, graphics, video, etc.), where the users of the one or more social networks were when their respective communications (e.g., text, sounds, speech, singing, drawing, graphics, video, etc.) were provided to the one or more social networks, and associated with and/or corresponding to one or more of a purchase, a transaction, a product, a service, a concept, an advertisement, a festival, a performance, a story, a concert, a band, a musical group, a performer, an entertainer, a radio station, a song, a piece of music, a motion picture, a video, a park, an airport, a city, a restaurant, and a business entity, among others.

In one example, a mood and/or sentiment relation can include a positive mood and/or relation. For instance, a positive mood and/or relation can include and/or be associated with one or more words, such as: appreciate, calm, celebratory, cheerful, comic, earnest, ecstatic, encourage, enlightened, enthrall, euphoric, excited, exhilarate, dreamy, fabulous, friendly, funny, giddy, gleeful, grateful, great, good, happy, hilarious, impress, joyful, liberate, like, light-hearted, lively, love, optimistic, pleased, proud, respectful, tasty, trustful, zealous, etc.

In another example, a mood and/or sentiment relation can include a negative mood and/or relation. In one instance, a negative mood and/or relation can include and/or be associated with one or words, such as: abhorrent, antagonistic, bad, bitter, bossy, crappy, condescend, derogatory, diabolic, disappointed, disrespectful, fearful, forceful, forebode, greed, gloom, hate, heartbroken, hopeless, horrible, impatient, incredulous, insolent, indignant, irate, irritate, mad, mock, pissed off, pretentious, psychotic, reject, sad, sarcastic, scare, severe, selfish, shock, sick, silly, sinister, skeptical, sly, stern, stressful, suspicious, tense, terrible, threatening, tragic, uncomfortable, uneasy, unsympathetic, upset, violent, wry, worry, etc. In another instance, a negative mood and/or relation can include and/or be associated with one or more profanities.

In one or more embodiments, mood and/or sentiment relations can provide one or more contexts corresponding to and/or associated with what users of one or more social networks have communicated (e.g., text, sounds, speech, singing, drawing, graphics, video, etc.), where the users of the one or more social networks were when their respective communications (e.g., text, sounds, speech, singing, drawing, graphics, video, etc.) were provided to and/or received from the one or more social networks, and one or more of a purchase, a transaction, a product, a service, a concept, an advertisement, a festival, a concert, a band, a musical group, a performance, a story, a performer, an entertainer, a radio station, a song, a piece of music, a motion picture, a video, a park, an airport, a city, a restaurant, and a business entity, among others.

In one or more embodiments, a combination of multiple locations of each user of multiple users of one or more social networks can be utilized in determining and/or providing subject-related groups, mood and/or sentiment relations, and/or contexts corresponding to and/or associated with what the users of the one or more social networks have communicated (e.g., text, sounds, speech, singing, drawing, graphics, video, etc.) at each of the multiple locations of each user. In one example, a first combination of first multiple locations where a first user, of the one or more social networks, has been and what the first user has communicated at each of the first multiple locations can be utilized in determining and/or providing one or more subject-related groups, one or more mood and/or sentiment relations, and/or one or more contexts corresponding to and/or associated with one or more of a first purchase, a first transaction, a first product, a first service, a first advertisement, a first festival, a first performance, a first story, a first concert, a first radio station, a first song, a first piece of music, a first motion picture, a first video, a first park, a first airport, a first city, a first restaurant, and a first business entity, among others. In another example, a second combination of second multiple locations where a second user, of the one or more social networks, has been and what the second user has communicated at each of the second multiple locations can be utilized in determining and/or providing one or more subject-related groups, one or more mood and/or sentiment relations, and/or one or more contexts corresponding to and/or associated one or more of a second purchase, a second transaction, a second product, a second service, a second advertisement, a second festival, a second performance, a second story, a second concert, a second radio station, a second song, a second piece of music, a second motion picture, a second video, a second park, a second airport, a second city, a second restaurant, and a second business entity, among others.

In one or more embodiments, at least one of the first purchase, the first transaction, the first product, the first service, the first advertisement, the first festival, the first performance, the first story, the first concert, the first radio station, the first song, the first piece of music, the first motion picture, the first video, the first park, the first airport, the first city, the first restaurant, and the first business entity can be different from at least one of the second purchase, the second transaction, the second product, the second service, the second advertisement, the second festival, the second performance, the second story, the second concert, the second radio station, the second song, the second piece of music, the second motion picture, the second video, the second park, the second airport, the second city, the second restaurant, and the second business entity, respectively. In one or more embodiments, at least one of the first purchase, the first transaction, the first product, the first service, the first advertisement, the first festival, the first performance, the first story, the first concert, the first radio station, the first song, the first piece of music, the first motion picture, the first video, the first park, the airport, the first city, the first restaurant, and the first business entity can be the same as at least one of the second purchase, the second transaction, the second product, the second service, the second advertisement, the second festival, the second performance, the second story, the second concert, the second radio station, the second song, the second piece of music, the second motion picture, the second video, the second park, the second airport, the second city, the second restaurant, and the second business entity, respectively.

In one or more embodiments, queries can be saved with their geospatial references and their search and/or filter parameters. For example, one or more saved queries can continue to run and/or execute over one or more periods of time transpiring. In one or more embodiments, queries can be saved with their geospatial references and their search and/or filter parameters. For example, one or more saved queries can continue to run and/or execute over one or more periods of time transpiring. In one or more embodiments, methods, processes, and/or systems can query a social network with one or more search and/or filter parameters and one or more geographic locations associated with a denoted search region. For example, the social network can be queried via an application programming interface (API). For instance, the social network can provide the API.

In one or more embodiments, the social network can be queried via a network (e.g., a public network, a private network, etc.), and one or more results of the query can be received via the network. In one example, the API can include a hypertext transfer protocol (HTTP) interface, and the social network can be queried via the HTTP interface. In a second example, the API can include a hypertext transfer protocol secure (HTTPS) interface, and the social network can be queried via the HTTPS interface. In another example, the API can be utilized with one or more secure communication methods, processes, and/or systems. For instance, the API can be utilized with and/or via one or more of a virtual private network, a secure tunnel, a secure socket layer (SSL), and a transport layer security (TLS) protocol, among others.

In one or more embodiments, the one or more results of the query of the social network can be provided to a user as the one or more results become available from the social network. In one example, the one or more results can be provided to a user via a user interface (e.g., a graphical user interface) as the one or more results become available from the social network. In another example, the one or more results can be provided to a user via an alert as the one or more results become available from the social network or a monitoring service.

In one or more embodiments, the one or more results of a query of the social network can be received over one or more periods of time transpiring. For example, one or more queries can be provided to a social media network data source (e.g., a data source that can store social media network data), the one or more queries can be saved (e.g., stored) with their geospatial references and their search and/or filter parameters, an amount of time can transpire, the one or more queries can be retrieved (e.g., retrieved from storage), the one or more queries can be provided (again, in a repeated fashion, etc.) to the social media network data source, and one or more search results can be received from the social media network data source. For instance, running and/or executing one or more saved queries can provide continual and/or periodic reporting.

In one or more embodiments, one or more methods, processes, and/or systems, described herein, can utilize one or more event-driven social network media data source methods, processes, and/or systems. In one example, one or more events can be generated (e.g., a data ready event, a timer event, a timeout event, a periodic timer event, a processing system ready event, a data send event, etc.), and one or more event handlers can perform one or more methods and/or processes in response to the one or more events. In one instance, the one or more event handlers can receive and/or process data associated with the one or more events. In a second instance, the one or more event handlers can provide data in response to the one or more events. In another instance, the one or more event handlers can generate one or more additional events in response to the one or more events.

In one example, a data ready event can be generated when data has been received from a social media network data source, and a data ready event handler can process the data received from the social media network data source. In a second example, a timeout event can be generated, and a timeout event handler can retrieve (e.g., retrieve from storage) one or more queries saved queries and can provide the one or more queries saved queries to a social media network data source. In one instance, a timer can be set with an amount of time to transpire, and the timeout event can be generated in response to the amount of time transpiring. In another instance, a timer can be set with a time (e.g., 10:30, 16:45 on 11 Dec. 2012, 23:02 on 26 July, etc.), and the timeout event can be generated in response to the time occurring.

In another example, a periodic timeout event can be generated, and a periodic timeout event handler can retrieve (e.g., retrieve from storage) one or more queries saved queries and can provide the one or more queries saved queries to a social media network data source. In one instance, a periodic timer can be set with an amount of time to transpire, and the periodic timeout event can be generated in response to the amount of time transpiring. In one or more embodiments, the periodic timeout event can be generated, repeatedly, in response to each repetition of the amount of time transpiring. For example, one or more methods, processes, and/or systems, described herein, can query a social media data source at a time interval.

In one or more embodiments, one or more methods, processes, and/or systems, described herein, can query the social network in a continuous fashion. For example, the social network can be queried until one or more results are received or until an amount of time has transpired. For instance, one or more methods, processes, and/or systems, described herein, can query the social network in a background process and/or in an automated batch. For example, one or more saved queries can continue to run and/or execute over one or more periods of time transpiring. For instance, running and/or executing one or more saved queries can provide continual and/or periodic reporting.

In one or more embodiments, methods, processes, and/or systems, described herein, can provide and/or implement one or more user interfaces. For example, the one or more user interfaces can provide one or more of social network query results, statistical analyses of data from the social network query results, one or more charts (e.g., a chart illustrating a number of results returned vs. each time the query was performed), a review of results determined and content that was saved, and/or some or all of the social network query results layered over a map, among others. In one or more embodiments, one or more of social network query results and statistical analyses of data from the social network query results, among others, can be utilized in training a neural network. For example, trainable data sets can be utilized for pattern initial guidance. For instance, one or more methods and/or processes can be trained from data sets and can automatically acquire an artificial intelligence to increase one or more of group, individual, and intent mapping aptitude over a period of time.

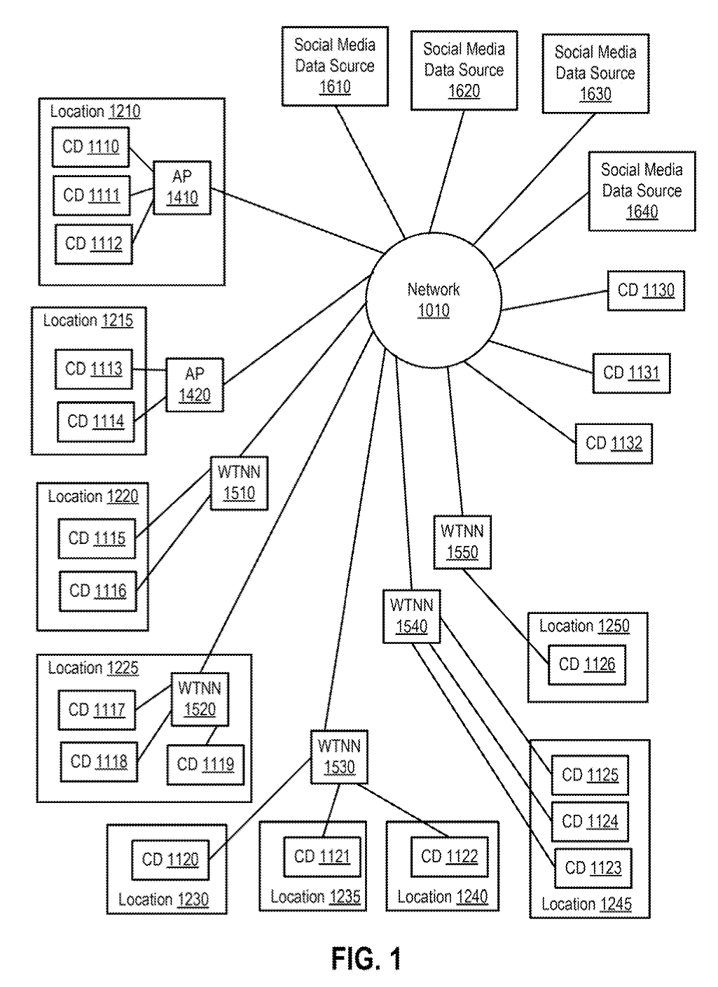

Turning now to FIG. 1, one or more network systems are illustrated, according to one or more embodiments. As shown, one or more social media data sources 1610-1640 can be coupled to a network 1010. In one or more embodiments, a social media data source (which can also be referred to as a social network media data source) can include a social media service and/or one or more computer systems that are operated and/or controlled by the social media service. For example, the social media service can provide and/or include one or more web-based interfaces (e.g., one or more websites and/or one or more network-based application programming interfaces) and/or mobile-based technologies and/or services that can facilitate and/or implement communications and/or interactive dialogues among related individuals, organizations, and/or communities, among others. For instance, the social media service can provide and/or implement Internet-based applications (e.g., websites, network-based programming interfaces, etc.) that can facilitate and/or provide a creation and/or an exchange of user input (e.g., user-generated data, user-provided content, etc.). In one example, social media data sources 1610-1640 can include Facebook, Twitter, YouTube, and Weibo. In another example, the social media data sources can include MySpace, Friendster, a blog, a wiki, Foursquare, Instagram, Flickr, Vimeo, and Yelp, among others.

In one or more embodiments, one or more of social media data sources 1610-1640 can provide application programming interfaces that provide functionalities that can receive one or more queries and can provide social media data corresponding to and/or associated with the one or more queries. For example, social media data source 1610 can receive a query associated with one or more of a word, a phrase, a mood, a sentiment, a user profile, a portion of a user profile, a regular expression, a natural language filter, a grammar (e.g., a set of formation rules for strings in a language, a context-free grammar, a regular grammar, a tree-adjoining grammar, an affix grammar, an attribute grammar, an adaptive grammar, an ambiguous grammar, a categorical grammar, etc.), a social group, an organization, a user identification, and/or a location, among others, and can provide social media data that is associated with and/or corresponds to at least one of the word, the phrase, the grammar, the regular expression, the user profile, the portion of the user profile, the social group, the organization, the user identification, and the location. For instance, social media data source 1610 can receive a query associated with one or more locations and provide the location-based social media data matching that query via network 1010. In one or more embodiments, a user profile can include one or more of a user name, a user identification, a mobile telephone number, an email address, a physical address, an occupation, a gender, a marital status, a past purchase, an interest, a past transaction, a shoe size, an age, one or more clothing sizes, a political affiliation, a monthly include, a yearly income, an employment status, a credit history, a credit rating, an eye color, a hair color, a music genre, and a membership, among others.

As illustrated, computing devices (CDs) 1110-1112 and an access point (AP) 1410 can be at and/or associated with a location 1210, and CDs 1110-1112 can be coupled to AP 1410 that can be coupled to network 1010. In one or more embodiments, AP 1410 can communicate with one or more computing devices in one or more of a wired fashion and a wireless fashion. In one example, AP 1410 can communicate with one or more of CDs 1110-1112 in a wired fashion. For instance, AP 1410 can communicate with CDs 1110-1112 via one or more of wired Ethernet, fiber optics, wired universal serial bus (USB), digital subscriber loop (DSL), and coaxial cable (e.g., cable TV), among others.

In another example, AP 1410 can communicate with one or more of CDs 1110-1112 in a wireless fashion. For instance, AP 1410 can communicate with CDs 1110-1112 via one or more of wireless Ethernet (e.g., WiFi), Institute of Electrical and Electronics Engineers (IEEE) 802.11, IEEE 802.16, WiMAX, Bluetooth, IEEE 802.15, ZigBee, Z-Wave, ultra wideband, IEEE 802.15.4, and wireless USB, among others. In one or more embodiments, an AP can include a transceiver to communicate with computing devices utilizing one or more wireless methods, processes, wireless spectrums (e.g., frequency ranges), protocols, and/or systems. For example, an AP can communicate with computing devices utilizing ISM (industrial, scientific and medical) bands. For instance, an ISM band can include a frequency range of 6.765-6.795 Mhz, 433.05-434.79 Mhz, 902-928 Mhz, 2.4-2.5 Ghz, 5.725-5.875 Ghz, or 24.0-24.25 Ghz, among others.

As shown, CDs 1113 and 1114 can be at and/or associated with a location 1215, CDs 1113 and 1114 can be coupled to an AP 1420 that can be coupled to network 1010. In one or more embodiments, AP 1420 can include one or more structures and/or functionalities described with reference to AP 1410. For example, AP 1420 can communicate with one or more computing devices in one or more of a wired fashion and a wireless fashion. As illustrated, AP 1420 may not be at and/or associated with a location 1215, according to one or more embodiments.

As shown, CDs 1115 and 1116 can be at and/or associated with a location 1220, and CDs 1115 and 1116 can be coupled to a wireless telephone network node (WTNN) 1510 that can be coupled to network 1010. In one example, WTNN 1510 can include one or more of a base station subsystem (BSS), a base station controller (BSC), and a base transceiver station (BTS) that can be coupled to network 1010. In a second example, WTNN 1510 can include one or more of a radio network controller (RNC) and a Node B. For instance, a Node B can include and/or denote a BTS of a universal mobile telecommunications system (UMTS) and can include one or more transmitters, one or more receivers, one or more transceivers, and/or one or more antennas. In another example, a WTNN can include a satellite that can orbit a planet (e.g., Earth) and can be wirelessly coupled to network 1010. For instance, the WTNN can orbit the planet in a low planetary orbit (e.g., a low Earth orbit), a medium planetary orbit (e.g., a medium Earth orbit), a geostationary orbit, a high planetary orbit (e.g., a high Earth orbit), a semi-synchronous orbit, or a geosynchronous orbit, among others.

In one or more embodiments, a WTNN can communicate with one or more computing devices via one or more protocols such as one or more of wideband code division multiple access (WCDMA), time division synchronous code division multiple access (TD-SCDMA), code division multiple access (CDMA), time division multiple access (TDMA), GSM (global system for mobile communications), long term evolution (LTE), general packet radio service (GPRS), enhanced GPRS (EGPRS), frequency division multiple access (FDMA), and enhanced data rates for GSM evolution (EDGE), among others. In one or more embodiments, a WTNN can include one or more transmitters, one or more receivers, one or more transceivers, one or more antennas, and/or one or more cryptography devices that can be used to wirelessly communicate with one or more computing devices. In one example, the one or more antennas of the WTNN can be mounted on a mast, on a tower (e.g., a cellular telephone communications tower), on a side of a structure (e.g., a building, a parking garage, a lamp post, etc.), and/or on a roof of a building, among others.

As illustrated, CD 1117-1119 and a WTNN 1520 can be at and/or associated with a location 1225, and CDs 1117-1119 can be coupled to WTNN 1520 that can be coupled to network 1010. In one or more embodiments, WTNN 1520 can include one or more structures and/or functionalities described with reference to WTNN 1510. As shown, CDs 1120-1122 can be at and/or associated with respective locations 1230-1240, and CDs 1120-1122 can be coupled to a WTNN 1530 that can be coupled to network 1010. In one or more embodiments, WTNN 1530 can include one or more structures and/or functionalities described with reference to WTNN 1510. As shown, WTNN 1530 may not be at and/or associated with one or more of locations 1230-1240, according to one or more embodiments.

As illustrated, CD 1123-1125 can be at and/or associated with a location 1245, and CDs 1123-1125 can be coupled to WTNN 1540 that can be coupled to network 1010. In one or more embodiments, WTNN 1540 can include one or more structures and/or functionalities described with reference to WTNN 1510. As shown, WTNN 1540 may not be at and/or associated with location 1245, according to one or more embodiments. As illustrated, a computing device (CD) 1126 can be at and/or associated with a location 1250, and CD 1126 can be coupled to a WTNN 1550 that can be coupled to network 1010. In one or more embodiments, WTNN 1550 can include one or more structures and/or functionalities described with reference to WTNN 1510. As shown, WTNN 1550 may not be at and/or associated with location 1250, according to one or more embodiments. As illustrated, one or more CDs 1130-1132 can be coupled to network 1010.

In one or more embodiments, network 1010 and/or network 1014 can include a wired network, a wireless network or a combination of wired and wireless networks. Network 1010 and/or network 1014 can include and/or be coupled to various types of communications networks, such as a public switched telephone network (PSTN), an Internet, a wide area network (WAN) (e.g., a private WAN, a corporate WAN, a public WAN, etc.), a local area network (LAN), etc. In one or more embodiments, NMD 1020 can be coupled to a PSTN, e.g., Ethernet cable and DSL; a cable (television) based network; a satellite-based system; and/or a fiber based network; among others. In one or more embodiments, network 1010 can include one or more wireless networks, e.g., based on IEEE 802.11 and/or IEEE 802.16.

In one or more embodiments, network 1010 can be or include a communications network. In one example, network 1010 can be or include multiple networks and/or can be coupled to one or more other networks. For instance, network 1010 can be, include, or form part of a WAN. For instance, the WAN can include one or more of a private WAN, a corporate WAN, and a public WAN (e.g., an Internet), among others. In another example, network 1010 can be or include a telephone network. In one instance, network 1010 can be or include a PSTN. In a second instance, network 1010 can be or include a wired telephone network. In another instance, network 1010 can be or include a wireless telephone network (e.g., a cellular telephone network, a satellite telephone network, etc.).

In one or more embodiments, network 1010 can include and/or be coupled to various types of communications networks. For example, network 1010 can include and/or be coupled to a PSTN, an Internet, a WAN (e.g., a private WAN, a corporate WAN, a public WAN, etc.), and/or a LAN, among others. In one or more embodiments, network 1010 can include a wired network, a wireless network or a combination of wired and wireless networks. In one example, network 1010 can include and/or be coupled to coupled to a wired PSTN, a DSL network, a cable (television) based network, a satellite-based system and/or network, and/or a fiber based network; among others. In another example, network 1010 can include and/or be coupled to one or more wireless networks, e.g., based on IEEE 802.11, based on IEEE 802.16, based on a wireless PSTN, based on a wireless telecommunications network, etc.

In one or more embodiments, a network system can be or include a communication system. For example, a network system can be operated by a network provider. For instance, a first network system can be operated by a first network provider (e.g., AT&T, T-Mobile, Iridium Communications, Verizon Wireless, Globalstar, etc.), and a second network system can be operated by a second network provider (e.g., Time-Warner Cable, Wayport, Boingo, Qwest, CLEAR, Grande Communications, Cox, EarthLink, etc.).

In one or more embodiments, one or more of CDs 1110-1126 can be or include any of various types of devices, including a computer system, such as a desktop computer system, a portable computer, a laptop computer system, a personal digital assistant (PDA), a smart phone, a wireless telephone (e.g., a cellular telephone, a satellite telephone, etc.), a digital music player, a tablet computing device, a wearable computing device, a communications device, or other wired or wireless device. In one example, a first user can utilize CD 1110 at location 1210. For instance, CD 1110 can be or include a laptop computing device. In a second example, a second user can utilize CD 1111 at location 1210. For instance, CD 1111 can be or include a tablet computing device. In a third example, a third user can utilize CD 1113 at location 1215. For instance, CD 1113 can be or include a personal digital assistant. In another example, a fourth user can utilize CD 1115 at location 1220. For instance, CD 1115 can be or include a wireless telephone.

In one or more embodiments, respective users of CDs 1110, 1111, 1113, and 1115, at and/or associated with respective locations, can provide data to one or more social media services, where the user-provided data can be associated with and/or correspond to the respective locations. In one example, the first user can utilize CD 1110 to update a status (e.g., a personal status) on a first social media service (e.g., associated with social media data source 1610) such that the updated status corresponds to a location of CD 1110. For instance, the updated status information associated with location 1210 can be stored by first social media service such that the updated status is associated with location data such that the updated status corresponds to location 1210. In a second example, the second user can utilize CD 1111 to upload a picture and/or a motion picture (e.g., a video) to a second social media service (e.g., associated with social media data source 1620). For instance, the picture and/or the motion picture and information associated with location 1210 can be stored by second social media service such that the picture and/or the motion picture corresponds to location 1210. In a third example, the third user can utilize CD 1113 to rate and/or review a venue (e.g., a restaurant, a coffee shop, a movie theatre, a car wash, etc.) on a third social media service (e.g., associated with social media data source 1630). For instance, the rating and/or the review and information associated with location 1215 can be stored by third social media service such that the rating and/or the review correspond to location 1215.

In another example, the fourth user can utilize CD 1115 to update an action and/or activity on a fourth social media service (e.g., associated with social media data source 1640). In one instance, the action and/or the activity and information associated with location 1220 can be stored by the fourth social media service such that the action and/or the activity corresponds to location 1220. In another instance, the action and/or the activity can be related to the fourth user (e.g., entering a football stadium) or can be related to actions and/or activities of others in the vicinity of location 1220 (e.g., gunshot(s) fired, car crash, a parade, etc.). In yet another instance, the action and/or the activity can be related to the environment in the vicinity of location 1220 (e.g., building fire, brush fire, gas leak, explosion, lightening storm, earthquake, etc.).

In one or more embodiments, a location (e.g., a location of locations 1210-1250), associated with and/or corresponding to a computing device, can be determined. For example, a location, described herein, can be or include a geographical location. For instance, a location (e.g., a location of locations 1210-1250) can include one or more of a street number, a street, a zip code, a city, a state, a country, a unit identifier (e.g., a suite identifier, a condominium identifier, a hospital room identifier, an apartment identifier, a gate identifier of an airport, an airport identifier, etc.), a cell identification (cell ID or CID associated with a cellular telephone network), latitude information, longitude information, and altitude information, among others. In one or more embodiments, a location can be, include, or be associated with one or more of a voting district, a congressional district, a school district, a school, a campus, a dormitory, an oil pipeline, a sports complex, a police precinct, a piece of real estate, a neighborhood, a borrow, a city, a town, a commercial office building, a floor of a building, a factory, a refinery, a storage facility, a power station, a power substation, and a military installation, among others.

In one or more embodiments, a location (e.g., a location of locations 1210-1250) can be determined based on a location of an AP communicating with a computing device. For example, one or more of CDs 1110-1112 can communicate with AP 1410, which is associated with and/or corresponding to location 1210, and can be determined to be at and/or associated with location 1210. In one or more embodiments, a location (e.g., a location of locations 1210-1250) can be determined based on a location of a WTNN communicating with a computing device. For example, one or more of CDs 1117-1119 can communicate with WTNN 1520, which is associated with and/or corresponding to location 1225, and can be determined to be at and/or associated with location 1225.

In one or more embodiments, a location (e.g., a location of locations 1210-1250) can be determined based on locations of multiple wireless telephone network nodes (WTNNs) communicating or being capable of communicating with a computing device. For example, CD 1122 can communicate or can be capable of communicating with two or more of WTNNs 1530-1550, and a location of CD 1122 (e.g., location 1240) can be determined based on two or more of WTNNs 1530-1550 and their locations. In one instance, a location of a computing device can be determined via multilateration which is a navigation technique that utilizes measurements of differences in distances to two or more WTNNs, at previously determined or known locations, that broadcast one or more signals at previously determined or known times. In a second instance, a location of a computing device can be determined via trilateration which is a navigation technique that utilizes distances or absolute measurements of time-of-flight from three or more WTNNs. In another, a location of a computing device can be determined via triangulation which is a navigation technique that utilizes measurements of absolute angles. In one or more embodiments, a computing device and/or a network operator can utilized multiple WTNNs in determining a location of the computing device.

In one or more embodiments, a location of a computing device is determined utilizing data from a positioning device and/or mechanism. For example, the computing device can include a global positioning system (GPS) device and/or mechanism, and the computing device can communicate its location information, from the GPS device and/or mechanism, to a social media data source. In one or more embodiments, a location of a computing device can be determined utilizing a network address utilized by the computing device. For example, the network address can include an Internet protocol (IP) address or other address utilized by the computing device and/or an IP address or other address of a gateway associated with the computing device. In one instance, a database can include multiple IP addresses that correspond to multiple locations, and the database can be queried with an IP address and can provide a location based on the IP address. In another instance, the network address can be or include a network address of a communication system.

In one or more embodiments, a computing device that is communicating with a social network can provide a location of the computing device to the social network. In one example, the computing device can provide latitude and longitude information, from a GPS device and/or mechanism, to the social network. In another example, the computing device can provide one or more of street number information, street information, zip code information, city information, state information, and country information, among others, to the social network.

In one or more embodiments, user-provided data (e.g., user-provided content, user input, user-provided pictures, user-provided motion pictures, user-provided videos, communications and/or interactive dialogues among related individuals, organizations, and/or communities, user status updates, posts to one or more social network services, one or more blog entries, etc.) can be correlated and/or associated with a location of a computing device, utilized by a user, that provides the user-provided data to a social media service via a network. In one example, first user input can be correlated and/or associated with a first location of a first computing device, utilized by a first user, that provides the first user input to a first social media service via network 1010. For instance, the first user input can be correlated and/or associated with location 1210 of CD 1110, utilized by the first user, that provides the first user input to a first social media service via network 1010.

In a second example, second user input can be correlated and/or associated with a second location of a second computing device, utilized by a second user, that provides the second user input to a second social media service via network 1010. For instance, the second user input can be correlated and/or associated with location 1215 of CD 1113, utilized by the second user, that provides the second user input to a second social media service via network 1010. In a third example, third user input can be correlated and/or associated with a third location of a third computing device, utilized by a third user, that provides the third user input to a third social media service via network 1010. For instance, the third user input can be correlated and/or associated with location 1245 of CD 1123, utilized by the third user, that provides the third user input to a third social media service via network 1010.

In a fourth example, fourth user input can be correlated and/or associated with the first location of a fourth computing device, utilized by a fourth user, that provides the fourth user input to a fourth social media service via network 1010. For instance, the fourth user input can be correlated and/or associated with location 1210 of CD 1111, utilized by the fourth user, that provides the fourth user input to a fourth social media service via network 1010. In a fifth example, fifth user input can be correlated and/or associated with a fifth location of a fifth computing device, utilized by a fifth user, that provides the fifth user input to the first social media service via network 1010. For instance, the fifth user input can be correlated and/or associated with location 1240 of CD 1122, utilized by the fifth user, that provides the fifth user input to a fifth social media service via network 1010. In a sixth example, sixth user input can be correlated and/or associated with the second location of a sixth computing device, utilized by a sixth user, that provides the sixth user input to the second social media service via network 1010. For instance, the sixth user input can be correlated and/or associated with location 1215 of CD 1114, utilized by the sixth user, that provides the sixth user input to a sixth social media service via network 1010.

In one or more embodiments, user input correlated and/or associated with a location of a computing device can be provided to a social media service via one or more of a web interface, a post (e.g., a HTTP POST), a get (e.g., a HTTP GET), a smart phone application, a tablet application, a digital music player application, a personal digital assistant application, an application for a personal computer (e.g., a desktop computer, a notebook computer, etc.), and an application for a virtual machine, among others.

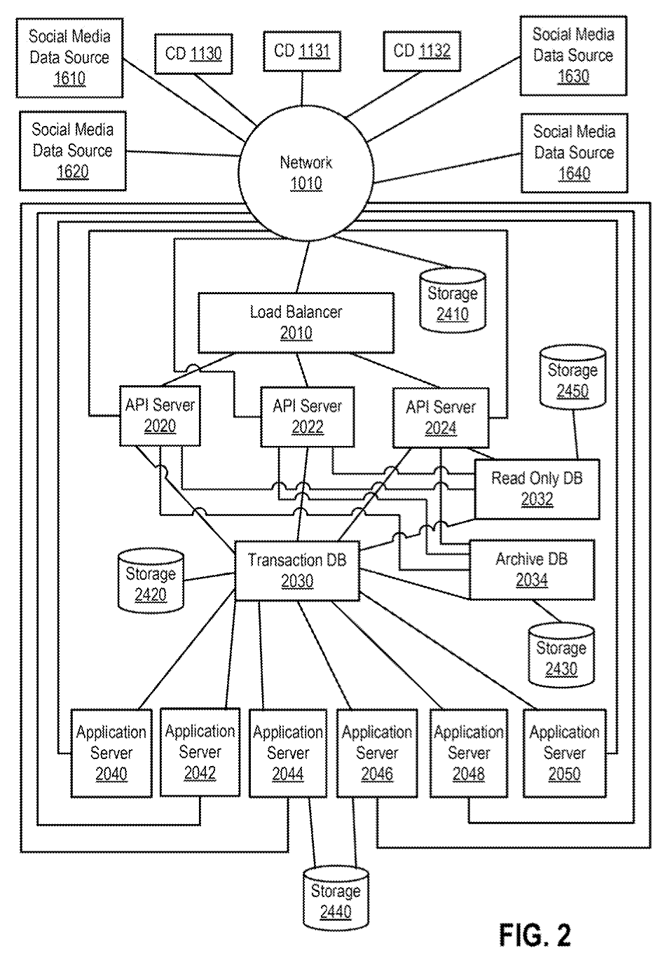

Turning now to FIG. 2, a social media query system is illustrated, according to one or more embodiments. As shown, one or more of CDs 1130-1132 and/or one or more of social media data sources 1610-1640 can be coupled to network 1010. In one or more embodiments, one or more of CDs 1130-1132 can be or include one or more clients of the social media query system. For example, one or more of CDs 1130-1132 can provide one or more queries to one or more API servers 2020-2024 via network 1010 and via a load balancer 2010. For instance, load balancer 2010 can distribute queries between or among two or more API servers in accordance with one or more load balancing methods and/or processes.

As illustrated, API servers 2020-2024 can be coupled to network 1010. In one or more embodiments, one or more API servers 2020-2024 can query one or more social media data sources 1610-1640. For example, one or more API servers 2020-2024 can receive one or more live queries from one or more of CDs 1130-1132 and can query one or more social media data sources 1610-1640, via network 1010, to provide one or more responses to the live queries. For instance, a live query can include a query for data that has not been archived.

In one or more embodiments, one or more API servers 2020-2024 can utilize one or more network monitors and/or packet analyzers (not shown) to monitor network traffic on network 1010 and capture network packets en route to one or more social media data sources 1610-1640 including information related to a query. For example, one or more API servers 2020-2024 can receive one or more queries from one or more of CDs 1130-1132 and intercept network packets destined for one or more social media data sources 1610-1640 via network 1010 to provide one or more responses to the queries based on content of the captured network packets.

In one or more embodiments, data provided to the social media services can be associated with and/or correspond to respective locations of computing devices that provided the data, and API servers 2020-2024 can query the one or more social media services to determine information associated with and/or corresponding to the data provided to the social media services and respective locations of the computing devices that provided the data. In one example, API server 2020 can provide, to social media data source 1610, a first query associated with one or more of a first word, first words, a first phrase, a first user profile, a portion of the first user profile, a first grammar, a first regular expression, a first social group, a first organization, a first user identification, and a first location, among others, and receive social media data that is associated with and/or corresponds to at least one of the first word, the first words, the first phrase, the first user profile, the portion of the first user profile, the first grammar, the first regular expression, the first social group, the first organization, the first user identification, and the first location. For instance, API server 2020 can provide the first query to social media data source 1610 via network 1010 and can receive the first social media data from social media data source 1610 via network 1010.

In a second example, API server 2022 can provide, to social media data source 1620, a second query associated with one or more of a second word, second words, a second phrase, a second user profile, a portion of the second user profile, a second grammar, a second regular expression, a second social group, a second organization, a second user identification, and a second location, among others, and receive second social media data that is associated with and/or corresponds to at least one of the second word, the second words, the second phrase, the second user profile, the portion of the second user profile, the second grammar, the second regular expression, the second social group, the second organization, the second user identification, and the second location. For instance, API server 2022 can provide the second query to social media data source 1620 via network 1010 and can receive the second social media data from social media data source 1620 via network 1010.

In another example, API server 2024 can provide, to social media data source 1630, a third query associated with one or more of a third word, third words, a third phrase, a third user profile, a third portion of the third user profile, a third grammar, a third regular expression, a third social group, a third organization, a third user identification, and a third location, among others, and receive third social media data that is associated with and/or corresponds to at least one of the third word, the third words, the third phrase, the third user profile, the portion of the third user profile, the third grammar, the third regular expression, the third social group, the third organization, the third user identification, and the third location. For instance, API server 2024 can provide the third query to social media data source 1630 via network 1010 and can receive the third social media data from social media data source 1630 via network 1010.

In one or more embodiments, social media data from a social media data source can be stored in a database (DB). For example, one or more of the first social media data from social media data source 1610, the second social media data from social media data source 1620, and the third social media data from social media data source 1630 can be stored in a transactional DB 2030. In one or more embodiments, transactional DB 2030 can provide social media data from a social media data source to one or more of a read only DB 2032 and an archive DB 2034. In one example, read only DB 2032 can be utilized for queries associated with and/or corresponding to data that has been received from a social media data source. For instance, read only DB 2032 can be utilized to off-load queries from transaction DB 2030. In a second example, archive DB 2034 can be utilized for long-term storage of queries associated with and/or corresponding to data that has been received from a social media data source. In another example, archive DB 2034 can be utilized for queries over a period of time.

In one or more embodiments, one or more of transactional DB 2030, read only DB 2032, and archive DB 2034 can include and/or be implemented via multiple computing devices and/or multiple databases. In one example, transactional DB 2030 can include at least one computer system for each API server coupled to transactional DB 2030. In another example, one or more of read only DB 2032 and archive DB 2034 can include multiple computing devices to process data in a parallel fashion. For instance, a DB can divide a data processing problem (e.g., a query), distribute portions of the data and/or portions the problem to multiple computing devices, and combine results from the multiple computing devices that were provided the portions of the data and/or the portions the problem.

In one or more embodiments, a database can include a relational database management system (RDBMS) that can be accessed by one or more computer systems. For example, the RDBMS can include an Oracle database, a Microsoft SQL Server database, a MySQL database, a PostgreSQL database, etc. In one or more embodiments, a database can include an object oriented database. For example, the object oriented database can include an Informix database, an Objectivity/DB database, a FastObjects database, a JADE database, a VelocityDB database, an ObjectDB database, etc. In one or more embodiments, a database can include a combination of a RDBMS and an object oriented database system.

As illustrated, transactional DB 2030 can be coupled to one or more of API servers 2020-2024, read only DB 2032, archive DB 2034, and application servers 2040-2050. In one or more embodiments, one or more of applications servers 2040-2050 can process and/or issue one or more queries to one or more social media data sources. For example, applications servers 2040-2050 can process and/or issue one or more queries to social media data sources over a period of time. In one or more embodiments, one or more of applications servers 2040-2050 can receive, process, analyze and/or present one or more results of one or more queries to one or more social media data sources.

As shown, a storage 2410 can be coupled to network 2410. In one or more embodiments, one or more of API servers 2020-2024, databases 2030-2034, and application servers 2040-2050 can utilize storage 2420 via network 1010. As illustrated, storages 2420, 2430, and 2450 can be coupled to one or more transaction DB 2030, archive DB 2430, and read only DB 2032, respectively. In one or more embodiments, one or more of storages 2420, 2430, and 2450 can be coupled to a respective database via one or more of SATA (serial AT attachment), SAS (serial attached SCSI), and FCoE (fiber channel over Ethernet). For example, storage 2420 can be coupled to database 2030 via Ethernet. For instance, FCoE can map storage 2420 to database 2030 independent of an Ethernet forwarding scheme. In one or more embodiments, one or more of storages 2410-2450 can be, be included in, or include at least one of a network attached storage (NAS) and a storage area network (SAN), among others.

As illustrated, a storage 2440 can be coupled to one or more of applications servers 2044 and 2046. In one or more embodiments, one or more of storage 2440 can be coupled to one or more of application servers 2440 via one or more of SATA, SAS, and FCoE. For example, storage 2420 can be coupled to database 2030 via Ethernet.

In one or more embodiments, one or more of storages 2410-2450 can include one or more storage devices that can be utilized to store database data (e.g., tables, database schemes, etc.) and/or one or more queries of one or more social media data sources. For example, one or more of storages 2410-2450 can store one or more queries generated via one or more methods, processes and/or systems described herein. In one or more embodiments, one or more stored queries can be retrieved from one or more of storages 2410-2450.

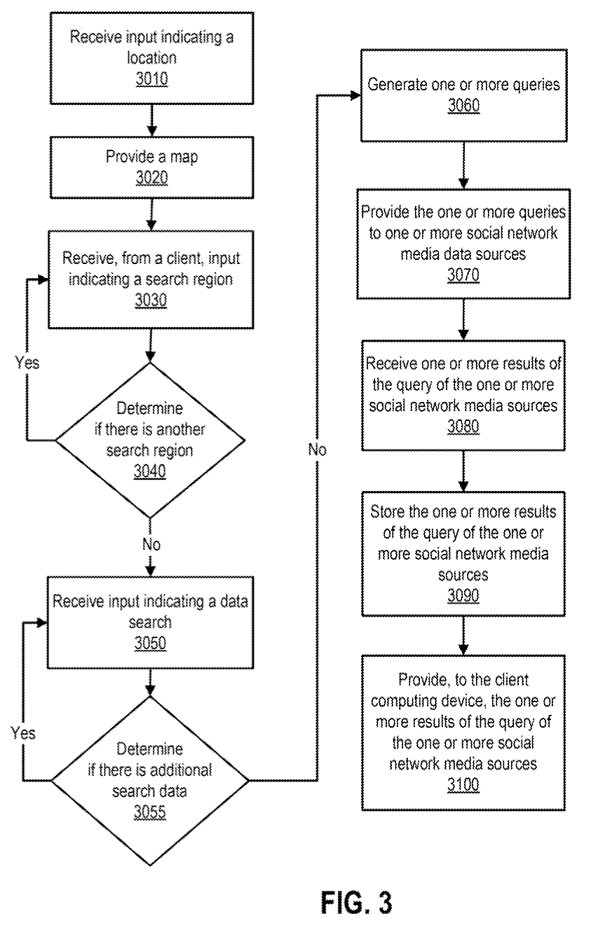

Turning now to FIG. 3, a method of selecting a geographic area is illustrated, according to one or more embodiments. At 3010, input indicating a location can be received. For example, an API server of API servers 2020-2024 can receive input indicating the location from a client (e.g., one of CDs 1130-1132) via network 1010. For instance, the location can include one or more of a coordinate (e.g., latitude, longitude, etc.), a city, a state, a zip code, and a country, among others. In one or more embodiments, the input can include at least one of user input and machine input (e.g., from a database system), among others. At 3020, a map can be provided. For example, an API server of API servers 2020-2024 can provide a map to the client. For instance, the map can include the location received at 3010.

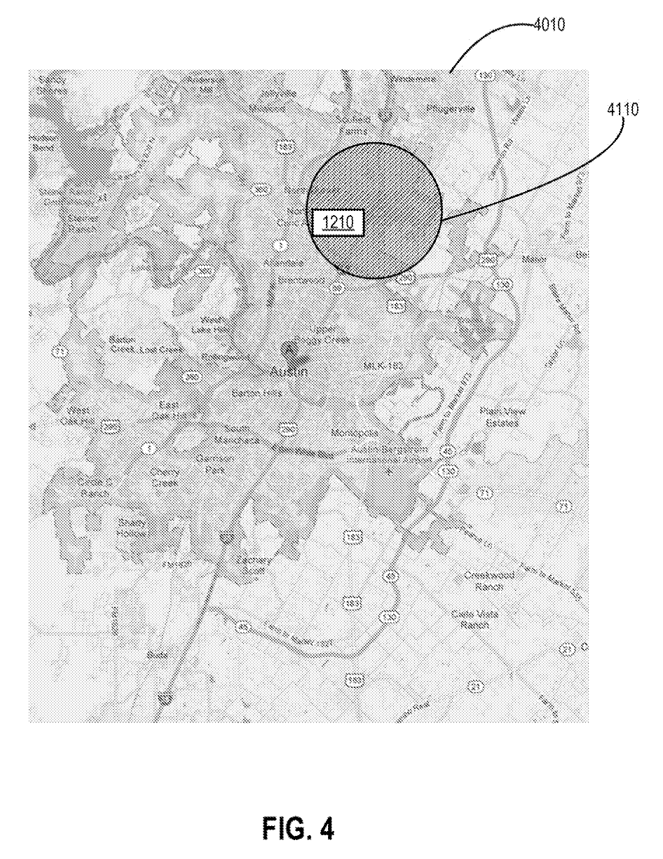

In one or more embodiments, the map can include the location, received at 3010, and one or more surrounding regions. For example, a map 4010 can include the location of Austin, Tex. and one or more surrounding regions as illustrated in FIG. 4. For instance, the client can display map 4010, via a display device and/or a graphical user interface (GUI), to a user. At 3030, input indicating a search region can be received. For example, an API server of API servers 2020-2024 can receive input indicating the search region from the client via network 1010. For instance, the user can select a search region 4110 of map 4010, and input indicating search region 4110 can be received from the client via network 1010. In one or more embodiments, the input indicating the search region received at 3030 can be associated with the location received via the input at 3010. As illustrated, search region 4110 can include location 1210.

At 3040, it can be determined if there is another search region. If there is another search region, the method can proceed to 3030. In one or more embodiments, a user of the client can utilize a GUI in selecting one or more search regions. In one instance, the client can receive user input via a pointing device (e.g., a mouse, a track pad, a track ball, a stylus, a finger, etc.), and data associated with and/or corresponding to the one or more selected search regions. In another instance, selected one or more search regions can be displayed, to a user, via a display device and/or a GUI.

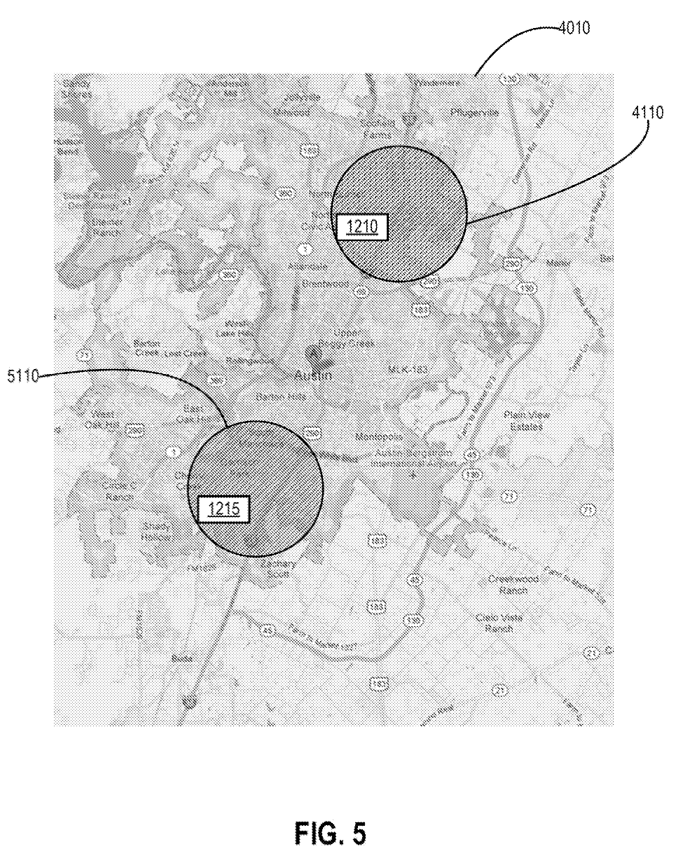

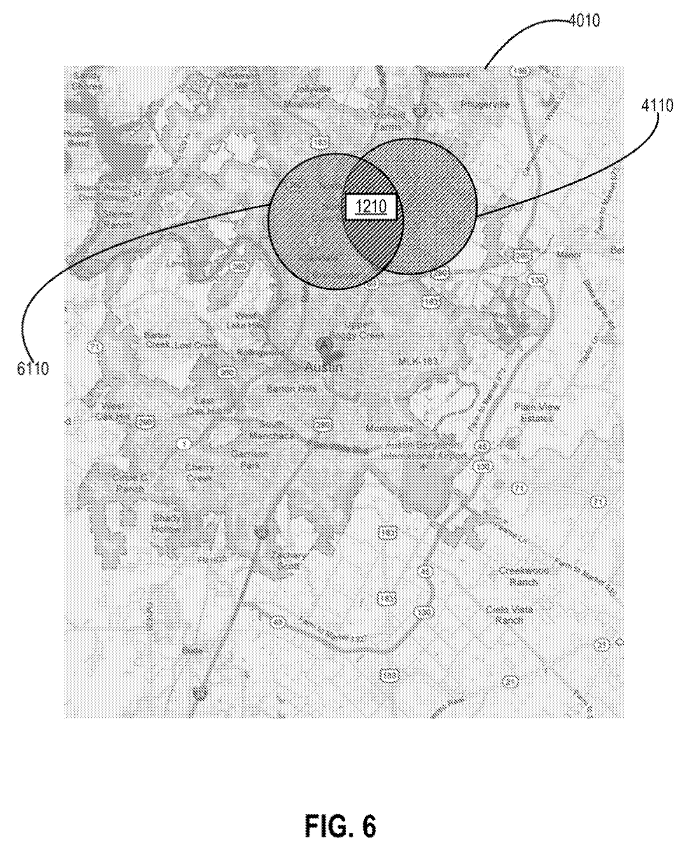

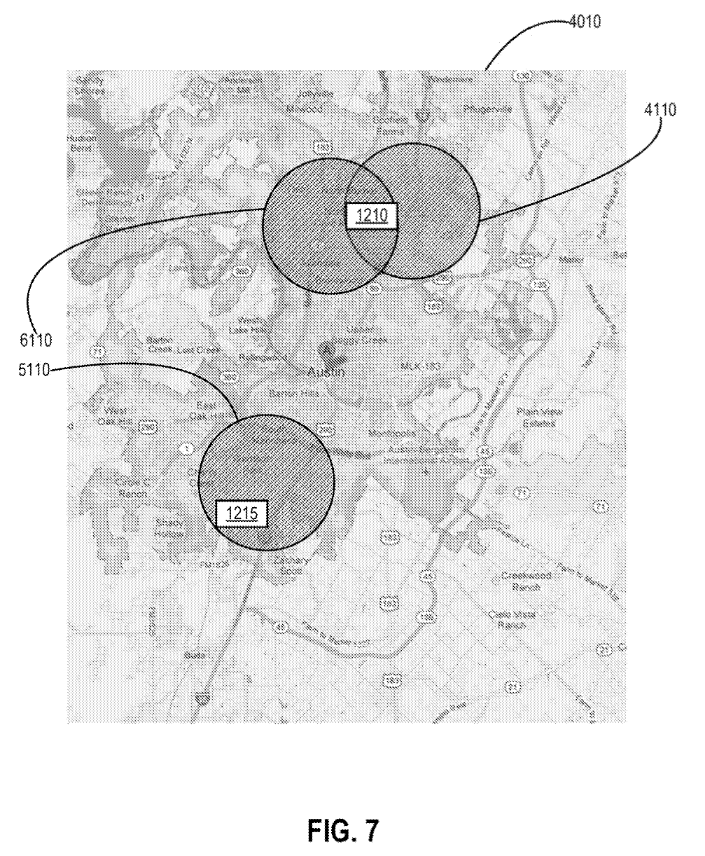

In one example, another search region can be selected. For instance, a search region 5110, as shown in FIG. 5, can be selected in addition to search region 4110, and input indicating search region 5110 can be received from the client via network 1010. As illustrated, search region 5110 can include location 1215. In a second example, another search region can be selected. For instance, a search region 6110, as shown in FIG. 6, can be selected in addition to search region 4110, and input indicating search region 6110 can be received from the client via network 1010. As illustrated in FIG. 6, one search region can overlap with another search region. In another example, multiple search regions can be selected. For instance, search regions 4110, 5110, and 6110 can be selected as shown in FIG. 7, and input indicating search regions 4110, 5110, and 6110 can be received from the client via network 1010.

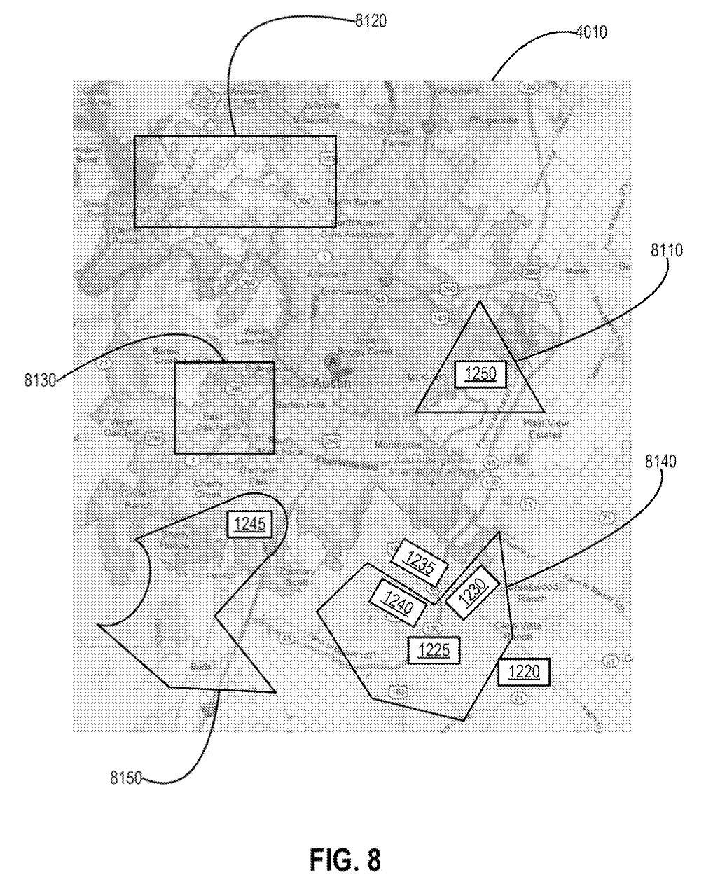

In one or more embodiments, a search region can include one or more shapes and/or boundaries. For example, a search region can include a polygon. In one instance, a search region can include a triangular search region, such as a search region 8110 of FIG. 8. As illustrated search region 8110 can include location 1250. In a second instance, a search region can include a rectangular search region, such as a search region 8120 of FIG. 8. In a third instance, a search region can include a square search region, such as a search region 8130 of FIG. 8. In a fourth instance, a search region can include custom search region (e.g., a n-sided polygon), such as a search region 8140 of FIG. 8. As illustrated, search region 8140 can include locations 1225, 1230, and 1240.

In another instance, a search region can include a custom search region (e.g., one or more straight edges with one or more arcs, elliptical arcs, parabolic arcs, splines, etc.), such as a search region 8150 of FIG. 8. As illustrated search region 8150 can include location 1245. In one or more embodiments, a custom search region can be utilized in implementing a search region of one or more of a voting district, a congressional district, a school district, a school, a campus, a dormitory, a police precinct, a piece of real estate, a neighborhood, a borrow, a city, a town, a commercial office building, a factory, a refinery, a storage facility, a power station, a power substation, and a military installation, among others.

In one or more embodiments, a custom search region can be described, transmitted, and/or stored via a markup language and/or a data description language. In one example, a custom search region can be described, transmitted, and/or stored via an extensible markup language (XML). In a second example, a custom search region can be described, transmitted, and/or stored via a keyhole markup language (KML). In another example, a custom search region can be described, transmitted, and/or stored via a language that can represent data structures (e.g., objects, arrays, associative arrays, etc.). For instance, the language that can represent data structures can be or include JSON (JavaScript Object Notation). In one or more embodiments, JSON can be utilized by any language that can support and/or utilize a JSON lexer and/or parser.

If there is not another search region, the method can proceed to 3050, as shown in FIG. 3, where input indicating a data search can be received. For example, the input indicating a data search can include one or more of a word, words, a phrase, a mood, a sentiment, a user profile, a portion of a user profile, a regular expression, a natural language filter, a grammar, a social group, an organization, and a user identification, among others. For instance, the input indicating a data search can be received from the client via network 1010. In one or more embodiments, the input indicating a data search can be or include search data. For example, the search data can include one or more of a word, words, a phrase, a mood, a sentiment, a user profile, a portion of a user profile, a regular expression, a natural language filter, a grammar, a social group, an organization, and a user identification, among others.

At 3055, it can be determined if there is additional search data. If there is additional search data, the method can proceed to 3050. If there is not additional search data, the method can proceed to 3060, where one or more queries can be generated. In one example, generating the one or more queries can include multiple supported geographical search region shapes. For instance, a search region can include one or more shapes that are not supported by one or more social media data sources, and the multiple supported geographical search region shapes can include the one or more shapes that are not supported by one or more social network media data sources. In a second example, the one or more queries can be based on one or more of the search region, the user input indicating a data search (e.g., search data), and one or more social network media data sources that store user-provided data (e.g., user-provided communications, user input, user-provided content, social network user-provided data, social network user-provided content, etc.) from multiple users provided via multiple user computing devices at multiple locations (e.g., two or more of CDs 1110-1126 at respective locations 1210-1250), among others.

In another example, generating the one or more queries can include configuring and/or implementing the one or more queries with one or more of a word, multiple words, a phrase, a mood, a sentiment, a user profile, a portion of a user profile, a regular expression, a natural language filter, a grammar, a social group, an organization, and a user identification, among others. In one instance, the one or more of the word, the multiple words, the phrase, the mood, the sentiment, the user profile, the portion of the user profile, the regular expression, the natural language filter, the grammar, the social group, the organization, and the user identification, among others, can match at least a portion of the user-provided data (e.g., user input, user-provided content, social network user-provided data, social network user-provided content) from multiple users provided via multiple user computing devices at multiple locations and/or can produce one or more search results. In another instance, one or more search results can be produced, generated, and/or precipitated via a satisfaction and/or a statistical satisfaction of one or more criteria that can include and/or can be based on the one or more of the word, the multiple words, the phrase, the mood, the sentiment, the user profile, the portion of the user profile, the regular expression, the natural language filter, the grammar, the social group, the organization, and the user identification, among others.

At 3070, the one or more queries can be provided to one or more social media data sources. In one example, one or more of API servers 2020-2024 can provide the one or more queries to one or more social media data sources, via network 1010. For instance, one or more of API servers 2020-2024 can query one or more social media data sources 1610-1640 based on the search data and the one or more search regions. In another example, one or more of application servers 2040-2050 can provide the one or more queries to one or more social media data sources, via network 1010. For instance, one or more of application servers 2040-2050 can query one or more social media data sources 1610-1640 based on the search data and the one or more search regions.

At 3080, one or more results of the query of the one or more social media data sources can be received. In one example, one or more of API servers 2020-2024 can receive one or more results of the query of one or more social media data sources 1610-1640 via network 1010. In another example, one or more of application servers 2040-2050 can receive one or more results of the query of one or more social media data sources 1610-1640 via network 1010. At 3090, the one or more results of the query of the one or more social media data sources can be stored. For example, a database can store the results of the query of the social media data sources. For instance, one or more of databases 2030-2034 can store the results of the query of social media data sources 1610-1640.

At 3100, the one or more results of the query of the one or more social media data sources can be provided to the client. In one example, one or more of API servers 2020-2024 can provide the results of the query of social media data sources 1610-1640 to the client via network 1010. In another example, one or more of application servers 2040-050 can provide the results of the query of social media data sources 1610-1640 to the client via network 1010.

In one or more embodiments, one or more locations (e.g., one or more locations where user data was provided by one or more users via one or more of their computing devices) can correspond to the one or more results of the one or more queries. In one example, location 1210 (as shown in FIG. 4), e.g., a location where user data was provided by one or more users via one or more of their computing devices, can correspond to the one or more results of the one or more queries, and the client can display location 1210 to a user, via a display device and/or a GUI. In a second example, locations 1210 and 1215 (as shown in FIG. 5), e.g., one or more locations where user data was provided by one or more users via one or more of their computing devices, can correspond to the one or more results of the one or more queries, and the client can display locations 1210 and 1215 to a user, via a display device and/or a GUI.

In a third example, location 1210 (as shown in FIG. 6) e.g., a location where user data was provided by one or more users via one or more of their computing devices, can correspond to the one or more results of the one or more queries, and the client can display location 1210 to a user, via a display device and/or a GUI. For instance, the one or more queries can include multiple search regions 4110 and 6110. In a fourth example, one or more of locations 1210 and 1215 (as shown in FIG. 7), e.g., one or more locations where user data was provided by one or more users via one or more of their computing devices, can correspond to the one or more results of the one or more queries, and the client can display to a user, via a display device and/or a GUI. For instance, the one or more queries can include one or more of search regions 4110, 5110, and 6110.

In a fifth example, one or more of locations 1225, 1230, 1240, 1245, and 1250 (as shown in FIG. 8), e.g., one or more locations where user data was provided by one or more users via one or more of their computing devices, can correspond to the one or more results of the one or more queries, and the client can display to a user, via a display device and/or a GUI. For instance, the one or more queries can include one or more of search regions 8110, 8120, 8130, and 8140. In sixth example, one or more of locations 22210-22232 (as shown in FIG. 22), e.g., one or more locations where user data was provided by one or more users via one or more of their computing devices, can correspond to the one or more results of the one or more queries. For instance, the client can display to a user, via a display device and/or a GUI, one or more locations 22210-22232 via a search region 22110 and/or via a map 22010.

In another example, one or more of locations 1225, 1230, 1240, 1245, and 1250 (as shown in FIG. 8), e.g., one or more locations where user data was provided by one or more users via one or more of their computing devices, can correspond to the one or more results of the one or more queries, and the client can store the one or more results of the one or more queries. For instance, the client can store the one or more results of the one or more queries in one or more formats such as one or more of a portable document format (PDF), a Microsoft Excel format, a XML format, a text format, a hypertext markup language (HTML) format, a comma separated value (CSV) format, and a structured query language (SQL) format, among others.

In one or more embodiments, the one or more results of the query of the one or more social media data sources can be analyzed by the one or more of API servers 2020-2024 and/or one or more of application servers 2040-050 to provide analysis and/or conclusions about the results of the query of social media data sources 1610-1640. For example, the one or more results of the query of the one or more social media data sources can be filtered by one or more of API servers 2020-2024 and/or one or more of application servers 2040-050 to provide filtered results and/or analysis of the one or more queries of social media data sources 1610-1640 that include one or more of an identified word, phrase, user profile, portion of a user profile, regular expression, grammar, social group, organization, user identification, and a location, among others.

In one or more embodiments, a search region can include a shape that is not supported by one or more social media data sources. For example, one or more social media data sources may support one or more shapes for defining a search region but not other shapes. For instance, one or more social media data sources may support a circular search region (e.g., a location and a radius from the location). In this instance, search regions 4110-6110 can be supported by one or more social media data sources, while search regions 8110-8150 may not be supported. In one or more embodiments, a query of one or more social network media data sources for a search region that is not supported by one or more social media data sources can be performed. For example, one or more queries can be generated utilizing multiple of the one or more shapes defining search regions that can be supported by the one or more social media data sources in order to generate the one or more queries of a search region including a shape that is not supported by one or more social media data sources. For instance, multiple shapes of search regions that can be supported by the one or more social media data sources can be utilized to implement and/or support a search region shape that is not supported by the one or more social media data sources.

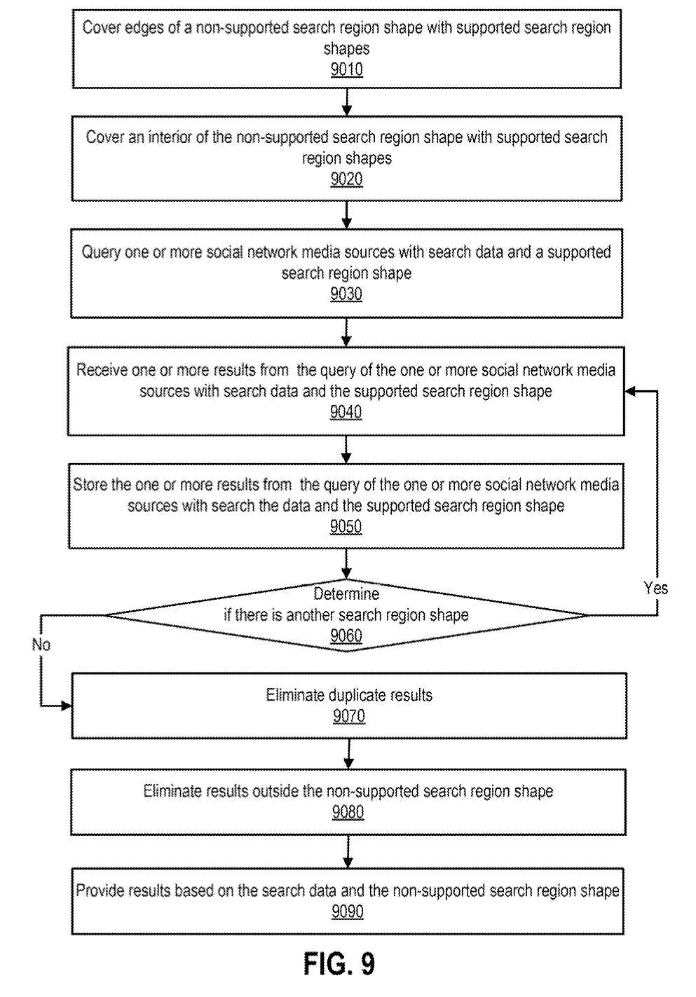

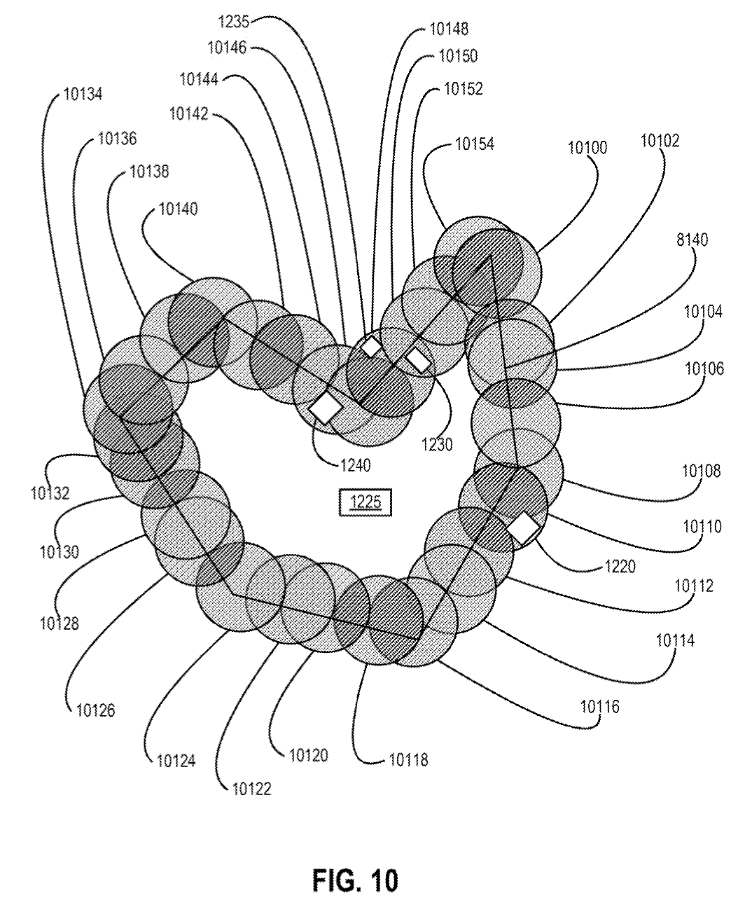

Turning now to FIG. 9, an exemplary method of supporting a search region shape that is not supported by one or more social media data sources is illustrated, according to one or more embodiments. At 9010, edges of a custom search region shape can be covered by shapes of search regions that are supported by a social media data source. For example, as illustrated in FIG. 10, search region 8140 is a custom search region shape, and edges of search region 8140 can be covered by circular search regions 10100-10154, which are supported search region shapes, in some examples.

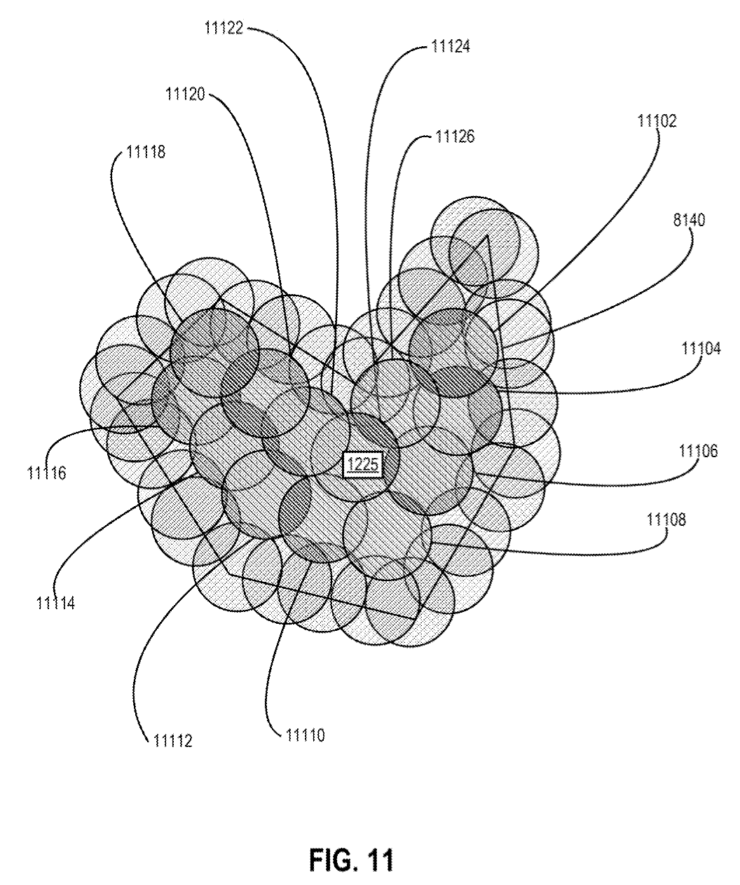

At 9020, an interior of the custom search region shape can be covered by shapes of search regions that are supported by a social media data source. For example, search region 8140 is a custom search region shape, and an interior of search region 8140 can be covered by circular search regions 11102-11126 that are supported search region shapes, as illustrated in FIG. 11. For instance, search region 11124 includes location 1225.

At 9030, one or more social network media data sources can be queried. For example, the query can include search data and a supported search region. For instance, the search data can include one or more of a word, a phrase, a mood, a sentiment, a user profile, a portion of a user profile, a social group, an organization, a user identification, a regular expression, and a grammar, among others, and the supported search region can include a search region of search regions 10100-11126. At 9040, one or more results of the query, associated with and/or corresponding to the supported search region, can be received. At 9050, the one or more results of the query can be stored.

At 9050, it can be determined if there is another search region shape. If there is another search region shape, the method can proceed to 9040. If there is not another search region shape, the method can proceed to 9070, where one or more duplicates of the search results can be eliminated.

In one or more embodiments, two or more of the supported search region shapes can intersect, and those intersections can yield duplicates in results of the queries based on respective search region shapes. For example, search regions 10148 and 10150 intersect and can produce one or more duplicates in search data results, since an area of an intersection of search regions 10148 and 10150 can be searched multiple times. For instance, search regions 10148 and 10150 intersect and include location 1230, as illustrated in FIG. 10, and one or more duplicates of the search data results of an intersection of search regions 10148 and 10150 can be eliminated.

At 9080, one or more results that correspond to one or more locations outside the custom search region shape can be eliminated. For example, one or more locations that are outside one or more edges of search region 8140 can be eliminated. For instance, search region 10110 can include one or more locations outside one or more edges of search region 8140, and results associated with and/or corresponding to the one or more locations outside one or more edges of search region 8140 can be eliminated. As illustrated in FIG. 10, search region 10110 can include location 1220, and location 1220 is outside one or more edges of search region 8140. As such, one or more results associated with and/or corresponding to location 1220 can be eliminated as falling outside the boundary of the custom search region shape. At 9090, one or more results based on the search data and the custom search region shape can be provided to the client.

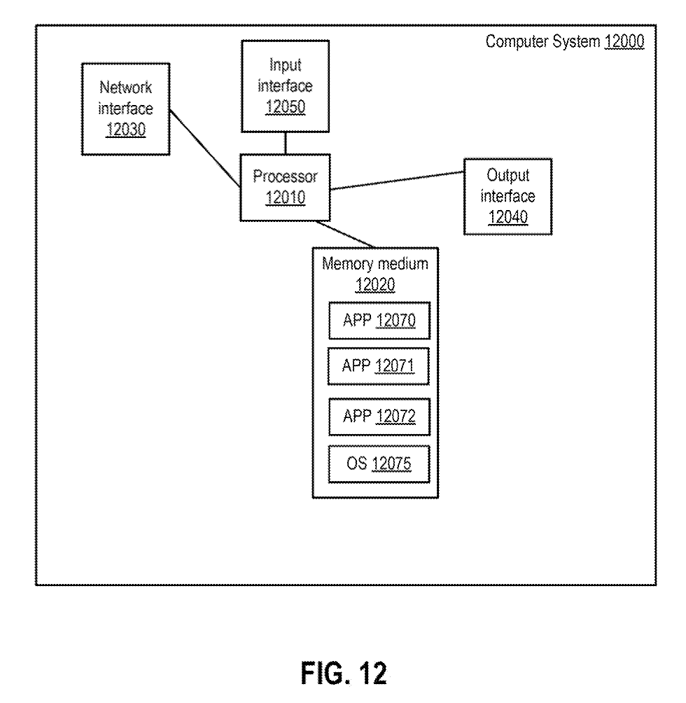

Turning now to FIG. 12, a computer system is illustrated, according to one or more embodiments. As shown, a computer system 12000 can include a processor 12010 coupled to a memory medium 12020. In one or more embodiments, processor 12010 can include and/or implement an instruction set architecture (ISA) that can include instructions that can be stored via memory medium 12020 and/or can be executable by processor 12010

As illustrated, memory medium can include one or more applications (APPs) 12070-12072 and an operating system (OS) 12075. In one or more embodiments, one or more of APPs 12070-12072 and OS 12075 can store instructions, executable by processor 12010, that can include one or more software programs in accordance with one or more of methods, processes and/or flowcharts described herein.

As illustrated, computer system 12000 can include a network interface 12030 coupled to processor 12010. In one example, network interface 12030 can be configured to couple computer system 12000 to network 1010. In a second example, network interface 12030 can be configured to couple computer system 12000 to a wireless AP. In a third example, network interface 12030 can be configured to couple computer system 12000 to a wired AP or gateway (e.g., a cable modem, a DSL modem, a router, a switch, etc.). In another example, network interface 12030 can be configured to couple computer system 12000 to a wireless telephone network (e.g., a cellular telephone network, a satellite telephone network, etc.).

As shown, computer system 12000 can include an output interface 12040 coupled to processor 12010. In one example, output interface 12040 can include a display that can convey graphical information to a user. In another example, output interface 12040 can be configured to be coupled to a display that can convey graphical information to a user. In another example, output interface 12040 can include or can be configured to be coupled to an audio output device (e.g., a speaker).

As illustrated, computer system 12000 can include an input interface 12050. In one example, input interface 12050 can include one or more of a keyboard and a mouse, among others. In a second example, input interface 12050 can be configured to be coupled to one or more of a keyboard and a mouse, among others. In a third example, input interface 12050 can include an input of a touch screen. In a fourth example, input interface 12050 can include or can be configured to be coupled to an audio input device (e.g., a microphone). In another example, input interface 12050 can be configured to be coupled to an input of a touch screen. In one or more embodiments, one or more of CDs 1110-1132, API servers 2020-2024, databases 2030-2034, and application servers 2040-2050 can include one or more structures and/or functionalities described with reference to computer system 12000.

In one or more embodiments, a computer system can include a field programmable gate array (FPGA) coupled to a memory medium, and the memory medium can store data and/or configuration information that can be utilized by the FPGA in implementing one or more systems, methods, and/or processes described herein. For example, the configuration information and/or the one or more instructions can include a hardware description language and/or a schematic design that can be utilized by the FPGA to implement one or more systems, methods, and/or processes described herein. In one or more embodiments, the FPGA can include multiple programmable logic components that can be configured and coupled to one another in implementing one or more systems, methods, and/or processes described herein.

In one or more embodiments, the FPGA can be coupled to one or more of a network interface, an output interface, and an input interface. In one or more embodiments, one or more of the network interface, the output interface, and the input interface can provide and/or implement one or more structures and/or functionalities as described above.

In one or more embodiments, a computer system can include an application specific processor (ASIC) coupled to a memory medium. In one or more embodiments, the memory medium can store data and/or configuration information that can be utilized by the ASIC in implementing one or more systems, methods, and/or processes described herein. For example, the memory medium can store a configuration, and the configuration can include configuration information and/or one or more instructions that can be utilized by the ASIC to implement one or more systems, methods, and/or processes described herein. In one or more embodiments, the memory medium can store data and/or instructions that can be executed by the ASIC. For instance, one or more APPs and/or an OS can include instructions of an ISA associated with the ASIC.

In one or more embodiments, the ASIC can be coupled to one or more of a network interface, an output interface, and an input interface. In one or more embodiments, one or more of the network interface, the output interface, and the input interface can provide and/or implement one or more structures and/or functionalities as described above.

In one or more embodiments, a computer system can include a graphics processing unit (GPU) coupled to a memory medium. For example, the GPU can be or include a general purpose graphics processing unit (GPGPU). In one or more embodiments, the memory medium can store data and/or configuration information that can be utilized by the GPU in implementing one or more systems, methods, and/or processes described herein. For example, the memory medium can store a configuration, and the configuration can include configuration information and/or one or more instructions that can be utilized by the GPU to implement one or more systems, methods, and/or processes described herein.

In one or more embodiments, the GPU can be coupled to one or more of a network interface, an output interface, and an input interface. In one or more embodiments, one or more of the network interface, the output interface, and the input interface can provide and/or implement one or more structures and/or functionalities as described above.

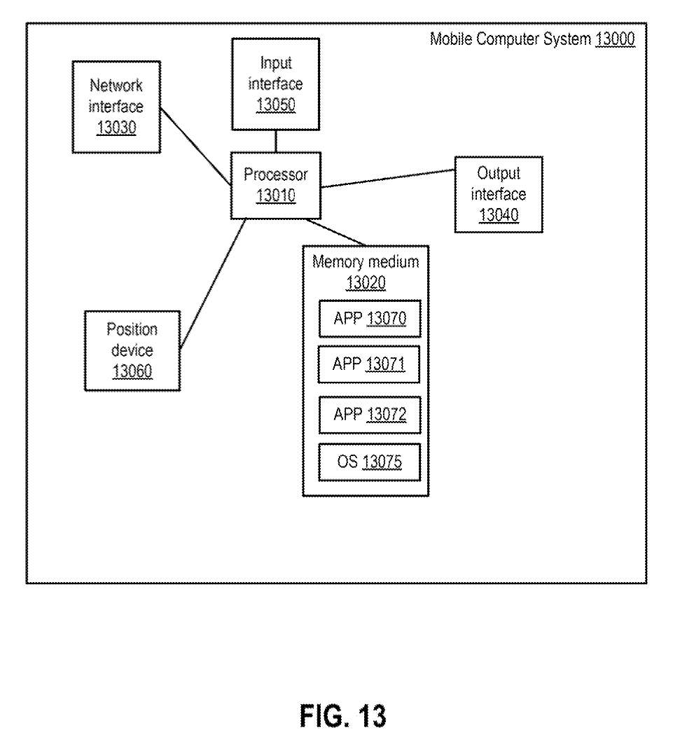

Turning now to FIG. 13, a mobile computer system is illustrated, according to one or more embodiments. As shown, a mobile computer system 13000 can include a processor 13010 coupled to a memory medium 13020. As illustrated, memory medium can include one or more APPs 13070-13072 and an OS 13075. In one or more embodiments, one or more of APPs 13070-13072 and OS 13075 can store instructions, executable by processor 13010, that can include one or more software programs in accordance with one or more of methods, processes and/or flowcharts described herein.

As illustrated, mobile computer system 13000 can include a network interface 13030 coupled to processor 12010. In one example, network interface 13030 can be configured to couple mobile computer system 13000 to network 1010. In a second example, network interface 13030 can be configured to couple mobile computer system 13000 to a wireless AP. In a third example, network interface 13030 can be configured to couple mobile computer system 13000 to a wired AP or gateway (e.g., a cable modem, a DSL modem, a router, a switch, etc.). In another example, network interface 13030 can be configured to couple computer system 13000 to a wireless telephone network (e.g., a cellular telephone network, a satellite telephone network, etc.).

As shown, mobile computer system 13000 can include an output interface 13040 coupled to processor 13010. In one example, output interface 12040 can include a display that can convey graphical information to a user. In another example, output interface 13040 can be configured to be coupled to a display that can convey graphical information to a user. In another example, output interface 13040 can include or can be configured to be coupled to an audio output device (e.g., a speaker).

As illustrated, mobile computer system 13000 can include an input interface 13050. In one example, input interface 13050 can include one or more of a keyboard and a mouse, among others. In a second example, input interface 13050 can be configured to be coupled to one or more of a keyboard and a mouse, among others. In a third example, input interface 13050 can include an input of a touch screen. In a fourth example, input interface 13050 can include or can be configured to be coupled to an audio input device (e.g., a microphone). In another example, input interface 13050 can be configured to be coupled to an input of a touch screen.

As shown, mobile computer system 13000 can include a position device 13060 coupled to processor 13010. For example, position device 13060 can determine location information and/or provide the location information to processor 13010. For instance, position device 13060 can determine location information based on one or more of multilateration, trilateration, triangulation, and multiangulation, among others. In one or more embodiments, position device 13060 can include a GPS device and/or mechanism. For example, a GPS device and/or mechanism can determine location information and provide the determined location information to processor 13010. In one or more embodiments, one or more of CDs 1110-1132 can include one or more structures and/or functionalities described with reference to mobile computer system 13000.

In one or more embodiments, mobile computer system 13000 may not include position device 13060. For example, position device 13060 can be eliminated from a design and/or implementation of mobile computer system 13000 to conserve utilization of a power source of mobile computer system 13000.

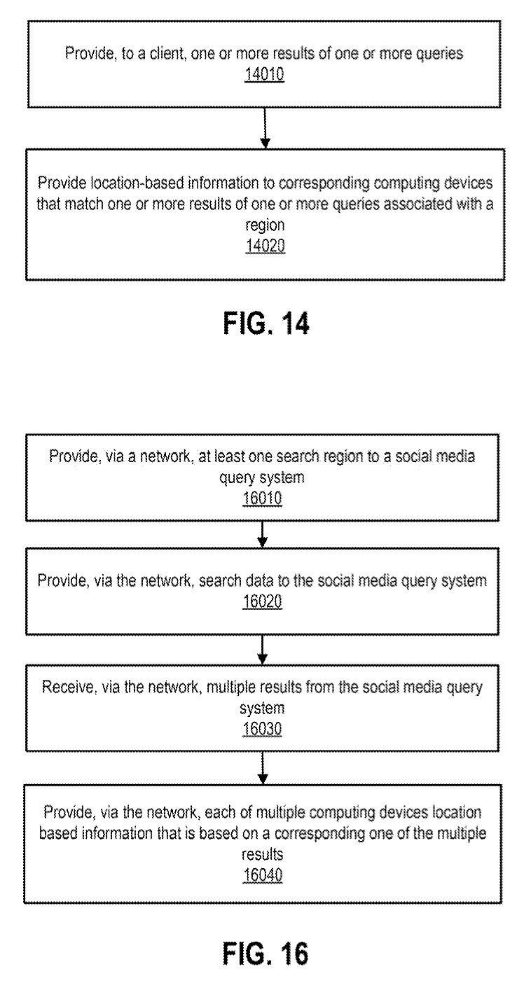

Turning now to FIG. 14, a method of providing location-based information to a computing device is illustrated, according to one or more embodiments. At 14010, one or more results of one or more queries can be provided to a client (e.g., one of CDs 1130-1132). For example, one or more of API servers 2020-2024 and application servers 2040-2050 can provide the one or more results of one or more queries to CD 1130.

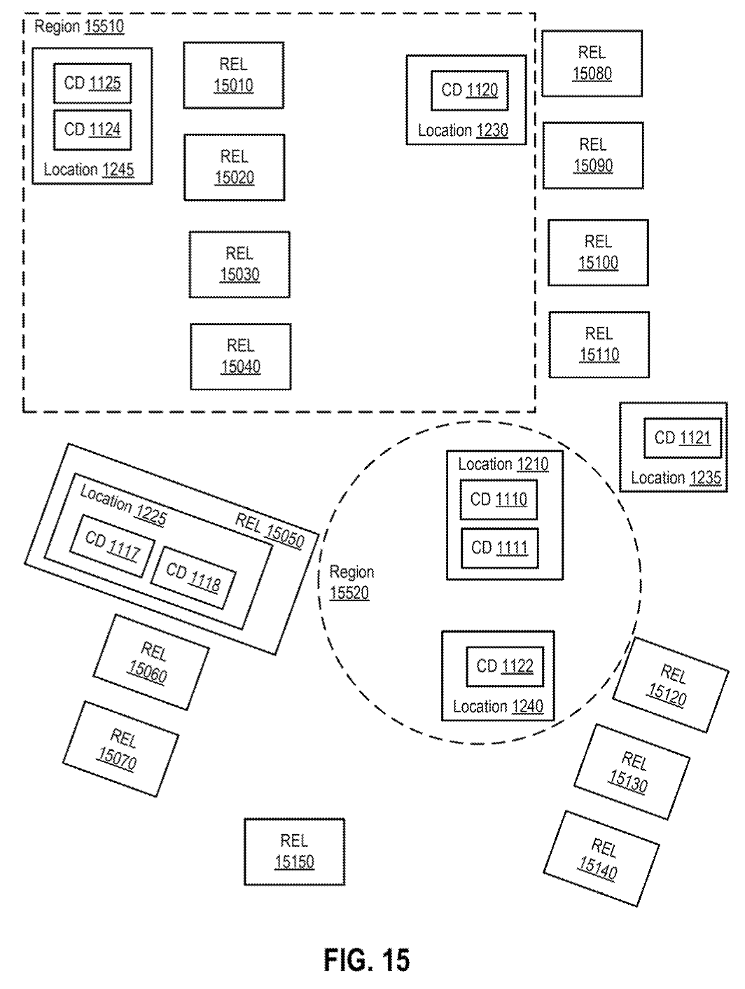

In one or more embodiments, a client (e.g., a retail entity, an advertising agency, a marketing agency, a promotion agency, etc.) can provide information indicating a search region and data of a search to one or more computing devices that perform the method illustrated in FIG. 3, and the client can receive one or more results of one or more queries. For example, the client can provide information indicating a region 15510, as illustrated in FIG. 15, and one or more search words or a search string to one or more of API servers 2020-2024 and application servers 2040-2050. In one instance, the string can include a word such as “shoes”, and one or more results of one or more queries associated with region 15510 and “shoes” can be provided to the client. In a second instance, the string can include a word such as “hungry”, and one or more results of one or more queries associated with region 15510 and “hungry” (or variation such as “hunger”, etc.) can be provided to the client. In another instance, the string can include a word such as “clothes”, and one or more results of one or more queries associated with region 15510 and “clothes” (or variation such as “clothing”, etc. or similarities such as “shirt”, “dress”, “pants”, “slacks”, “skirt”, “blouse”, etc.) can be provided to the client.

At 14020, location-based information (e.g., an advertisement, a promotion, marketing information, a coupon, directions to a store, etc.) can be provided to corresponding computing devices that correspond to one or more results of one or more queries of social network media data sources associated with a region. In one example, CD 1130 can provide location-based information to CD 1124, which corresponds with the one or more results of one or more queries of social network media data sources 1610-1640 associated with region 15510. For instance, CD 1124 can provide a search string that includes the word “clothing”, and CD 1130 can provide one or more of an advertisement associated with retail entity location (REL) 15040 (e.g., a clothing retailer location, a department store, etc.), a promotion associated REL 15040, a coupon associated REL 15040, and one or more directions (e.g., turn-by-turn directions) to REL 15040, among others. In one or more embodiments, location-based information can be provided to a computing device via one or more of a banner advertisement, a text message, a SMS (short message service) message, an email message, a video, and an in-application message, among others. As illustrated in FIG. 15, the location based information can be associated with a specific one of retail entity locations 15010-15150. In this way, for example, a social media network user may include the word “clothes,” for example, in a social media update such as a “Tweet,” for example, to a social media website such as Twitter, for example, and the social media network user can be presented with one or more location-based information associated with the location from which the social media network user provided the social media update.

In a second example, application server 2040 can provide location-based information to CD 1120, which corresponds with the one or more results of one or more queries of social network media data sources 1610-1640 associated with region 15510. For instance, CD 1120 can provide a string that includes the word “hungry”, and application server 2040 can provide one or more of an advertisement associated with REL 15110 (e.g., a food purveyor location), a promotion associated REL 15110, a coupon associated REL 15110, and one or more directions to REL 15110, among others. In third example, API server 2020 can provide location based information to CD 1125, which corresponds with the one or more results of one or more queries associated with region 15510. For instance, CD 1125 can provide a string that includes the word “shoes”, and API server 2020 can provide one or more of an advertisement associated with REL 15060 (e.g. a shoe store, a department store, etc.), a promotion associated REL 15060, a coupon associated REL 15060, and directions to REL 15060, among others.

In another example, social media data source 1610 can provide location-based information to CD 1111, which corresponds with one or more results of one or more queries associated with region 15520. For instance, CD 1111 can provide a string that includes the word “sunglasses”, and social media data source 1610 can provide one or more of an advertisement associated with REL 15030 (e.g., a glasses retailer location, a department store, etc.), a promotion associated REL 15030, a coupon associated REL 15030, and directions to REL 15030, among others. In one or more embodiments, social media data source 1610 can support an API that permits CD 1130 to provide location-based information to CD 1111. For example, CD 1130 can provide the location-based information to CD 1111 via social media data source 1610.

Turning now to FIG. 16, a method of providing location-based information to a computing device is illustrated, according to one or more embodiments. At 16010, a client (e.g., a computer system of a retail entity, a computer system of an advertising agency, a computer system of a marketing agency, a computer system of a promotion agency, a computing device of CDs 1130-1132, etc.) can provide at least one search region to a social media query system, via a network (e.g., network 1010). For example, the social media query system can include one or more structures and/or functionalities as those described with reference to the social media query system illustrated in FIG. 2.

At 16020, the client can provide search data to the social media query system, via the network. For example, the search data can include one or more of a word, words, a phrase, a mood, a sentiment, a user profile, a portion of a user profile, a regular expression, a natural language filter, a grammar, a social group, an organization, and a user identification, among others. At 16030, the client can receive multiple results from the social media query system, via the network. For example, the multiple results can be based on the search data and the at least one search region, and the multiple results can correspond to multiple computing devices (e.g., multiple of CDs 1110-1126). For instance, each of the multiple results can correspond to each of the multiple computing devices.

At 16040, the client can provide, via the network, each of the multiple computing devices location based information that is based on a corresponding one of the multiple results from the social media query system. For example, the client can provide location based one or more directions to REL 15050, illustrated in FIG. 15, a location based coupon, a location based promotion, location based marketing information, and a location based advertisement to each of multiple computing devices based on a corresponding one of the multiple results from the social media query system. In one instance, the client can provide CD 1125 one or more directions to REL 15050 based on a first result of the multiple results from the social media query system. In a second instance, the client can provide a coupon to CD 1124 based on a second result of the multiple results from the social media query system. In a third instance, the client can provide a promotion to CD 1110 based on a third result of the multiple results from the social media query system. In a fourth instance, the client can provide marketing information to CD 1122 based on a fourth result of the multiple results from the social media query system. In another instance, the client can provide an advertisement to CD 1120 based on a fifth result of the multiple results from the social media query system.

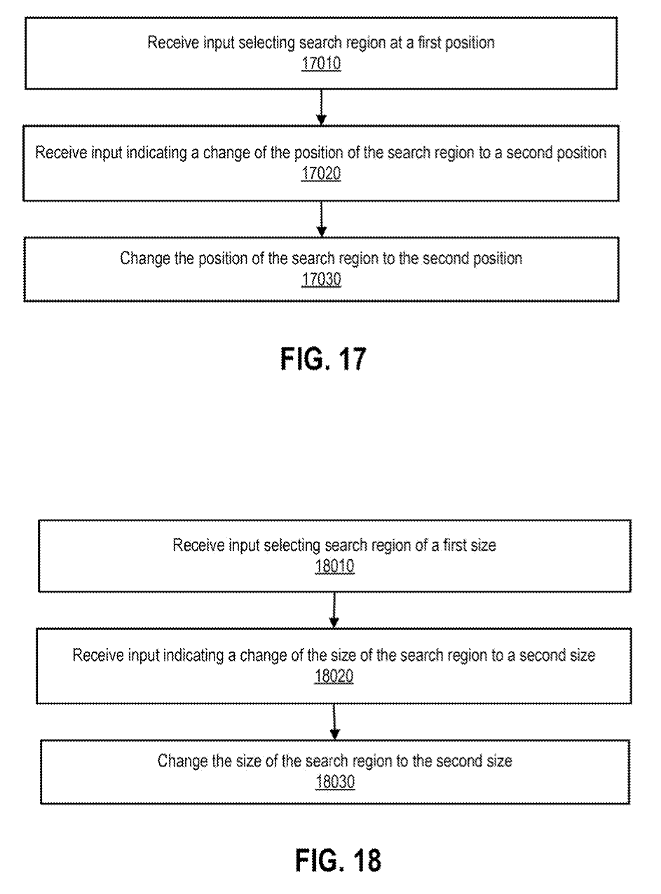

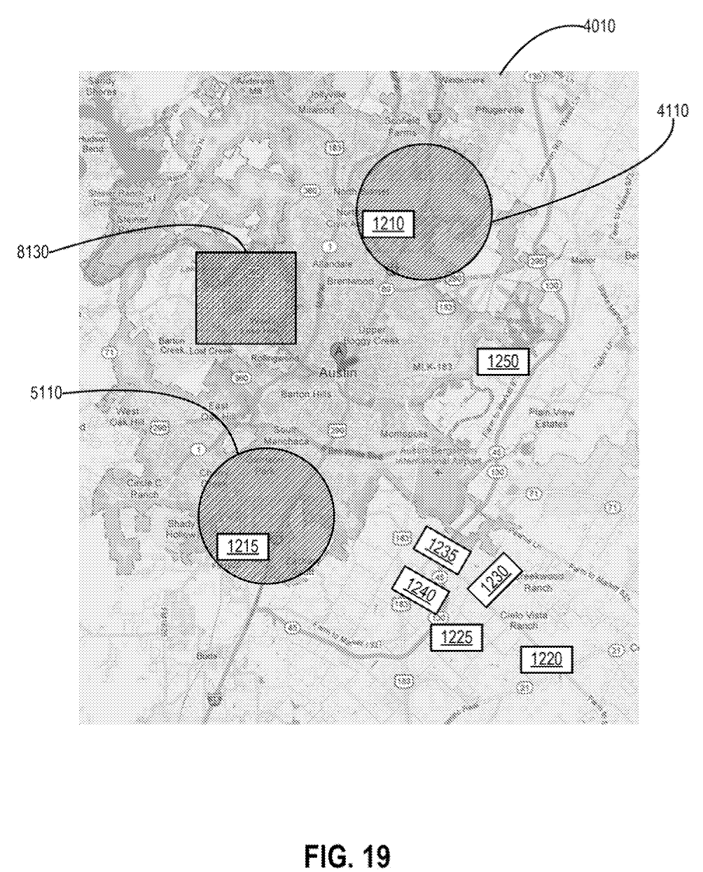

Turning now to FIG. 17, a method of changing a position of a search region, according to one or more embodiments. At 17010, input selecting a search region, at a first position, can be received. In one example, a first computing device can receive input from a second computing device which selects a search region. In another example, a computing device can receive user input that selects a search region. For instance, a search region of search regions 4110, 5110, and 8130, as shown in FIG. 19, can be selected. In one or more embodiments, one or more of map 4010 and search regions 4110, 5110, and 8130 can be displayed to a user via one or more of a screen, a projector, a GUI, and a display, among others, and the user input that selects a search region can be received via a keyboard and/or a pointing device (e.g., a mouse, a trackpad, a trackball, a touch screen that can determine contact from a stylus and/or a finger).

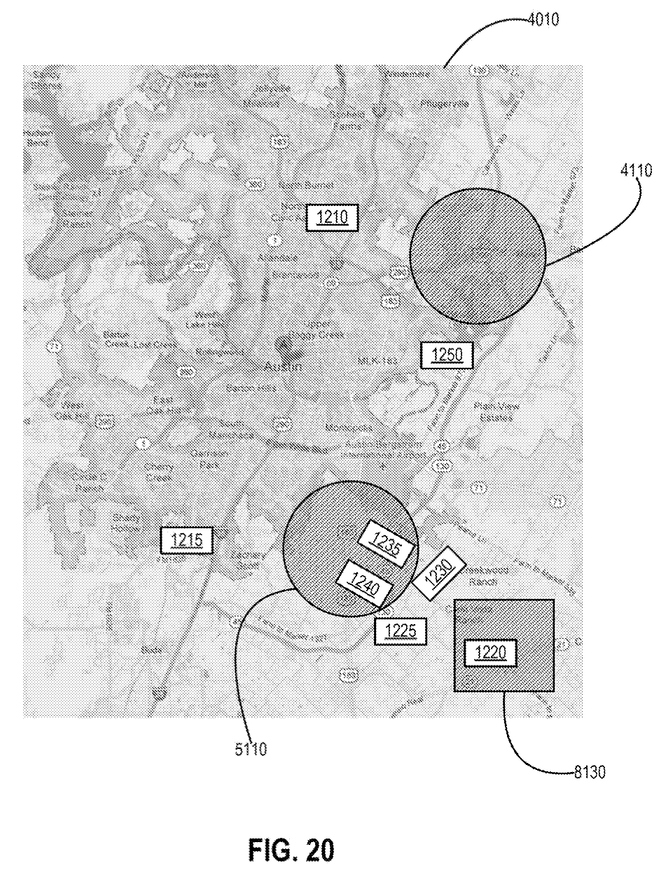

At 17020, input indicating a change of position of the search region from the first position to a second position. In one example, a first computing device can receive input from a second computing device which provides data to the first computing device that indicates the change of position of the search region from the first position to the second position. In a second example, a computing device can receive user input that indicates a change of a position search region, at a first position, to a second position. For instance, a search region of search regions 4110, 5110, and 8130, as shown in FIG. 19, can be changed from a first position to a second position as shown in FIG. 20. In another example, input indicating a change of position of the search region from the first position to the second position can include input from one or more of accelerometer and/or gyroscope that can indicate a change of position of a computing device (e.g., a user tilting a computing device to indicate a change of position of the search region from the first position to the second position).

In one or more embodiments, one or more of map 4010 and search regions 4110, 5110, and 8130 can be displayed to a user via one or more of a screen, a projector, a GUI, and a display, among others, and the user input that indicates a change of a position search region, at a first position, to a second position can be received via a keyboard and/or a pointing device (e.g., a mouse, a trackpad, a trackball, a touch screen that can determine contact from a stylus and/or a finger). In one example, a user can provide numeric or alphanumeric input that indicates the second position of the search region. In another example, the user can utilize a pointing device to “drag” the search region to the second position.

At 17030, a position of the search region can be changed to the second position. In one or more embodiments, one or more systems, methods, and/or processes described herein can utilize the second position of the search region. In one example, search region 4110 may no longer be associated with a location, as illustrated in FIG. 20. In a second example, search region 5110 can be associated with locations 1235 and 1240, as illustrated in FIG. 20. In another example, search region 8110 can be associated with location 1220, as shown in FIG. 20. In one or more embodiments, one or more queries can be generated that utilize a second position of a search region.

Turning now to FIG. 18, a method of changing a size of a search region is illustrated, according to one or more embodiments. At 18010, input selecting a search region, of a first size, can be received. In one example, a first computing device can receive input from a second computing device which selects a search region. In another example, a computing device can receive user input that selects a search region. For instance, a search region of search regions 4110, 5110, and 8130, as shown in FIG. 19, can be selected. In one or more embodiments, one or more of map 4010 and search regions 4110, 5110, and 8130 can be displayed to a user via one or more of a screen, a projector, a GUI, and a display, among others, and the user input that selects a search region can be received via a keyboard and/or a pointing device (e.g., a mouse, a trackpad, a trackball, a touch screen that can determine contact from a stylus and/or a finger).

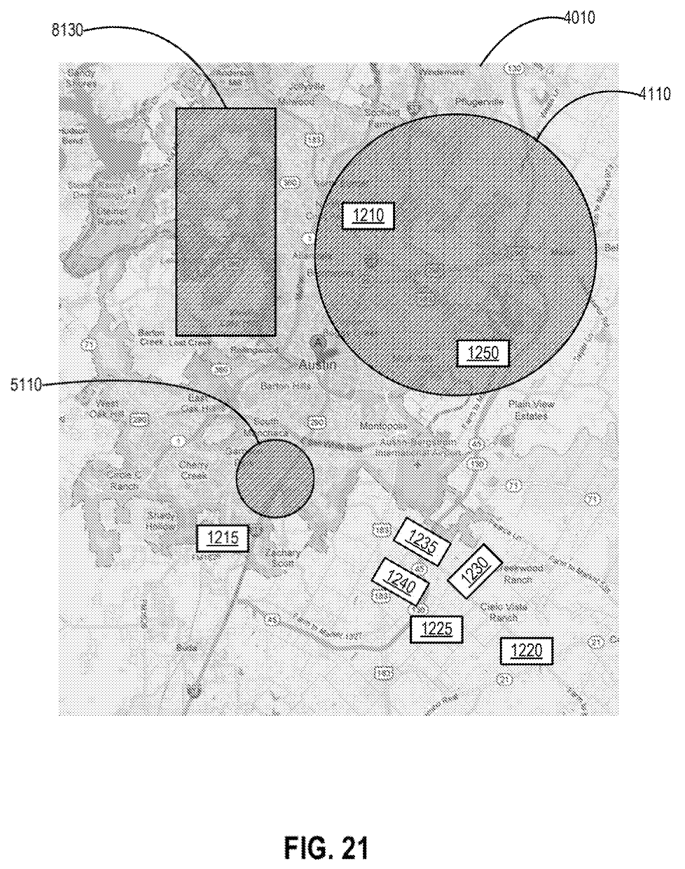

At 18020, input indicating a change of size of the search region from the first size to a second size. In one example, a first computing device can receive input from a second computing device which provides data to the first computing device that indicates the change of size of the search region from the first size to the second size. In another example, a computing device can receive user input that indicates a change of the size search region, of the first size, to a second size. For instance, a search region of search regions 4110, 5110, and 8130, as shown in FIG. 19, can be changed from a size position to a second size as shown in FIG. 21.

In one or more embodiments, one or more of map 4010 and search regions 4110, 5110, and 8130 can be displayed to a user via one or more of a screen, a projector, a GUI, and a display, among others, and the user input that indicates a change of a size search region, of a first size, to a second size can be received via a keyboard and/or a pointing device (e.g., a mouse, a trackpad, a trackball, a touch screen that can determine contact from a stylus and/or a finger). In one example, a user can provide numeric or alphanumeric input that indicates the second size of the search region. In another example, the user can utilize a pointing device to “drag” an edge of a search region to change the size of the search region.

At 18030, a size of the search region can be changed to the second size. In one or more embodiments, one or more systems, methods, and/or processes described herein can utilize the second size of the search region. In one example, search region 4110 can be associated with locations 1210 and 1250, as illustrated in FIG. 21. In a second example, search region 5110 may no longer be associated with a location, as illustrated in FIG. 21. In another example, search region 8110 may not be associated with a location, as illustrated in FIG. 21. In one or more embodiments, one or more queries can be generated that utilize a second size of a search region.

Turning now to FIG. 22, exemplary search results are illustrated, according to one or more embodiments. As illustrated, one or more search results 22210-22232 can be provided via a map 22010. For example, the one or more search results 22210-22232 and/or map 22010 can be provided to a user via a display and/or a GUI.

As shown, a search region 22110 can be provided via map 22010. As illustrated, icons can indicate one or more locations of respective one or more search results 22210-22232. In one or more embodiments, a number of computing devices and/or user accounts corresponding to the one or more search results 22210-22232 can be indicated. For example, a number within a characters “|” can indicate an amount (e.g., an integral number) of computing devices and/or user accounts corresponding to the one or more search results 22210-22232.

In one or more embodiments, one or more icons corresponding to the one or more search results 22210-22232 can be customized. In one example, a user can select the one or more icons. In a second example, an icon can be sized in an accordance with an amount (e.g., an integral number) of computing devices and/or user accounts corresponding to the search result.

In another example, an icon can be sized in an accordance with a radius of uncertainty of a location corresponding to the search result. For instance, each of one or more locations provided via one or more of a GPS device, an access point, a WTNN, multilateration, trilateration, and triangulation, among others, can be associated with a radius of uncertainty.

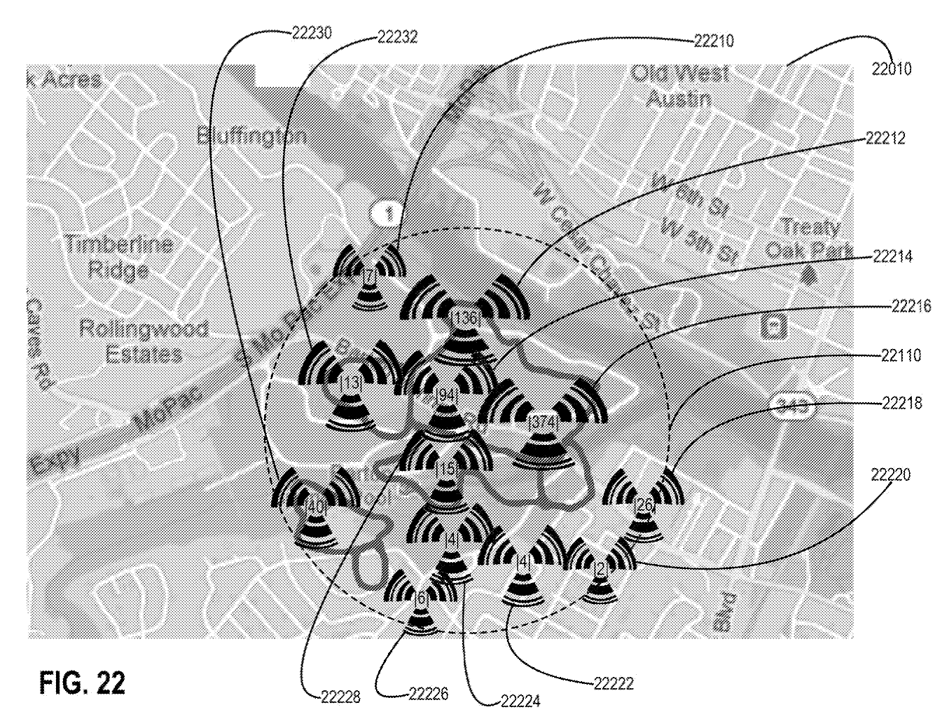

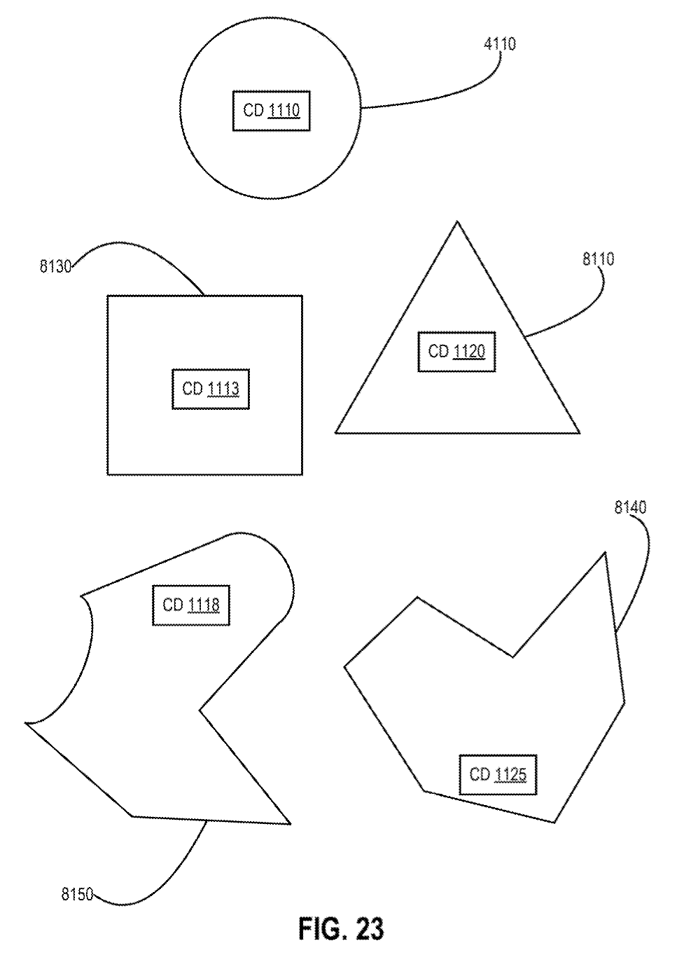

In one or more embodiments, a search region can be associated with a computing device. In one example, search region 4110, as illustrated in FIG. 23, can correspond to and/or be associated with CD 1110. In a second example, search region 8130, as illustrated in FIG. 23, can correspond to and/or be associated with CD 1113. In a third example, search region 8110, as illustrated in FIG. 23, can correspond to and/or be associated with CD 1120. In a fourth example, search region 8150, as illustrated in FIG. 23, can correspond to and/or be associated with CD 1118. In another example, search region 8140, as illustrated in FIG. 23, can correspond to and/or be associated with CD 1125.

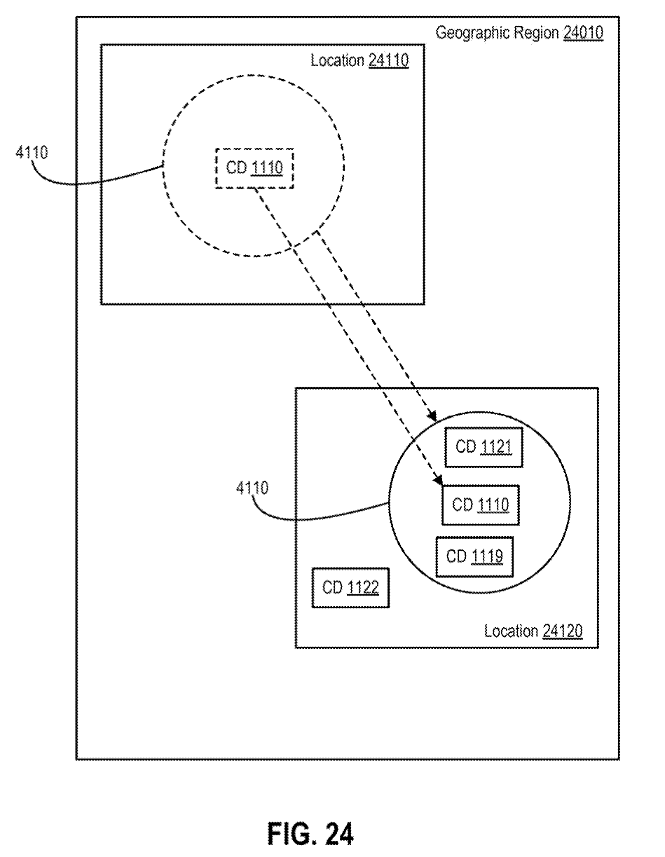

In one or more embodiments, a search region corresponding to and/or associated with a computing device can move and/or propagate with and/or when the computing device moves and/or propagates. In one or more embodiments, one or more methods, processes, and/or systems described here that provides and/or implements a search region that moves and/or propagates with a user and/or a computing device of the user can be included in a mobile lens system. In one example, as illustrated in FIG. 24, search region 4110 can move and/or propagate with CD 1110 as CD 1110 moves and/or propagates in a geographic region 24010 (where dashed lines indicate previous positions and movements/propagations of the devices and search regions). For instance, search region 4110 can move and/or propagate with CD 1110 as CD 1110 moves and/or propagates from a location 24110 to location 24120. As shown, search region 4110 (at location 24120) can include CDs 1119 and 1121 and/or can exclude CD 1122.

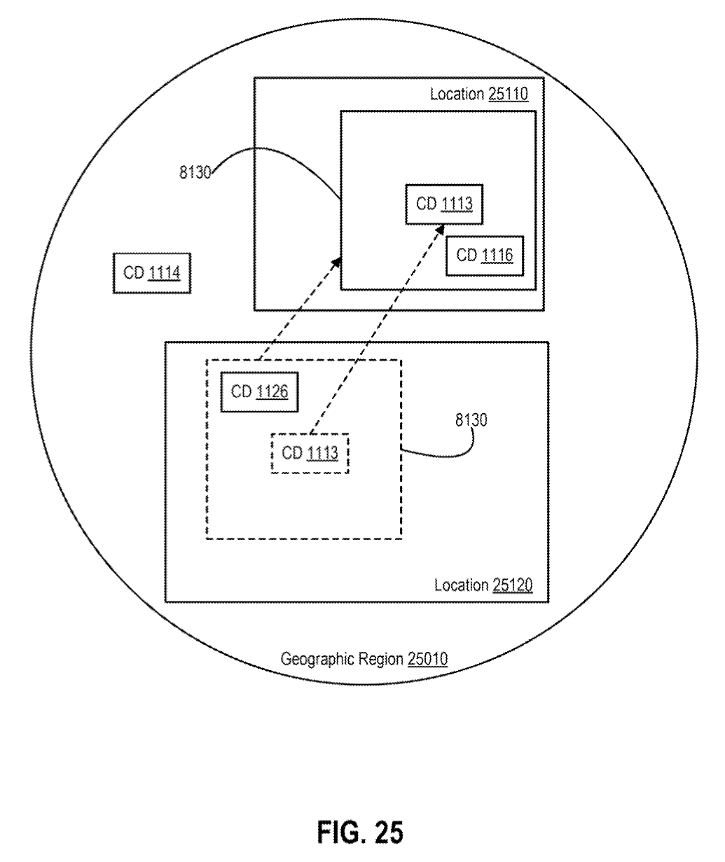

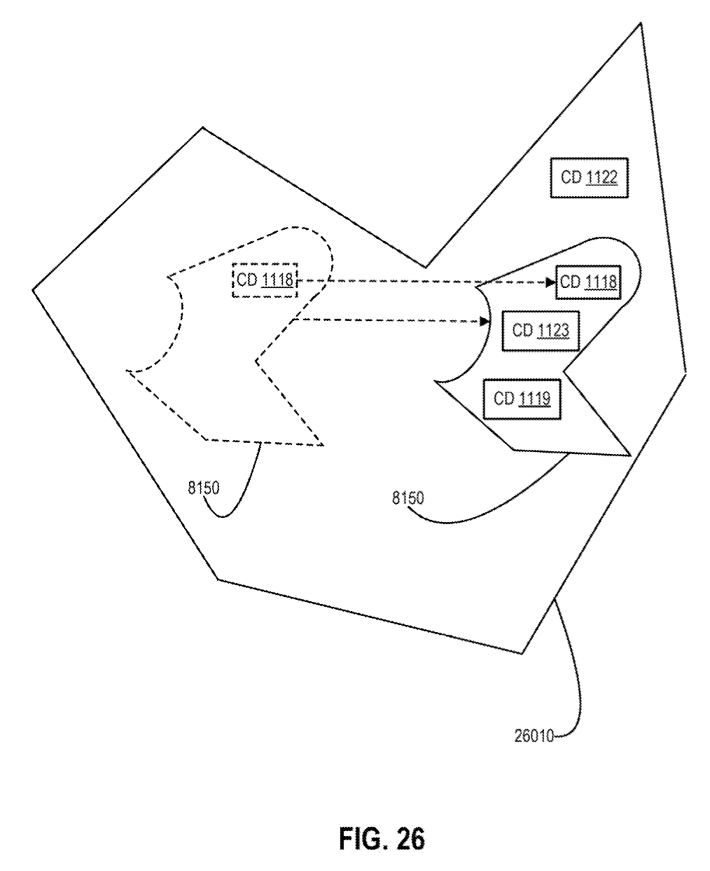

In a second example, as illustrated in FIG. 25, search region 8130 can move and/or propagate with CD 1113 as CD 1113 moves and/or propagates in a geographic region 25010. For instance, search region 8130 can move and/or propagate with CD 1113 as CD 1113 moves and/or propagates from a location 25110 to location 25120. As shown, search region 8130 (at location 25120) can include CD 1116 and/or can exclude CD 1114. In another example, search region 8150 can move and/or propagate with CD 1118 as CD 1118 moves and/or propagates in a geographic region 26010, as illustrated in FIG. 26. For instance, search region 8150 can move and/or propagate with CD 1118 as CD 1118 moves and/or propagates from one place to another. As shown, search region 8150 (at the other place) can include CDs 1119 and 1123 and/or can exclude CD 1122. In another example, search region 8150 can be configured to automatically exclude and/or or filter CD 1118 and/or CDs 1119 and 1123 from search region 8150 as it moves and/or propagates with CD 1118 from one place to another. For example, CD 1118 and/or CDs 1119 and 1123 can be identified by identification information, including at least one of a CPU identification, a electronic serial number (ESN), a mobile information number (MIN), a mobile directory number (MDN), a cookie identification, an operating system (OS) identifier, a media access control (MAC) address, a subscriber identifier, a virtual local area network (VLAN) identification, a Internet protocol (IP) address, a cellular phone number, and some other means of device identification. In one example, search region 8150 is configured to exclude the identified device by reshaping the search region 8150. In another example, search region 8150 is configured to exclude the identified device by filtering any monitoring of the identified device performed within the search region 8150.

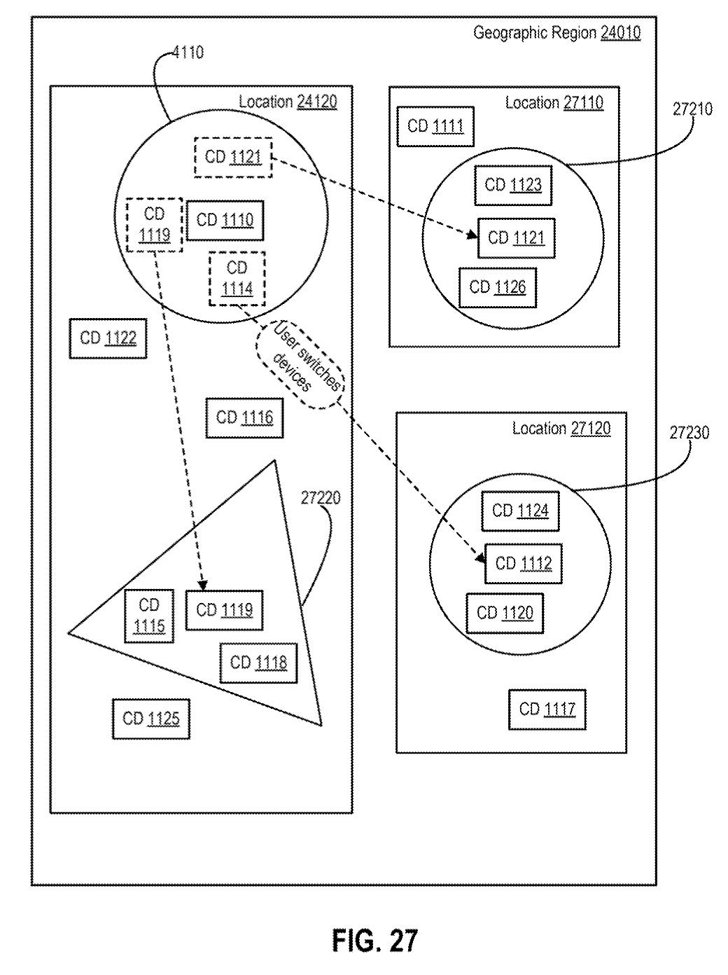

In one or more embodiments, a search region, moving and/or propagating with a computing device as the computing device moves and/or propagates (e.g., moves and/or propagates in a geographic region), can group and/or associate one or more other computing devices (and/or user(s) of the one or more other computing devices) with the computing device and/or a user of the computing device. In one example, CDs 1121 and 1119 can be grouped and/or associated with CD 1110, a user of CD 1110, and/or search region 4110 (as shown in FIG. 24). In a second example, CD 1126 and/or CD 1116 can be grouped and/or associated with CD 1113, a user of CD 1113, and/or search region 8130 (as illustrated in FIG. 25). In a third example, CD 1123 and/or CD 1119 can be grouped and/or associated with CD 1118, a user of CD 1118, and/or search region 8150 (as shown in FIG. 26). In another example, one or more of CDs 1119, 1114, 1121, 1115, 1118, 1123, 1126, 1124, and 1120 can be grouped and/or associated with CD 1110 and/or a user of CD 1110 (as shown in FIG. 27).

In one or more embodiments, a search region, moving and/or propagating with a computing device as the computing device moves and/or propagates (e.g., moves and/or propagates in a geographic region), can group and/or associate one or more locations with the computing device and/or a user of the computing device. In one example, locations 24110 and 24120 can be grouped and/or associated with CD 1110, a user of CD 1110, and/or search region 4110 (as shown in FIG. 24). In a second example, locations 25110 and 25120 can be grouped and/or associated with CD 1113, a user of CD 1113, and/or search region 8130 (as illustrated in FIG. 25). In a third example, location 26010 can be grouped and/or associated with CD 1118, a user of CD 1118, and/or search region 8150 (as shown in FIG. 26).

In one or more embodiments, as a computing device moves and/or propagates (e.g., moves and/or propagates in a geographic region) one or more other computing devices (and/or user(s) of the one or more other computing devices) can be grouped and/or associated with the computing device and/or a user of the computing device, and the one or more other computing devices (and/or the user(s) of the one or more other computing devices) can be utilized in grouping and/or associating additional one or more computing devices (and/or additional user(s) of the additional one or more other computing devices). In one example, CD 1121 can move and/or propagate from location 24120 to a location 27110, as illustrated in FIG. 27. In one or more embodiments, a search region 27210 can be utilized and/or associated with CD 1121. As shown, search region 27210 can include one or more or CDs 1123 and 1126. In a second example, CD 1119 can move and/or propagate from a first position associated with location 24120 to a second position associated with location 24120, as illustrated in FIG. 27. In one or more embodiments, a search region 27220 can be utilized and/or associated with CD 1119. As shown, search region 27210 can include one or more or CDs 1115 and 1126.

In one or more embodiments, as a computing device moves and/or propagates (e.g., moves and/or propagates in a geographic region) one or more other computing devices (and/or user(s) of the one or more other computing devices) can be grouped and/or associated with the computing device and/or a user of the computing device, and the one or more other computing devices (and/or the user(s) of the one or more other computing devices) can be utilized in grouping and/or associating locations, where the other computing devices are located and/or have moved and/or propagated with CD 1110, a user of CD 1110, and/or search region 4110. For example, one or more of CDs 1119, 1114, 1121, 1115, 1118, 1123, 1126, 1124, and 1120 can be grouped and/or associated with CD 1110 and/or a user of CD 1110 (as shown in FIG. 27), and one or more of locations 24110, 24120, 27120 and 27220, where CDs 1119, 1114, 1121, 1115, 1118, 1123, 1126, 1124, and 1120 are and/or have been located, can be grouped and/or associated with CD 1110 and/or a user of CD 1110 (as shown in FIG. 27) based on the grouping and/or association therewith.

In one or more embodiments, a first user or entity can monitor communications of a second user and/or associated with a second user via grouping and/or a mobile lens system. In one example, a parent can monitor, via grouping and/or a mobile lens system, social network communications of a child of the parent and/or social network communications of computing devices and/or users of the computing devices around the child over a period of time transpiring and/or as the child moves from place to place. In a second example, a school administrator can monitor, via grouping and/or a mobile lens system, social network communications of a student and/or social network communications of computing devices and/or users of the computing devices around the student over a period of time transpiring and/or as the student moves from place to place.

In a third example, a law officer can monitor, via grouping and/or a mobile lens system, social network communications of a person (e.g., a confidential informant, a person of interest, a suspect, etc.) and/or social network communications of computing devices and/or users of the computing devices around the person over a period of time transpiring and/or as the person moves from place to place. In a fourth example, a rating entity (e.g., a television rating entity, Nielson rating entity, a music rating entity, Billboard rating entity, etc.) can monitor, via grouping and/or a mobile lens system, social network communications of one or more persons and/or social network communications of computing devices and/or users of the computing devices around the one or more persons over a period of time transpiring and/or as the one or more persons moves from place to place. For instance, the rating entity can determine and/or formulate a survey and/or an unbiased survey of one or more performances, of one or more advertisements, and/or of promotions, via grouping and/or a mobile lens system.

In one or more embodiments, a user of a first computing device at a first position and/or first location can utilize a second computing device at a second position and/or second location, and a search region can be utilized and/or associated with the second computing device, second position, and/or second location. In one example, the user can utilize a first user account with the first computing device and can utilize the first user account with the second computing device. In a second example, the user can utilize the first user account with the first computing device and can utilize a second, different from the first, user account with the second computing device, where the second user account can be linked to and/or associated with the first account. As illustrated, in one or more embodiments, a search region 27230 can be utilized and/or associated with CD 1112, where a user of CD 1114 can switch to CD 1112. As shown, search region 27230 can include one or more or CDs 1124 and 1120. In one or more embodiments, search region 4110 can be utilized and/or associated with CD 1112, where a user of CD 1114 has switched to CD 1112, and where search region 4110 can be moved and/or propagated to location 27120 to cover CD 1112. For example, search region 4110 can include one or more or CDs 1124 and 1120 in addition to CD 1112 in location 27120.

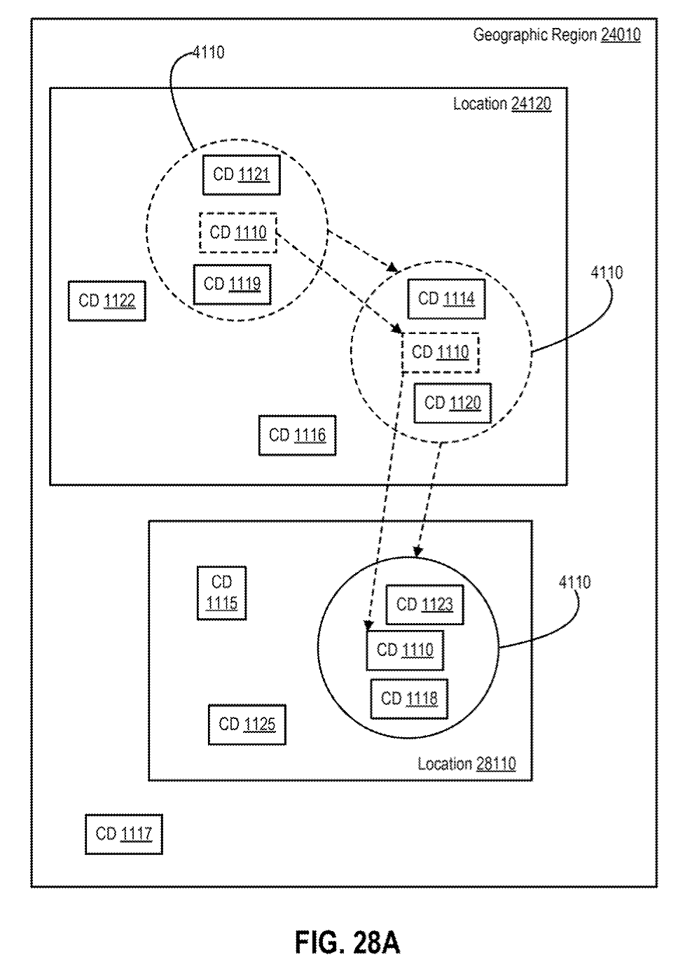

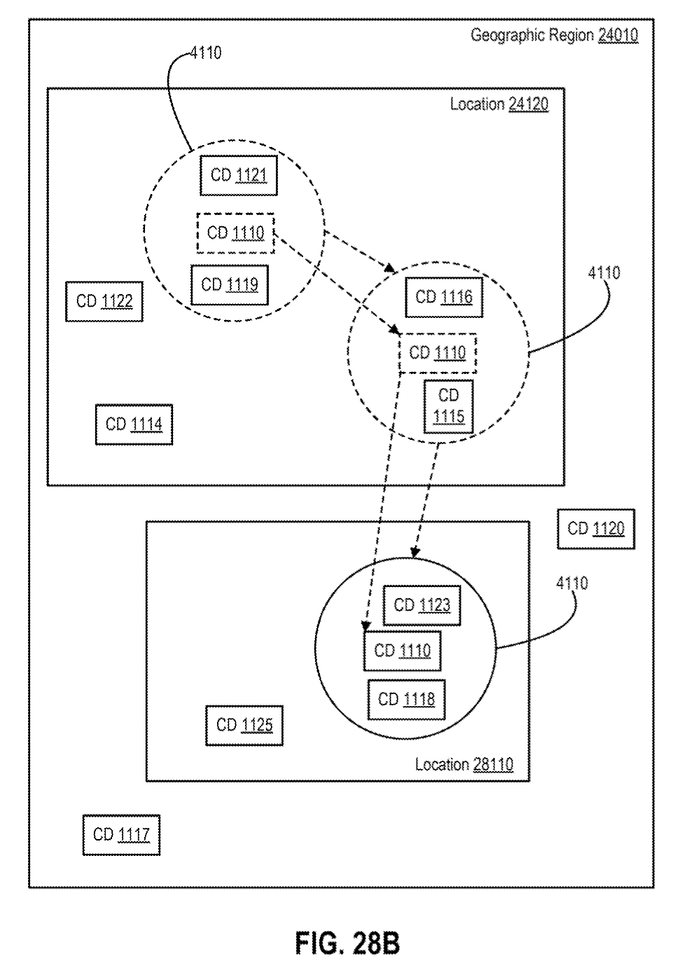

In one or more embodiments, a search region corresponding to and/or associated with a computing device can move and/or propagate with and/or when the computing device moves and/or propagates through and/or via multiple positions with a location and/or through and/or via multiple locations. In one example, search region 4110 can move and/or propagate with CD 1110 as CD 1110 moves and/or propagates from a first position in and/or at location 24120 to a second position in and/or at location 24120, as illustrated in FIG. 28A (where dashed lines indicate first and second positions and movements/propagations of the devices and search regions). In one example, a search region can follow a user's cell phone as it is moved by the user into various rooms throughout a home location. As shown, search region 4110 at the first position in and/or at location 24120 can include CDs 1119 and 1121. As illustrated, search region 4110 at the second position in and/or at location 24120 can include CDs 1114 and 1120. In one example, a search region can include cell phones or other computing devices of other users located within the search region moving with a user's cell phone or other computing device from room to room in a building and/or building to building.

In another example, search region 4110 can move and/or propagate with CD 1110 as CD 1110 moves and/or propagates from the second position in and/or at a first location to a second location. For instance, search region 4110 can move and/or propagate with CD 1110 as CD 1110 moves and/or propagates from the second position in and/or at location 24120 to a location 28110. For example, a search region can follow a user's cell phone as it is moved by the user into a neighboring home or building. As shown, search region 4110 at the second position in and/or at location 24120 can include CDs 1119 and 1121. As illustrated, search region 4110 at location 28120 can include CDs 1118 and 1123.

In one or more embodiments, search region 4110 can remain at a location and/or position for an amount of time transpiring. In one example, search region 4110 can remain at the second position for an amount of time transpiring. For instance, one or more of CDs 1115 and 1116 can be positioned into search region 4110, as illustrated in FIG. 28B, before the amount of time transpires and search region 4110 can include one or more of CDs 1115 and 1116. In another example, a query associated with the location and/or position can expire after the amount of time transpires.

In one or more embodiments, search region 4110 can be moved to a location and/or position associated with a location of a computing device in the past, present, or future. In one example, search region 4110 can move to the first position within location 24120 based on CD 1110 having been located there in the past. In a second example, search region 4110 can remain at the location 24110 based on CD 1110 having a present location at that position/location. In another example, search region 4110 can move to the second position (or another position or location) based on a prediction that CD 1110 will move and/or propagate to that position/location in the future.

In one or more embodiments, predictive analytics can be utilized to determine and/or predict a location CD 1110 will be located in the future based on a number of inputs. For example, regarding a computing device and/or a user of a computing device and/or regarding past and/or present, one or more of a position, location, an identification, an email address, a physical address, an occupation, a gender, a marital status, a purchase, an interest, a transaction, a habit, and an activity, among others, can be utilized as input(s) to a predictive analytics method, process, and/or system. In one or more embodiments, a mobile lens system utilizes predicted one or more future locations of a computing device to move a search region (also referred to as a lens) along a predicted future path of the computing device, for example, a computing device in or part of a vehicle, to retrieve social network data and/or information provided by computing devices within the predicted future path.

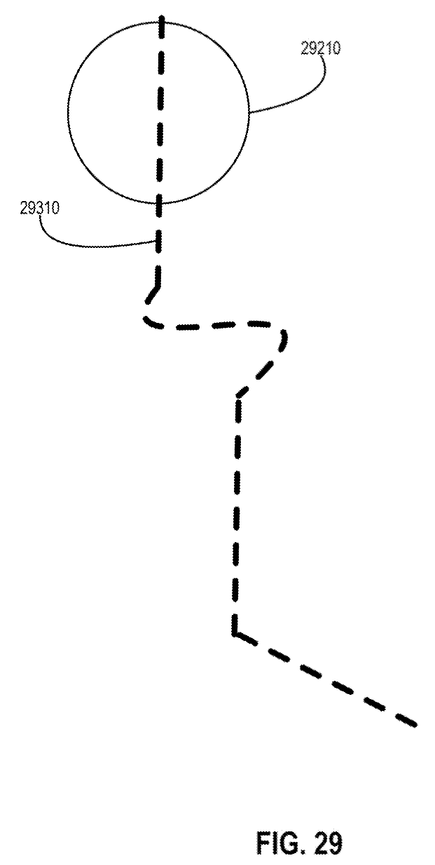

In one or more embodiments, a search region can be associated with a path (e.g., one or more portions of one or more walkways, trails, airways, roads, railways, and/or waterways, etc.). For example, a search region 29210 can be associated with a path 29310, as illustrated in FIG. 29. For instance, search region 29210 can traverse path 29310 at a time and/or over an amount of time transpiring. In another instance, search region 29210 can traverse path 29310 as a computing device moves and/or propagates along the path 29210.

In one or more embodiments, the path (e.g., path 29310) can be received via user input. In one example, a user can select one or more of a roadway, a railway, and a waterway, among others, from a map as the path. In another example, a user can provide waypoints (e.g., geographic positions such as latitude and longitude points) that can be utilized to interpolate and/or as the path. In one or more embodiments, the path (e.g., path 29310) can be determined from multiple positions of a computing device. In one example, the computing device can provide position information over a period of time transpiring. For instance, the computing device can receive position information from a GPS device (e.g., included in the computing device, coupled to the computing device, etc.) over a period of time transpiring and provide the position information from the GPS device to another computing device (e.g., via a cellular telephone network, a satellite telephone network, a wide area network, the Internet, etc.) over the period of time transpiring.

In a second example, a system can determine position information of the computing device over a period of time transpiring. For instance, one or more of an advertising truck, a supply truck (e.g., a gasoline truck, a grocery store truck, a container truck, etc.), a boat, a ship (e.g., a container ship, a cruise ship, an oil tanker ship, etc.), a bus, a train, a subway train, an elevated train, and an unmanned vehicle (e.g., an autonomous vehicle, a remotely operated vehicle, an unmanned aerial vehicle, etc.), among others, can record and/or provide position information corresponding to and/or associated with one or more portions of its route, and the path (e.g., path 29310) can be determined and/or constructed utilizing the position information.

In one or more embodiments, one or more of an advertising truck, a supply truck (e.g., a gasoline truck, a grocery store truck, a container truck, etc.), a boat, a ship (e.g., a container ship, a cruise ship, an oil tanker ship, etc.), a bus, a train, a subway train, an elevated train, and an unmanned vehicle (e.g., an autonomous vehicle, a remotely operated vehicle, an unmanned aerial vehicle, etc.), among others, can include a computing device that can receive position information from a GPS device (e.g., included in the computing device, coupled to the computing device, etc.) over a period of time transpiring and provide the position information from the GPS device to another computing device (e.g., via a cellular telephone network, a satellite telephone network, a wide area network, the Internet, etc.) over the period of time transpiring. In one example, the one or more of the advertising truck, the supply truck (e.g., the gasoline truck, the grocery store truck, the container truck, etc.), the boat, the ship (e.g., the container ship, the cruise ship, the oil tanker ship, etc.), the bus, the train, the subway train, the elevated train, and the unmanned vehicle (e.g., the autonomous vehicle, the remotely operated vehicle, the unmanned aerial vehicle, etc.), among others, can traverse a path (e.g., path 29310). In another example, an armed service(s) and/or expeditionary vehicle can traverse a path (e.g., path 29310) and can include a computing device that can receive position information from a GPS device (e.g., included in the computing device, coupled to the computing device, etc.) over a period of time transpiring and provide the position information from the GPS device to another computing device (e.g., via a cellular telephone network, a satellite telephone network, a wide area network, the Internet, etc.) over the period of time transpiring.

In one or more embodiments, utilizing a mobile lens system can provide information as to what people are communicating about and/or related to a vehicle traversing a path (e.g., path 29310) and/or about the vehicle that traversed the path. For example, the vehicle can be associated with one or more of a corporation, an armed service, a country, a service, and an operator of the vehicle, among others, and a mobile lens system can provide information as to what people are communicating about the one or more of the corporation, the armed service, the country, the service, and the operator of the vehicle, among others. In one instance, the mobile lens system can provide one or more portions of social network data communications that corresponds to one or more of the vehicle, the corporation, the armed service, the country, the service, and the operator of the vehicle, among others. For example, a mobile lens system can provide a search region tracking the movements of a vehicle such as a military vehicle and retrieve social network data communications from computing devices such as computing devices of combatants along the path of the vehicle based on user-provided social network data provided within the search region as it tracked the vehicle along the path. In one instance, the mobile lens system can provide one or more portions of information of one or more social networks that corresponds to one or more of the vehicle, the corporation, the armed service, the country, the service, and the operator of the vehicle, among others.

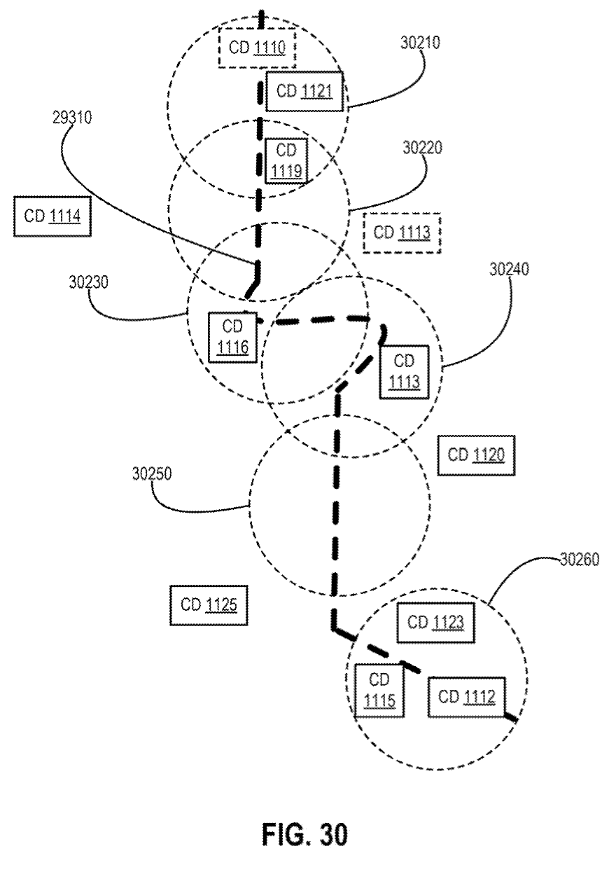

As illustrated in FIG. 30, search regions 30210-30260 can represent search region 29210 at one or more points in time and/or over one or more amounts of time transpiring, according to one or more embodiments. As shown, search region 30210 (at a first position, at a first point in time, and/or over a first period of time transpiring) can include CDs 1110, 1119, and 1121 and/or can exclude CDs 1112, 1113, 1114, 1115, 1116, 1120, 1123, and 1125. As illustrated, search region 30220 (at a second position, at a second point in time, and/or over a second period of time transpiring) can include CD 1119 and/or can exclude CDs 1110, 1112, 1113, 1114, 1115, 1116, 1120, 1121, 1123, and 1125. As shown, search region 30230 (at a third position, at a third point in time, and/or over a third period of time transpiring) can include CD 1116 and/or can exclude CDs 1110, 1112, 1113, 1114, 1115, 1119, 1120, 1121, 1123, and 1125.

As illustrated, search region 30240 (at a fourth position, at a fourth point in time, and/or over a fourth period of time transpiring) can include CD 1113 (which may have previously moved from a position excluded from search region 30240 as illustrated by CD 1113 in dashed line) and/or can exclude CDs 1110, 1112, 1114, 1115, 1116, 1119, 1120, 1121, 1123, and 1125. As shown, search region 30250 (at a fifth position, at a fifth point in time, and/or over a fifth period of time transpiring) may not include any computing devices and/or can exclude CDs 1110, 1112, 1113, 1114, 1115, 1116, 1119, 1120, 1121, 1123, and 1125. As illustrated, search region 30260 (at a sixth position, at a sixth point in time, and/or over a sixth period of time transpiring) can include CDs 1112, 1115, and 1123 and/or can exclude CDs 1110, 1113, 1114, 1116, 1119, 1120, 1121, and 1125.

In one or more embodiments, one or more of search regions 30210-30260 can correspond to and/or be associated with one or more points in time and/or one or more amounts of time transpiring. In one example, search regions 30210-30260 can correspond to and/or be associated with one or more points in time that at least one of an advertising truck, a supply truck (e.g., a gasoline truck, a grocery store truck, a container truck, etc.), a boat, a ship (e.g., a container ship, a cruise ship, an oil tanker ship, etc.), a bus, a train, a subway train, and an elevated train, among others, traversed path 29310. In a second example, search regions 30210-30260 can correspond to and/or be associated with one or more amounts of time transpiring that at least one of an advertising truck, a supply truck (e.g., a gasoline truck, a grocery store truck, a container truck, etc.), a boat, a ship (e.g., a container ship, a cruise ship, an oil tanker ship, etc.), a bus, a train, a subway train, an elevated train, and an unmanned vehicle (e.g., an autonomous vehicle, a remotely operated vehicle, an unmanned aerial vehicle, etc.), among others, traversed path 29310.

For instance, search regions 30210-30260 can be associated with respective first through sixth amounts of time transpiring, where two or more of the six amounts of time transpiring are different, from one another, amounts of time transpiring. In one example, search region 30210 can be associated with at least a portion of a major and/or an important roadway (e.g., “Main Street”, “6th Street”, “Guadalupe Street”, etc.), and the first amount of time transpiring can be greater than one or more of the fourth amount of time transpiring and the fifth amount of time transpiring. In another example, search region 30210 can be associated with at least a portion of a major and/or an important railway and/or waterway, and the first amount of time transpiring can be greater than one or more of the fourth amount of time transpiring and the fifth amount of time transpiring.

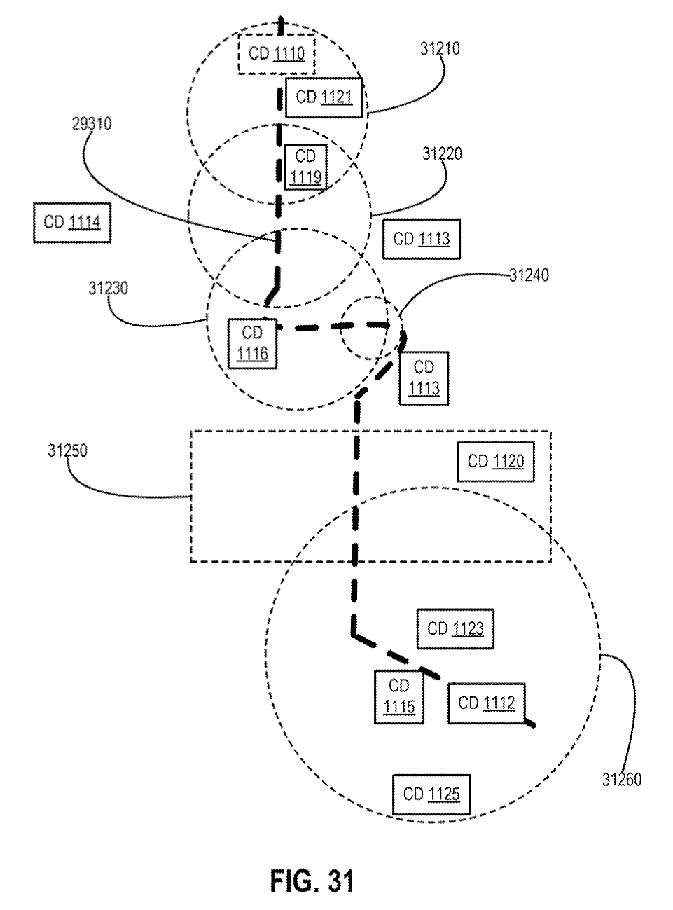

In one or more embodiments, multiple search regions can represent a search region at one or more points in time and/or over one or more amounts of time transpiring. For example, search regions 31210-31260 can represent search region 29210 at one or more points in time and/or over one or more amounts of time transpiring, as illustrated in FIG. 31. As shown, search region 31210 (at a first position, at a first point in time, and/or over a first period of time transpiring) can include CDs 1110, 1119, and 1121 and/or can exclude CDs 1112, 1113, 1114, 1115, 1116, 1120, 1123, and 1125. As illustrated, search region 31220 (at a second position, at a second point in time, and/or over a second period of time transpiring) can include CD 1119 and/or can exclude CDs 1110, 1112, 1113, 1114, 1115, 1116, 1120, 1121, 1123, and 1125. As shown, search region 31230 (at a third position, at a third point in time, and/or over a third period of time transpiring) can include CD 1116 and/or can exclude CDs 1110, 1112, 1113, 1114, 1115, 1119, 1120, 1121, 1123, and 1125.

As illustrated, search region 31240 (at a fourth position, at a fourth point in time, and/or over a fourth period of time transpiring) may not include any computing devices, can exclude CDs 1110, 1112, 1113, 1114, 1115, 1116, 1119, 1120, 1121, 1123, and 1125, and/or can include a different size and/or geographic area covered than search region 29210. As shown, search region 31250 (at a fifth position, at a fifth point in time, and/or over a fifth period of time transpiring) can include CD 1120, can exclude CDs 1110, 1112, 1113, 1114, 1115, 1116, 1119, 1121, 1123, and 1125, and/or can include a different size and/or geographic area covered as search region 29210 and/or can include a different shape as search region 29210. As illustrated, search region 31260 (at a sixth position, at a sixth point in time, and/or over a sixth period of time transpiring) can include CDs 1112, 1115, 1123, and 1125, can exclude CDs 1110, 1113, 1114, 1116, 1119, 1120, and 1121, and/or can include a different size and/or geographic area covered than search region 29210.

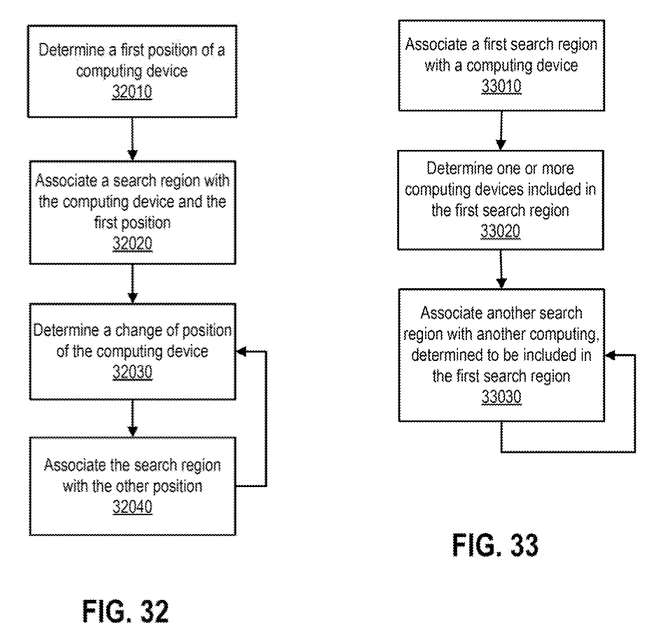

Turning now to FIG. 32, a method that moves and/or propagates a search region corresponding to and/or associated with a computing device when the computing device moves and/or propagates is illustrated, according to one or more embodiments. At 32010, a first position of a computing device can be determined. For example, one or more methods, processes, and systems, described herein, can determine the first position of the computing device. In one instance, one or more methods, processes, and systems, described herein, can determine a first position of CD 1110, as shown in FIG. 24 (where dashed lines indicate first positions and movements/propagations of the devices and search regions). In a second instance, one or more methods, processes, and systems, described herein, can determine a first position of CD 1113, as shown in FIG. 25 (where dashed lines indicate first positions and movements/propagations of the devices and search regions). In a third instance, one or more methods, processes, and systems, described herein, can determine a first position of CD 1113, as shown in FIG. 26. In another instance, one or more methods, processes, and systems, described herein, can determine a first position of CD 1110, as shown in FIG. 28 (where dashed lines indicate first positions and movements/propagations of the devices and search regions).

At 32020, a search region can be associated with the computing device and the first position. In one example, search region 4110 can be associated with CD 1110 and its first position, as shown in FIG. 24. For instance, search region 4110, associated with CD 1110 and its first position, may not include any computing devices. In a second example, search region 8130 can be associated with CD 1113 and its first position, as shown in FIG. 25. For instance, search region 8130, associated with CD 1113 and its first position, can include CD 1126. In a third example, search region 8150 can be associated with CD 1118 and its first position, as shown in FIG. 26. For instance, search region 8150, associated with CD 1118 and its first position, may not include any computing devices. In another example, search region 4110 can be associated with CD 1110 and its first position, as shown in FIG. 28. For instance, search region 4110, associated with CD 1110 and its first position, can include CDs 1119 and 1126.

At 32030, a change of position of the computing device can be determined. In one or more embodiments, determining a change of position of the computing device can include determining another position of the computing that is different from a previous position of the computing device. In one example, one or more methods, processes, and systems, described herein, can determine another position of CD 1110, as shown in FIG. 24. In a second example, one or more methods, processes, and systems, described herein, can determine another position of CD 1113, as shown in FIG. 25. In a third example, one or more methods, processes, and systems, described herein, can determine another position of CD 1113, as shown in FIG. 26. In another example, one or more methods, processes, and systems, described herein, can determine another position of CD 1110, as shown in FIG. 28.

At 32040, the search region can be associated with the other position. In one example, search region 4110 can be associated with CD 1110 and its second position, as shown in FIG. 24. For instance, search region 4110, associated with CD 1110 and its second position, can include CDs 1119 and 1121. In a second example, search region 8130 can be associated with CD 1113 and its second position, as shown in FIG. 25. For instance, search region 8130, associated with CD 1113 and its second position, can include CD 1116. In a third example, search region 8150 can be associated with CD 1118 and its second position, as shown in FIG. 26. For instance, search region 8150, associated with CD 1118 and its second position, can include CDs 1119 and 1123. In another example, search region 4110 can be associated with CD 1110 and its second position, as shown in FIG. 28. For instance, search region 4110, associated with CD 1110 and its second position, can include CDs 1114 and 1120.

In one or more embodiments, the method can proceed to 32030. For example, a change of position of CD 1110 can be determined, at 32030. For instance, one or more methods, processes, and systems, described herein, can determine a third position of CD 1110, as shown in FIG. 28. At 32040, the search region can be associated with the other position of CD 1110. For example, search region 4110 can be associated with CD 1110 and its third position, as shown in FIG. 28. For instance, search region 4110, associated with CD 1110 and its third position, can include CDs 1118 and 1123.

Turning now to FIG. 33, a method that associates and/or instantiates a search region corresponding to and/or associated with a computing device is illustrated, according to one or more embodiments. At 33010, a first search region can be associated with a first computing device. For example, search region 4110 can be associated with CD 1110, as shown in FIG. 27. At 33020, one or more computing devices included the first search region can be determined. For example, CDs 1114, 1119, and 1121 can be determined to be included in search region 4110, as shown in FIG. 27.

At 33030, another search region can be associated with another computing device, determined to be included in the first search region. For example, a search region 27220 can be associated with CD 1119, as shown in FIG. 27. For instance, search region 27220 can include CDs 1115 and 1118. In one or more embodiments, the method can proceed to 33030. For example, the method can proceed to 33030 to process an additional computing device that was determined to be included in the first search region. In one instance, the method can proceed to 33030 where a search region 27210 can be associated with CD 1121, as shown in FIG. 27, and search region 27210 can include CDs 1123 and 1126. In another instance, the method can proceed to 33030 where a search region 27230 can be associated with CD 1112, as shown in FIG. 27, and search region 27230 can include CDs 1120 and 1124.

In one or more embodiments, the method illustrated in FIG. 33 can be repeated. In one example, the method illustrated in FIG. 33 can be repeated where search region 27220 can be a first search region associated with CD 1119. In a second example, the method illustrated in FIG. 33 can be repeated where search region 27210 can be a first search region associated with CD 1121. In another example, the method illustrated in FIG. 33 can be repeated where search region 27230 can be a first search region associated with CD 1112.

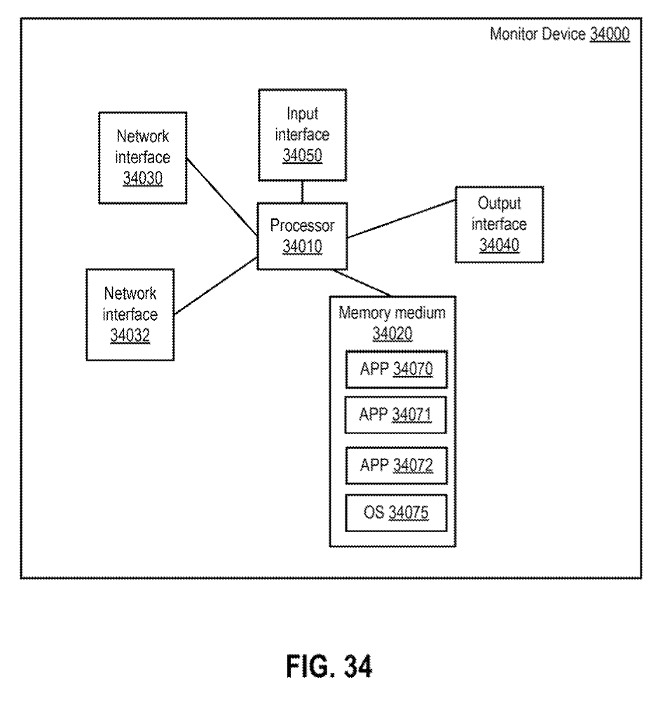

Turning now to FIG. 34, a monitoring device is illustrated, according to one or more embodiments. As shown, a monitor device 34000 can include a processor 34010 coupled to a memory medium 34020. In one or more embodiments, processor 34010 can include and/or implement an ISA that can include instructions that can be stored via memory medium 34020 and/or can be executable by processor 34010.

As illustrated, memory medium 34020 can include one or more APPs 34070-34072 and an OS 34075. In one or more embodiments, one or more of APPs 34070-34072 and OS 34075 can store instructions, executable by processor 34010, that can include one or more software programs in accordance with one or more of methods, processes and/or flowcharts described herein.

As illustrated, monitor device 34000 can include one or more network interfaces 34030 and 34032 coupled to processor 34010. In one example, network interface 34030 can be configured to couple monitor device 34000 to network 1010. In a second example, network interface 34030 can be configured to couple monitor device 34000 to a wireless AP. In a third example, network interface 34030 can be configured to couple monitor device 34000 to a wired AP or gateway (e.g., a cable modem, a DSL modem, a router, a switch, etc.).

In fourth example, network interface 34030 can be configured to couple monitor device 34000 to a wireless telephone network (e.g., a cellular telephone network, a satellite telephone network, etc.). In fifth example, network interface 34030 can be configured to couple monitor device 34000 to customer premise equipment (e.g., cable (television) modem, DSL (digital subscriber loop) modem, wireless modem, a fiber optic modem, etc.). In a sixth example, network interface 34032 can be configured to couple monitor device 34000 to a wireless AP. In seventh example, network interface 34032 can be configured to couple monitor device 34000 to a wired AP. In another example, network interface 34032 can be configured to perform wireless communications that can permit and/or enable monitor device 34000 to function as a wireless AP (e.g., a WiFI AP, an IEEE 802.11 AP, an IEEE 802.16 AP, etc.).

As shown, monitor device 34000 can include an output interface 34040 coupled to processor 34010. In one example, output interface 34040 can include a display that can convey graphical information to a user. In another example, output interface 34040 can be configured to be coupled to a display that can convey graphical information to a user. In another example, output interface 34040 can include or can be configured to be coupled to an audio output device (e.g., a speaker).

As illustrated, monitor device 34000 can include an input interface 34050. In one example, input interface 34050 can include one or more of a keypad, one or more buttons, a keyboard, and a mouse, among others. In a second example, input interface 34050 can be configured to be coupled to one or more of a keyboard and a mouse, among others. In a third example, input interface 34050 can include an input of a touch screen. In a fourth example, input interface 34050 can include or can be configured to be coupled to an audio input device (e.g., a microphone). In another example, input interface 34050 can be configured to be coupled to an input of a touch screen.

In one or more embodiments, monitor device 34000 can monitor communications to and/or from one or more computing devices. For example, monitor device 34000 can monitor communications to and/or from one or more social networks. In one or more embodiments, monitor device 34000 can inspect and/or monitor packets (e.g., TCP packets, UDP packets, IP packets, media access control (MAC) packets, etc.) to and/or from one or more computing devices. For example, monitor device 34000 can inspect and/or monitor packets (e.g., TCP packets, UDP packets, IP packets, MAC packets, etc.) to and/or from to and/or from one or more social networks.

In one or more embodiments, a monitor device can include a FPGA coupled to a memory medium, and the memory medium can store data and/or configuration information that can be utilized by the FPGA in implementing one or more systems, methods, and/or processes described herein. For example, the configuration information and/or the one or more instructions can include a hardware description language and/or a schematic design that can be utilized by the FPGA to implement one or more systems, methods, and/or processes described herein. In one or more embodiments, the FPGA can include multiple programmable logic components that can be configured and coupled to one another in implementing one or more systems, methods, and/or processes described herein.

In one or more embodiments, the FPGA can be coupled to one or more of a network interface, an output interface, and an input interface. In one or more embodiments, one or more of the network interface, the output interface, and the input interface can provide and/or implement one or more structures and/or functionalities as described above.

In one or more embodiments, a monitor device can include an ASIC coupled to a memory medium. In one or more embodiments, the memory medium can store data and/or configuration information that can be utilized by the ASIC in implementing one or more systems, methods, and/or processes described herein. For example, the memory medium can store a configuration, and the configuration can include configuration information and/or one or more instructions that can be utilized by the ASIC to implement one or more systems, methods, and/or processes described herein. In one or more embodiments, the memory medium can store data and/or instructions that can be executed by the ASIC. For instance, one or more APPs and/or an OS can include instructions of an ISA associated with the ASIC.

In one or more embodiments, the ASIC can be coupled to one or more of a network interface, an output interface, and an input interface. In one or more embodiments, one or more of the network interface, the output interface, and the input interface can provide and/or implement one or more structures and/or functionalities as described above.

In one or more embodiments, a monitor device can include a GPU coupled to a memory medium. For example, the GPU can be or include a GPGPU. In one or more embodiments, the memory medium can store data and/or configuration information that can be utilized by the GPU in implementing one or more systems, methods, and/or processes described herein. For example, the memory medium can store a configuration, and the configuration can include configuration information and/or one or more instructions that can be utilized by the GPU to implement one or more systems, methods, and/or processes described herein.

In one or more embodiments, the GPU can be coupled to one or more of a network interface, an output interface, and an input interface. In one or more embodiments, one or more of the network interface, the output interface, and the input interface can provide and/or implement one or more structures and/or functionalities as described above.

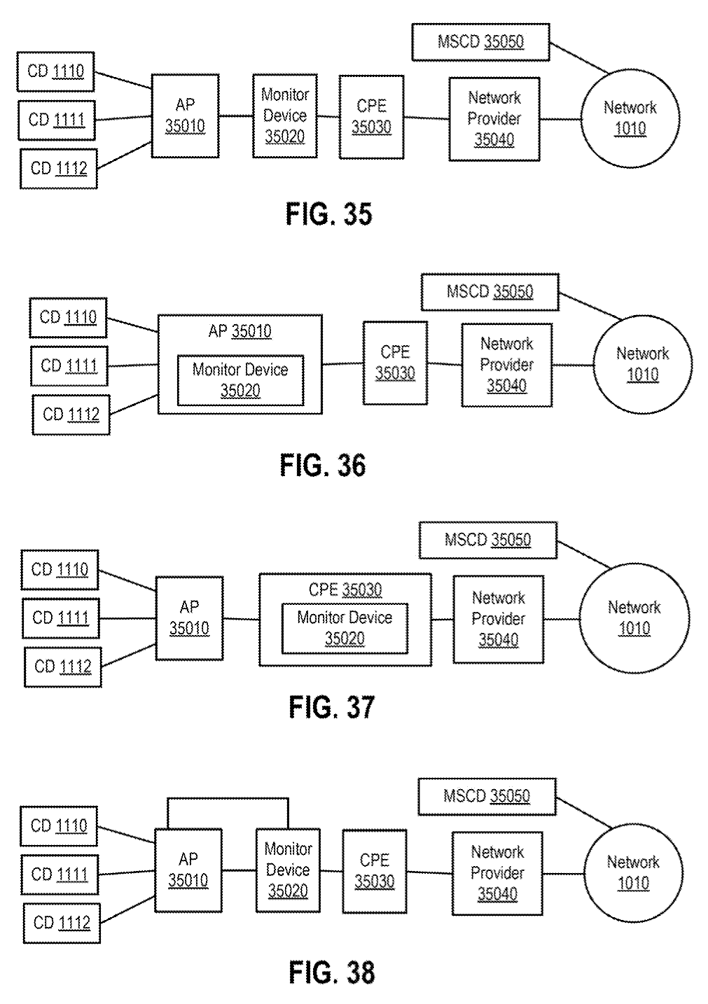

Turning now to FIGS. 35-38, exemplary network configurations that utilize a monitor device are illustrated, according to one or more embodiments. As shown in FIG. 35, one or more of CDs 1110-1112 can be coupled to an AP 35010. In one or more embodiments, AP 35010 can include one or more of a wireless AP and a wired AP. As illustrated, AP 35010 can be coupled to a monitor device 35020. In one or more embodiments, monitor device 35020 can include one or more functionalities and/or structures as those described with reference to monitor device 34000. As shown, monitor device 35020 can be coupled to customer premise equipment (CPE) 35030. In one or more embodiments, CPE can be or include one or more of a modem (e.g., a dial-in modem, an asynchronous transfer mode modem, a cable (television) modem, a DSL modem, a fiber optic modem, a metropolitan area network modem, a wireless metropolitan area network modem, a wired modem, a wireless modem, etc.), a router, an access controller, and a firewall, among others.

As illustrated, CPE 35030 can be coupled to a network provider 35040 that can be coupled to network 1010. In one or more embodiments, a network provider can provide access to and/or access of a network (e.g., network 1010). In one example, a network provider can be AT&T. In a second example, a network provider can be Time Warner Cable. In a third example, a network provider can be Dish Networks. In a fourth example, a network provider can be Verizon Wireless. In a fifth example, a network provider can be Comcast Cable. In a sixth example, a network provider can be Cox Cable. In a seventh example, a network provider can be Verizon Communications.

In one or more embodiments, a network provider can provide access to and/or access of a network (e.g., network 1010) via at least another network provider. For example, the network provider can utilized network access of and/or to the network via the at least the other network provider. For instance, the at least the other network provider can include at least one of AT&T, Dish networks, Time Warner Cable, Comcast Cable, Cox Cable, and Verizon Communications, among others.

In one or more embodiments, a monitor service computing device (MSCD) can utilize a monitor device as a social network media data source. For example, monitor device 35020 can communicate with a MSCD 35050 that can be coupled to network 1010, as illustrated. In one instance, monitor device 35020 can intercept and/or duplicate first data that is destined for a computing device (e.g., a computing device of a social network) coupled to network 1010 and/or intercept and/or duplicate second data that is coming from a computing device coupled to network 1010 (e.g., destined to one or more of CDs 1110-1112). In another instance, monitor device 35020 can provide one or more of the first data, the second data, a duplicate of at least a portion of the first data, and a duplicate of at least a portion of the second data to MSCD 35050. In one or more embodiments, MSCD 35050 can include one or more structures and/or functionalities of those described with reference to computer system 12000 and/or another computer system described herein.

In one or more embodiments, a monitor service computing device can store one or more configurations associated with respective one or more monitor devices. For example, a configuration associated with a monitor device can include a query that can include one or more of a word, multiples words, a phrase, a mood, a sentiment, a user profile, a portion of a user profile, a regular expression, a natural language filter, a grammar, a social group, an organization, and a user identification, among others.

In one or more embodiments, a monitor device can utilize first data that is destined for a computing device (e.g., a computing device of a social network) coupled to a network (e.g., network 1010) and/or intercept and/or duplicate second data that is coming from computing device coupled to the network (e.g., destined to one or more of CDs 1110-1112) as a social network media data source. For example, monitor device 35020 can store one or more queries that can include one or more of a word, multiples words, a phrase, a mood, a sentiment, a user profile, a portion of a user profile, a regular expression, a natural language filter, a grammar, a social group, an organization, and a user identification, among others.

In one or more embodiments, a monitor device can be located at a location such as a home, a business (e.g., a building, a portion of a building, etc.), a school, a campus, a dormitory, an entertainment center (e.g., an entertainment complex, a theatre, a concert hall, a sports complex, a stadium, etc.), a police precinct, a factory, a refinery, a storage facility, a power station, a power substation, and/or a military installation, among others. In one example, a monitor device can be utilized to alert one or more parents regarding at least one social network communication associated with a child of the one or more parents. In a second example, a monitor device can be utilized to alert one or more teachers and/or school administrators regarding at least one social network communication associated with one or more students of that school. In a third example, a monitor device can be utilized to alert one or more managers (e.g., managers, directors, executives, board members, etc.) of a business regarding at least one social network communication associated with one or more employees of the business. In another example, a monitor device can be utilized to alert one or more agents (e.g., security agents, custodians, wardens, managers, directors, executives, board members, etc.) of an entertainment center regarding at least one social network communication associated with one or more patrons of the entertainment center.

As illustrated in FIG. 36, AP 35010 can include monitor device 35020. In one or more embodiments, an AP (e.g., AP 35010) can include one or more structures and/or functionalities as those described with reference to a monitor device (e.g., monitor device 35020). As illustrated in FIG. 37, CPE 35030 can include monitor device 35020. In one or more embodiments, CPE (e.g., CPE 35030) can include one or more structures and/or functionalities as those described with reference to a monitor device (e.g., monitor device 35020).

As illustrated in FIG. 38, monitor device 35020 can interpose AP 35010 and CPE 35030. In one or more embodiments, a monitor device can inspect packets (e.g., TCP packets, UDP packets, IP packets, MAC packets, etc.) communicated between AP 35010 and CPE 35030. In one or more embodiments, a configuration, such as the configuration illustrated in FIG. 38, may not allow for a monitor device to provide data to network provider 35040, network 1010, or MSCD 35050. For example, an interface of CPE 35030 may not provide for the configuration illustrated in FIG. 38, where monitor device 35020 can provide data to network provider 35040, network 1010, or MSCD 35050.

In one or more embodiments, an AP can include multiple interfaces. For example, AP 35010 can include a first interface that can be coupled to CPE 35030 and can include a second interface that can be coupled to one or more of CDs 1110-1112. For instance, a computing device coupled to the second interface can utilize CPE 35030 via the first interface. As shown, monitor device 35020 can be coupled to AP 35010. For example, monitor device 35020 can be coupled to AP 35010 via a first interface of AP 35010 and can be coupled to AP 35010 via a second interface of AP 35010. For instance, monitor device 35020 can inspect packets (e.g., TCP packets, UDP packets, IP packets, MAC packets, etc.) communicated between AP 35010 and CPE 35030 via the coupling to the first interface of AP 35010, and monitor device 35020 can communicate with one or more of network provider 35040, network 1010, and MSCD 35050, among others, via the coupling to the second interface of AP 35010.

In one or more embodiments, a monitor device can identify data that it communicates to avoid a feedback loop and/or a recursive data loop from forming. In one example, monitor device 35020 can identify data that it communicates to one or more of network provider 35040, network 1010, and MSCD 35050, among others, via one or more of an IP address, a TCP port number, and a UDP port number, among others. In another example, monitor device 35020 can identify data that it communicates to one or more of network provider 35040, network 1010, and MSCD 35050, among others, via a one or more of a checksum and hash value (e.g., a cryptographic hash value), among others.

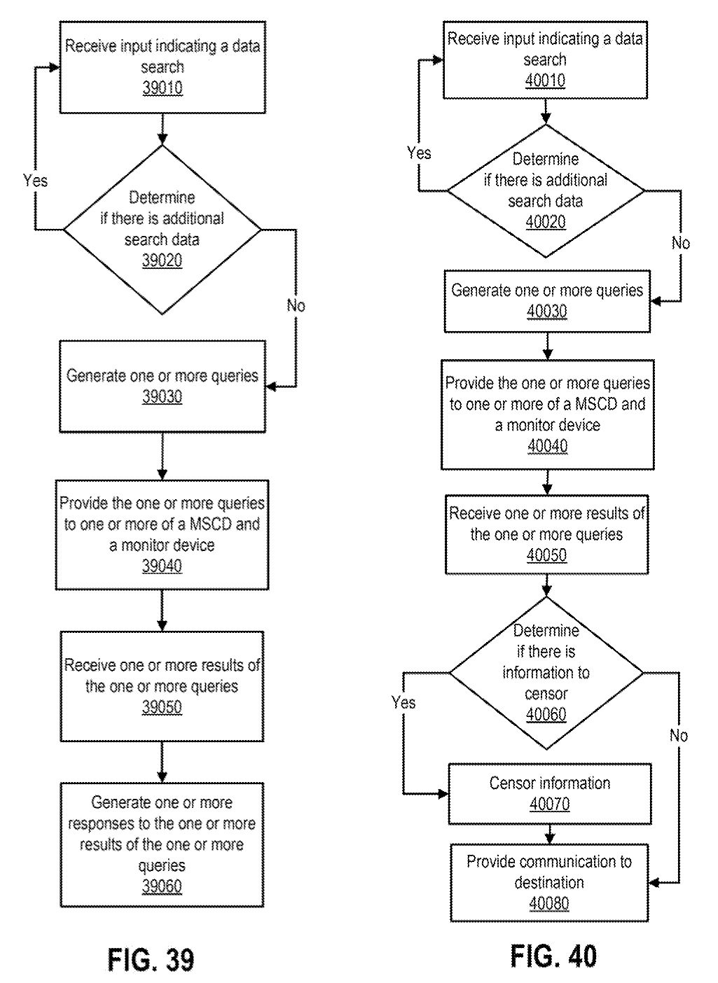

Turning now to FIG. 39, a method of operating a monitor is illustrated, according to one or more embodiments. In one or more embodiments, the method of operating a monitor can be performed and/or implemented via one or more of a MSCD and a monitor device, among others. At 39010, input indicating a data search can be received. For example, the input indicating a data search can include one or more of a word, words, a phrase, a mood, a sentiment, a user profile, a portion of a user profile, a regular expression, a natural language filter, a grammar, a social group, an organization, and a user identification, among others. In one instance, the input indicating a data search can be received from a client via network 1010. In another instance, the input indicating a data search can be received from a MSCD via network 1010.

In one or more embodiments, the input indicating a data search can be or include search data. For example, the search data can include one or more of a word, words, a phrase, a mood, a sentiment, a user profile, a portion of a user profile, a regular expression, a natural language filter, a grammar, a social group, an organization, and a user identification, among others.

At 39020, it can be determined if there is additional search data. If there is additional search data, the method can proceed to 39010. If there is not additional search data, the method can proceed to 39030, where one or more queries can be generated. In one example, generating the one or more queries can include one or more monitor devices. In a second example, the one or more queries can be based on one or more of a monitor device, the user input indicating a data search (e.g., search data), and one or more social network media data sources that provide and/or receive user-provided data (e.g., user-provided communications, user input, user-provided content, social network user-provided data, social network user-provided content, etc.) from one or more users provided via one or more user computing devices, among others.

In a second example, generating the one or more queries can include configuring and/or implementing the one or more queries with one or more of a word, multiple words, a phrase, a mood, a sentiment, a user profile, a portion of a user profile, a regular expression, a natural language filter, a grammar, a social group, an organization, and a user identification, among others. In one instance, the one or more of the word, the multiple words, the phrase, the mood, the sentiment, the user profile, the portion of the user profile, the regular expression, the natural language filter, the grammar, the social group, the organization, and the user identification, among others, can match at least a portion of the user-provided data (e.g., user-provided communications, user input, user-provided content, social network user-provided data, social network user-provided content, etc.) from one or more users provided via one or more user computing devices and/or can produce one or more search results. In another instance, one or more search results can be produced, generated, and/or precipitated via a satisfaction and/or a statistical satisfaction of one or more criteria that can include and/or can be based on the one or more of the word, the multiple words, the phrase, the mood, the sentiment, the user profile, the portion of the user profile, the regular expression, the natural language filter, the grammar, the social group, the organization, and the user identification, among others.

In a third example, generating the one or more queries can include configuring and/or implementing the one or more queries with time information. In one instance, the time information can include one or more times of a day. In a second instance, the time information can include one or more amounts of time transpiring. In another example, generating the one or more queries can include configuring and/or implementing the one or more queries with graphical pattern information. In one instance, the graphical pattern information can be utilized in determining that the user-provided data includes one or more pictures, photographs, and representations, among others, of one or more portions of a human body (e.g., clothed, unclothed, etc.). In another instance, graphical pattern information can be utilized in determining that the user-provided data includes one or more pictures, photographs, and representations, among others, of a physical structure (e.g., a naturally occurring physical structure, a human-made physical structure, etc.).

At 39040, the one or more queries can be provided to one or more of a MSCD and a monitor device, among others. In one example, one or more of API servers 2020-2024 can provide the one or more queries to one or more of a MSCD and a monitor device, via network 1010. In a second example, one or more of application servers 2040-2050 can provide the one or more queries to one or more of a MSCD and a monitor device, via network 1010. In a third example, a MSCD can provide the one or more queries to a monitor device. In another example, one or more computing devices, described herein, can provide the one or more queries to one or more of a MSCD and a monitor device.

At 39050, one or more results of the one or more queries can be received. In one example, one or more of API servers 2020-2024 can receive one or more results of the one or more queries. In a second example, one or more of application servers 2040-2050 can receive one or more results of the one or more queries. In another example, a MSCD can receive one or more results of the one or more queries. For instance, MSCD 35050 can receive one or more results of the one or more queries of monitor device 35020.

In one or more embodiments, the one or more results of the one or more queries can be analyzed to provide analysis and/or conclusions about the one or more results of the one or more queries. For example, the one or more results can be filtered to provide filtered results and/or analysis of the one or more queries that include one or more of an identified word, phrase, user profile, portion of a user profile, regular expression, grammar, social group, organization, user identification, and a location, among others.

At 39060, one or more responses to the one or more results can be initiated. In one example, a response to the one or more results can include storing the one or more results. For instance, one or more databases (e.g., one or more of databases 2030-2034) can store the results. In a second example, a response to the one or more results can include signaling a computing device. For instance, MSCD 35050 can signal a computing device. In a third example, a response to the one or more results can include signaling a telecommunications device. For instance, MSCD 35050 can signal a telecommunications device.

In one or more embodiments, signaling a device (e.g., a computing device, a telecommunications device, etc.) can provide an alert associated with and/or corresponding to the one or more results of the one or more queries. In one example, signaling a device can provide an alert to a person that a communication to and/or from a social network occurred while no person was at a location (e.g., a residence, a place of business, a place of work, an apartment, a condominium, a house, etc.). In a second example, signaling a device can provide an alert to a person that a communication to and/or from a social network occurred during a period of time (e.g., 12:00 A.M. and 4:30 A.M., 10:00 A.M. and 2:47 P.M., etc.). In a third example, signaling a device can provide an alert to a person that a communication to and/or from a social network includes one or more graphical representations (e.g., picture(s), photo(s), motion picture(s), video(s), etc.) of one or more portions of a human body (e.g., clothed, unclothed, etc.).

In a fourth example, signaling a device can provide an alert to a person that a communication to and/or from a social network includes one or more graphical representations (e.g., picture(s), photo(s), motion picture(s), video(s), etc.) of one or more portions of a structure (e.g., a human-made structure, a naturally occurring structure, etc.). In a fifth example, signaling a device can providing a text message (e.g., an email, a text message, a short message service (SMS) message, etc.) to a device of a user (e.g., a parent, a manager, a custodian, a school administrator, a teacher, etc.). In another example, signaling a device can providing a sound and/or video message (e.g., a voice mail, a voice memo, a voice message, a sound message, a picture message, a video message, etc.) to a device of a user (e.g., a parent, a manager, a custodian, a school administrator, a teacher, etc.).

Turning now to FIG. 40, a method of censoring information of a communication is illustrated, according to one or more embodiments. In one or more embodiments, method elements 40010-40050 can be performed in accordance with respective method elements 39010-39050. In one or more embodiments, method elements 40060 and 40070 can be performed as one or more responses to results of the one or more queries.

In one or more embodiments, input indicating a data search, received at 40010, can include information of a communication that can be censored. In one example, information of a communication that can be censored can include one or more profanities. In a second example, information of a communication that can be censored can include one or more graphics and/or graphical representations (e.g., picture(s), photo(s), motion picture(s), video(s), etc.) of one or more portions of a structure (e.g., a human-made structure, a naturally occurring structure, etc.). In another example, information of a communication that can be censored can include one or more sounds.

At 40060, it can be determined if there is information of a communication to be censored. In one example, MSCD 35050 can determine if there is information of a communication to be censored. In another example, monitor device 35020 can determine if there is information of a communication to be censored. If there is information to be censored, the information can be censored at 40070. In one example, one or more profanities can be censored. In one instance, one or more words expressing and/or conveying one or more profanities can be redacted from a communication. In another instance, one or more words expressing and/or conveying confidential information can be redacted from a communication. In a second example, one or more sounds can be censored. In one instance, one or more sounds expressing and/or conveying one or more profanities can be redacted from a communication. In another instance, one or more sounds expressing and/or conveying confidential information can be redacted from a communication.

In another example, one or more graphics and/or graphical representations (e.g., picture(s), photo(s), motion picture(s), video(s), etc.) can be censored. In one instance, one or more graphics and/or graphical representations can be redacted and/or blanked out from a communication. For example, the one or more graphics and/or graphical representations can include one or more nude portions of a human body, and the one or more nude portions of a human body can be redacted and/or blanked out from the communication. In another instance, one or more graphics and/or graphical representations can express and/or convey confidential information can be redacted from a communication.

In one or more embodiments, the communication can be provided to a destination (e.g., a network, computing device, etc.) after information of the communication has been censored, at 40080. If there is no information to be censored, the communication can be provided to the destination at 40080.

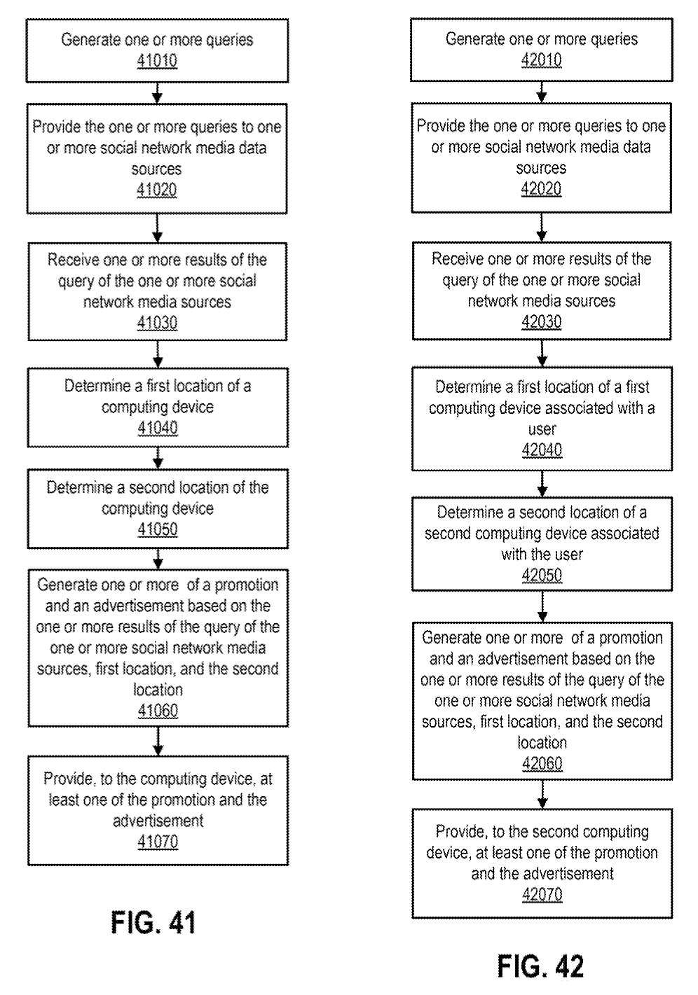

Turning now to FIG. 41, an exemplary method of providing one or more of an advertisement and promotion is illustrated, according to one or more embodiments. At 41010, one or more queries can be generated. In one example, generating the one or more queries can include multiple supported geographical search region shapes. For instance, a search region can include one or more shapes that are not supported by one or more social media data sources, and the multiple supported geographical search region shapes can include the one or more shapes that are not supported by one or more social network media data sources. In a second example, the one or more queries can be based on one or more of the search region, the user input indicating a data search (e.g., search data), and one or more social network media data sources that store user-provided data (e.g., user-provided communications, user input, user-provided content, social network user-provided data, social network user-provided content, etc.) from multiple users provided via multiple user computing devices at multiple locations, among others.

In a third example, the one or more queries can be based on one or more of the search region, the user input indicating a data search (e.g., search data), and one or more social network media data sources that store user-provided data (e.g., user-provided communications, user input, user-provided content, social network user-provided data, social network user-provided content, etc.) from a user provided via a computing device at multiple locations, among others. In another example, generating the one or more queries can include configuring and/or implementing the one or more queries with one or more of a word, multiple words, a phrase, a mood, a sentiment, a user profile, a portion of a user profile, a regular expression, a natural language filter, a grammar, a social group, an organization, and a user identification, among others.

In one instance, the one or more of the word, the multiple words, the phrase, the mood, the sentiment, the user profile, the portion of the user profile, the regular expression, the natural language filter, the grammar, the social group, the organization, and the user identification, among others, can match at least a portion of the user-provided data (e.g., user input, user-provided content, social network user-provided data, social network user-provided content) from multiple users provided via multiple user computing devices at multiple locations and/or can produce one or more search results. In a second instance, the one or more of the word, the multiple words, the phrase, the mood, the sentiment, the user profile, the portion of the user profile, the regular expression, the natural language filter, the grammar, the social group, the organization, and the user identification, among others, can match at least a portion of the user-provided data (e.g., user input, user-provided content, social network user-provided data, social network user-provided content) from the user provided via the computing devices at multiple locations and/or can produce one or more search results.

At 41020, the one or more queries can be provided to one or more social media data sources. At 41030, one or more results of the query of the one or more social media data sources can be received. In one or more embodiments, the one or more search results can be produced, generated, and/or precipitated via a satisfaction and/or a statistical satisfaction of one or more criteria that can include and/or can be based on one or more of a word, multiple words, a phrase, a mood, a sentiment, a user profile, a portion of a user profile, a regular expression, a natural language filter, a grammar, a social group, a organization, and a user identification, among others.

At 41040, a first location associated with a computing device can be determined. In one example, location 24120 associated with CD 1110 (as illustrated in FIG. 24) can be determined. In a second example, the first location associated with the computing device can be determined via the one or more results of the query of the one or more social media data sources. In another example, the first location associated with the computing device can be received via the computing device. For instance, the first location can be received from the computing device.

At 41050, a second location associated with the computing device can be determined. In one example, location 24120 associated with CD 1110 (as illustrated in FIG. 24) can be determined. In a second example, the second location associated with the computing device can be determined via the one or more results of the query of the one or more social media data sources. In another example, the second location associated with the computing device can be received via the computing device. For instance, the second location can be received from the computing device.

In one or more embodiments, the one or more of the word, the multiple words, the phrase, the mood, the sentiment, the user profile, the portion of the user profile, the regular expression, the natural language filter, the grammar, the social group, the organization, and the user identification, among others, can be cross-referenced with multiple locations. For example, the one or more of the word, the multiple words, the phrase, the mood, the sentiment, the user profile, the portion of the user profile, the regular expression, the natural language filter, the grammar, the social group, the organization, and the user identification, among others, can be cross-referenced with at least the first location and the second location.

At 41060, one or more of a promotion and an advertisement can be generated, based on the one or more results of the query of the one or more social media data sources, the first location, and the second location. At 41070, at least one of the promotion and the advertisement can be provided to the computing device. For example, the at least one of the promotion and the advertisement can be provided to the computing device via a network. In one or more embodiments, the at least one of the promotion and the advertisement can be provided to the computing device while the computing device is at the second location. In one or more embodiments, the promotion and the advertisement can be provided to the computing device after the computing device is no longer at the second location.

Turning now to FIG. 42, another exemplary method of providing one or more of an advertisement and promotion is illustrated, according to one or more embodiments. In one or more embodiments, method elements 42010-42030 can be performed as described with reference to method elements 41010-41030, respectively.

At 42040, a first location associated with a first computing device associated with a user can be determined. In one example, location 24120 associated with CD 1114 (as illustrated in FIG. 27) can be determined. In a second example, the first location associated with the first computing device can be determined via the one or more results of the query of the one or more social media data sources. In another example, the first location associated with the first computing device can be received via the first computing device. For instance, the first location can be received from the first computing device.

At 42050, a second location associated with a second computing device associated with the user can be determined. In one example, location 27120 associated with CD 1112 (as illustrated in FIG. 24) can be determined. For instance, the user can switch from utilizing CD 1114 to utilizing CD 1112. In a second example, the second location associated with the second computing device can be determined via the one or more results of the query of the one or more social media data sources. In another example, the second location associated with the second computing device can be received via the second computing device. For instance, the second location can be received from the second computing device.

In one or more embodiments, the one or more of the word, the multiple words, the phrase, the mood, the sentiment, the user profile, the portion of the user profile, the regular expression, the natural language filter, the grammar, the social group, the organization, and the user identification, among others, can be cross-referenced with multiple locations. For example, the one or more of the word, the multiple words, the phrase, the mood, the sentiment, the user profile, the portion of the user profile, the regular expression, the natural language filter, the grammar, the social group, the organization, and the user identification, among others, can be cross-referenced with at least the first location and the second location.

At 42060, one or more of a promotion and an advertisement can be generated, based on the one or more results of the query of the one or more social media data sources, the first location, and the second location. At 42070, at least one of the promotion and the advertisement can be provided to the second computing device. For example, the at least one of the promotion and the advertisement can be provided to the second computing device via a network. In one or more embodiments, the at least one of the promotion and the advertisement can be provided to the second computing device while the computing device is at the second location. In one or more embodiments, the promotion and the advertisement can be provided to the second computing device after the computing device is no longer at the second location.

In one or more embodiments, a computer system, a computing device, and/or a computer can be broadly characterized to include any device that includes a processor that executes instructions from a memory medium. For example, the term “memory medium” can mean a “memory”, a “memory device”, “storage device”, and/or “tangible computer readable storage medium”. In one instance, one or more of a “memory”, a “memory device”, “storage device” and “tangible computer readable storage medium” can include volatile storage such as random access memory (RAM), SRAM (static RAM), DRAM (dynamic RAM), EDO RAM (extended data out RAM), Rambus RAM, etc. In another instance, one or more of a “memory”, a “memory device”, and “tangible computer readable storage medium” can include nonvolatile storage such as a ROM (read only memory), a PROM (programmable ROM), an EPROM (erasable PROM), an EEPROM (electrically erasable PROM), flash memory, NVRAM (non-volatile RAM), FRAM (ferroelectric RAM), a CD-ROM, a DVD-ROM, a floppy disk, a magnetic tape, a magnetic media (e.g., a hard drive), optical storage, etc. In one or more embodiments, a memory medium can include one or more volatile storages and/or one or more nonvolatile storages.

In one or more embodiments, a processor (e.g., a central processing unit or CPU) can execute instructions from a memory medium that stores the instructions that can include one or more software programs in accordance with one or more of methods, processes and/or flowcharts described herein. In one example, the processor and the memory medium, that stores the instructions which can include one or more software programs in accordance with one or more of methods, processes and/or flowcharts described herein, can form one or more means for one or more functionalities described with references to methods, processes and/or flowcharts herein. In a second example, a GPU and the memory medium, that stores the instructions which can include one or more software programs in accordance with one or more of methods, processes and/or flowcharts described herein, can form one or more means for one or more functionalities described with references to methods, processes and/or flowcharts herein.

In a third example, a FPGA can be configured with one or more configurations in accordance with one or more of methods, processes and/or flowcharts described herein, that can form one or more means for one or more functionalities described with references to methods, processes and/or flowcharts herein. In a fourth example, an ASIC and the memory medium, that stores the instructions which can include one or more software programs in accordance with one or more of methods, processes and/or flowcharts described herein, can form one or more means for one or more functionalities described with references to methods, processes and/or flowcharts herein. In a fifth example, an ASIC can be configured with one or more configurations in accordance with one or more of methods, processes and/or flowcharts described herein, that can form one or more means for one or more functionalities described with references to methods, processes and/or flowcharts herein.

In a sixth example, an ASIC and the memory medium, that stores the instructions which can include one or more software programs in accordance with one or more of methods, processes and/or flowcharts described herein, can form one or more means for one or more functionalities described with references to methods, processes and/or flowcharts herein. In another example, the memory medium, that stores the instructions which can include one or more software programs in accordance with one or more of methods, processes and/or flowcharts described herein, can include, implement, and/or form an article of manufacture. When terms are used in this disclosure in the singular they shall be deemed to include the plural when applicable, and when used herein in the plural to include the singular when applicable.

One or more of the method elements described herein and/or one or more portions of an implementation of a method element can be repeated, can be performed in varying orders, can be performed concurrently with one or more of the other method elements and/or one or more portions of an implementation of a method element, or can be omitted, according to one or more embodiments. In one or more embodiments, concurrently can mean simultaneously. In one or more embodiments, concurrently can mean apparently simultaneously according to some metric. For example, two tasks can be context switched such that they appear to be simultaneous to a human. In one instance, a first task of the two tasks can include a first method element and/or a first portion of a first method element. In a second instance, a second task of the two tasks can include a second method element and/or a first portion of a second method element. In another instance, a second task of the two tasks can include the first method element and/or a second portion of the first method element. Further, one or more of the system elements described herein can be omitted and additional system elements can be added as desired, according to one or more embodiments. Moreover, supplementary, additional, and/or duplicated method elements can be instantiated and/or performed as desired, according to one or more embodiments.

One or more modifications and/or alternatives of the embodiments described herein may be apparent to those skilled in the art in view of this description. Hence, descriptions of the embodiments, described herein, are to be taken and/or construed as illustrative and/or exemplary only and are for the purpose of teaching those skilled in the art the general manner of carrying out methods, processes, and/or systems described herein. In one or more embodiments, one or more materials and/or elements can be swapped or substituted for those illustrated and described herein. In one or more embodiments, one or more parts and/or processes can be reversed, and/or certain one or more features of the described one or more embodiments can be utilized independently, as would be apparent to one skilled in the art after having the benefit of this description.

What is claimed is:

1. A system, comprising:
a processor;
a network interface, coupled to the processor and configured to be coupled to a network; and
a memory device coupled to the processor, wherein the memory device stores instructions that are executed by the processor, wherein the system:
receives, via a network, search data from a first computing device;
determines a first location of a second computing device;
associates a first geographical search region with the second computing device and the first location;
generates at least a first query based on the first geographical search region that is associated with the first location, the search data, and at least one social network media data source, wherein the at least one social network media source is configured to store user-provided data from a plurality of users provided via a plurality of computing devices at a plurality of locations;
provides, via the network, the at least the first query to the at least one social network media data source;
receives, from the at least one social network media data source via the network, at least a first result based on the at least the first query and based on the user-provided data provided within the first geographical search region associated with the first location to the at least one social network media data source;
provides the at least the first result to the first computing device;
determines a first change of location of the second computing device, from the first location to a second location;
associates a second geographical search region with the second computing device and the second location;
generates at least a second query based on: the second geographical search region that is associated with the second location, the search data, and the at least one social network media data source;
provides, via the network, the at least the second query to the at least one social network media data source; and
receives, from the at least one social network media data source via the network, at least a second result based on the at least the second query and based on the user-provided data provided within the second geographical search region associated with the second location to the at least one social network media data source.

2. The system of claim 1, wherein the system further:
tracks a plurality of changes of locations of the second computing device;
associates a third geographical search region with the second computing device and each location of the plurality of locations;
generates a plurality of queries based on the third geographical search region associated with each location of the plurality of locations, the search data, and the at least one social network media data source;
provides, via the network, the plurality of queries to the at least one social network media data source; and
receives, from the at least one social network media data source via the network, one or more results based on the plurality of queries and based on the user-provided data provided within the third geographical search region at each location of the plurality of locations to the at least one social network media data source.

3. The system of claim 1, wherein the system further:
provides a map to a user;
provides, via the map, at least the second location; and
provides, via the map, at least location-based data stored at the at least one social network media data source, wherein the at least location-based data corresponds to the at least the second result based on the at least the second query and the second location.

4. The system of claim 1, wherein the system further:
provides a map to a user; and
provides, via the map, at least a third location;
wherein the third location corresponds to the at least the second result based on the at least the second query and location-based data stored via the at least one social network media data source.

5. The system of claim 1,
wherein, when the system generates the at least a second query, the system generates the at least a second query based on: the first geographical search region that is associated with the first location, the second geographical search region that is associated with the second location, the search data, and the at least one social network media data source; and
wherein the at least the second result is based on the at least the second query and based on the user-provided data provided within both, the first geographical search region associated with the first location and the second geographical search region associated with the second location, to the at least one social network media data source.

6. The system of claim 5, wherein, when the system generates the at least the second query, the system generates the at least the second query based on: the first geographical search region that is associated with the first location, a first time that the second computing device is determined to be at the first location, the second geographical search region that is associated with the second location, a second time that the second computing device is determined to be at the second location, the search data, and the at least one social network media data source.

7. The system of claim 1,
wherein the second result includes information associated with a third computing device located at the second location; and
wherein the system further:
determines a second change of location of the third computing device, from the second location to a third location;
associates a third geographical search region with the third computing device and the third location;
generates at least a third query that is based on: the third geographical search region associated with the third location, the search data, and the at least one social network media data source;
provides, via the network, the at least the third query to the at least one social network media data source; and
receives, from the at least one social network media data source via the network, at least a third result based on the at least the third query and based on the user-provided data within the second geographical search region to the at least one social network media data source.

8. The system of claim 7, wherein the system further:
provides a map to a user; and
provides, via the map, at least the third location;
wherein the third location corresponds to the at least the third result based on the at least the third query and based on location-based data stored via the at least one social network media data source.

9. The system of claim 8, wherein the system further:
provides, via the map, the second location;
wherein the second location corresponds to the at least the first result based on the at least the first query and based on location-based data stored via the at least one social network media data source.

10. The system of claim 1,
wherein the at least the second query is configured with at least one of a word, a plurality of words, a phrase, a user profile, a portion of a user profile, a regular expression, a natural language filter, a grammar, a social group, an organization, and a user identification;
wherein at least a portion of the user-provided data from the plurality of users corresponds to the at least the first result and at least one of the word, the plurality of words, the phrase, the user profile, the portion of the user profile, the regular expression, the natural language filter, the grammar, the social group, the organization, and the user identification; and
wherein the at least the second result is based on the at least the portion of the user-provided data from the plurality of users that corresponds to the at least the second result and the at least one of the word, the plurality of words, the phrase, the user profile, the portion of the user profile, the regular expression, the natural language filter, the grammar, the social group, the organization, and the user identification.

11. The system of claim 10,
wherein the grammar includes at least one of a set of formation rules for strings in a language, a context-free grammar, a regular grammar, a tree-adjoining grammar, an affix grammar, an attribute grammar, an adaptive grammar, an ambiguous grammar, and a categorical grammar; and
wherein the user profile includes at least one of a user name, the user identification, a mobile telephone number, an email address, a physical address, an occupation, a gender, a marital status, a past purchase, an interest, a past transaction, a shoe size, an age, a clothing size, a political affiliation, a monthly income, a yearly income, an employment status, a credit history, a credit rating, an eye color, a hair color, a music genre, and a membership.

12. The system of claim 1,
wherein the second geographical search region includes an unsupported geographical search region shape; and
wherein the at least the second query includes a plurality of supported geographical search region shapes, wherein the plurality of supported geographical search region shapes include the unsupported geographical search region shape.

13. The system of claim 1, wherein, when the system associates the first geographical search region with the second computing device and the first location, the system associates the first geographical search region with at least one of a user identification and a user account of a user of the second computing device.

14. The system of claim 1,
wherein the at least the first query is further based on at least an amount of time transpiring; and
wherein the at least the first query expires after the amount of time transpires.

15. The system of claim 14, wherein the at least the amount of time transpiring corresponds to the first change of location of the second computing device.

16. The system of claim 1, wherein the user-provided data includes at least one post to the at least one social network service.

17. The system of claim 1, wherein the user-provided data stored via the at least one social network media data source includes user input from the plurality of users utilizing at least one of Facebook, Twitter, YouTube, Weibo, a blog, a wiki, Foursquare, Instagram, Flickr, Vimeo, and Yelp.

18. The system of claim 1, wherein the first geographical search region is the second geographical search region.

19. The system of claim 1, wherein the search data includes at least identification information that indicates at least one of the second computing device and a user of the second computing device.

20. A method, comprising:
receiving search data at a first computing device;
determining a first location of a second computing device;
associating a first geographical search region with the second computing device and the first location;
generating at least a first query based on the first geographical search region that is associated with the first location, the search data, and at least one social network media data source, wherein the at least one social network media source is configured to store user-provided data from a plurality of users provided via a plurality of computing devices at a plurality of locations;
providing, via a network, the at least the first query to the at least one social network media data source;
receiving, from the at least one social network media data source via the network, at least a first result based on the at least the first query and based on the user-provided data provided within the first geographical search region associated with the first location to the at least one social network media data source;
determining a first change of location of the second computing device, from the first location to a second location;
associating a second geographical search region with the second computing device and the second location;
generating at least a second query based on: the second geographical search region that is associated with the second location, the search data, and the at least one social network media data source;
providing, via the network, the at least the second query to the at least one social network media data source; and
receiving, from the at least one social network media data source via the network, at least a second result based on the at least the second query and based on the user-provided data provided within the second geographical search region associated with the second location to the at least one social network media data source.

21. The method of claim 20, further comprising:
tracking a plurality of changes of locations of the second computing device;
associating a third geographical search region with the second computing device and each location of the plurality of locations;
generating a plurality of queries based on the third geographical search region associated with each location of the plurality of locations, the search data, and the at least one social network media data source;
providing, via the network, the plurality of queries to the at least one social network media data source; and
receiving, from the at least one social network media data source via the network, one or more results based on the plurality of queries and based on the user-provided data provided within the third geographical search region at each location of the plurality of locations to the at least one social network media data source.

22. The method of claim 20, further comprising:
providing a map to a user;
providing, via the map, at least the second location; and
providing, via the map, at least location-based data stored at the at least one social network media data source, wherein the at least location-based data corresponds to the at least the second result based on the at least the second query and the second location.

23. The method of claim 20, further comprising:
providing a map to a user; and
providing, via the map, at least a third location;
wherein the third location corresponds to the at least the second result based on the at least the second query and location-based data stored via the at least one social network media data source.

24. The method of claim 20,
wherein generating the at least a second query includes generating the at least a second query based on the first geographical search region that is associated with the first location, the second geographical search region that is associated with the second location, the search data, and the at least one social network media data source; and
wherein the at least the second result is based on the at least the second query and based on the user-provided data provided from within both the first geographical search region associated with the first location and the second geographical search region associated with the second location to the at least one social network media data source.

25. The method of claim 24, wherein generating the at least the second query includes generating the at least the second query based on: the first geographical search region that is associated with the first location, a first time that the second computing device is determined to be at the first location, the second geographical search region that is associated with the second location, a second time that the second computing device is determined to be at the second location, the search data, and the at least one social network media data source.

26. The method of claim 20, wherein the second result includes information associated with a third computing device located at the second location;
the method further comprising:
determining a second change of location of the third computing device, from the second location to a third location;
associating a third geographical search region with the third computing device and the third location;
generating at least a third query that is based on the third geographical search region associated with the third location, the search data, and the at least one social network media data source;
providing, via the network, the at least the third query to the at least one social network media data source; and
receiving, from the at least one social network media data source via the network, at least a third result based on the at least the third query and based on the user-provided data within the second geographical search region to the at least one social network media data source.

27. The method of claim 26, further comprising:
providing a map to a user; and
providing, via the map, at least the third location;
wherein the third location corresponds to the at least the third result based on the at least the third query and based on location-based data stored via the at least one social network media data source.

28. The method of claim 27, further comprising:
providing, via the map, the second location;
wherein the second location corresponds to the at least the first result based on the at least the first query and based on location-based data stored via the at least one social network media data source.

29. The method of claim 20,
wherein the at least the second query is configured with at least one of a word, a plurality of words, a phrase, a user profile, a portion of a user profile, a regular expression, a natural language filter, a grammar, a social group, an organization, and a user identification;
wherein at least a portion of the user-provided data from the plurality of users corresponds to the at least the first result and at least one of the word, the plurality of words, the phrase, the user profile, the portion of the user profile, the regular expression, the natural language filter, the grammar, the social group, the organization, and the user identification; and
wherein the at least the second result is based on the at least the portion of the user-provided data from the plurality of users that corresponds to the at least the second result and the at least one of the word, the plurality of words, the phrase, the user profile, the portion of the user profile, the regular expression, the natural language filter, the grammar, the social group, the organization, and the user identification.

30. The method of claim 29,
wherein the grammar includes at least one of a set of formation rules for strings in a language, a context-free grammar, a regular grammar, a tree-adjoining grammar, an affix grammar, an attribute grammar, an adaptive grammar, an ambiguous grammar, and a categorical grammar; and
wherein the user profile includes at least one of a user name, the user identification, a mobile telephone number, an email address, a physical address, an occupation, a gender, a marital status, a past purchase, an interest, a past transaction, a shoe size, an age, a clothing size, a political affiliation, a monthly income, a yearly income, an employment status, a credit history, a credit rating, an eye color, a hair color, a music genre, and a membership.

31. The method of claim 20,
wherein the second geographical search region includes an unsupported geographical search region shape; and
wherein the at least the second query includes a plurality of supported geographical search region shapes, wherein the plurality of supported geographical search region shapes include the unsupported geographical search region shape.

32. The method of claim 20, wherein associating the first geographical search region with the second computing device and the first location includes associating the first geographical search region with at least one of a user identification and a user account of a user of the second computing device.

33. The method of claim 20,
wherein the at least the first query is further based on at least an amount of time transpiring; and
wherein the at least the first query expires after the amount of time transpires.

34. The method of claim 33, wherein the at least the amount of time transpiring corresponds to the first change of location of the second computing device.

35. The method of claim 20, wherein the user-provided data includes at least one post to the at least one social network service.

36. The method of claim 20, wherein the user-provided data stored via the at least one social network media data source includes user input from the plurality of users utilizing at least one of Facebook, Twitter, YouTube, Weibo, a blog, a wiki, Foursquare, Instagram, Flickr, Vimeo, and Yelp.

37. The method of claim 20, wherein the first geographical search region is the second geographical search region.

38. The method of claim 20, wherein the search data includes at least identification information that indicates at least one of the second computing device and a user of the second computing device.

39. The method of claim 20, wherein the first computing device performs the steps of the receiving the search data, determining the first location, associating the first geographical search region, generating the at least the first query, providing the at least the first query, and receiving the at least the first result.

40. A computer readable memory device that stores instructions, which when executed by a processor, the processor:
receives, via a network, search data from a first computing device;
determines a first location of a second computing device;
associates a first geographical search region with the second computing device and the first location;
generates at least a first query based on the first geographical search region that is associated with the first location, the search data, and at least one social network media data source, wherein the at least one social network media source is configured to store user-provided data from a plurality of users provided via a plurality of computing devices at a plurality of locations;
provides, via the network, the at least the first query to the at least one social network media data source;
receives, from the at least one social network media data source via the network, at least a first result based on the at least the first query and based on the user-provided data provided within the first geographical search region associated with the first location to the at least one social network media data source;
provides the at least the first result to the first computing device;
determines a first change of location of the second computing device, from the first location to a second location;
associates a second geographical search region with the second computing device and the second location;
generates at least a second query based on: the second geographical search region that is associated with the second location, the search data, and the at least one social network media data source;
provides, via the network, the at least the second query to the at least one social network media data source; and
receives, from the at least one social network media data source via the network, at least a second result based on the at least the second query and based on the user-provided data provided within the second geographical search region associated with the second location to the at least one social network media data source.

41. The computer readable memory device of claim 40, wherein the processor further:
tracks a plurality of changes of locations of the second computing device;
associates a third geographical search region with the second computing device and each location of the plurality of locations;
generates a plurality of queries based on the third geographical search region associated with each location of the plurality of locations, the search data, and the at least one social network media data source;
provides, via the network, the plurality of queries to the at least one social network media data source; and
receives, from the at least one social network media data source via the network, one or more results based on the plurality of queries and based on the user-provided data provided within the third geographical search region at each location of the plurality of locations to the at least one social network media data source.

42. The computer readable memory device of claim 40, wherein the processor further:
provides a map to a user;
provides, via the map, at least the second location; and
provides, via the map, at least location-based data stored at the at least one social network media data source, wherein the at least location-based data corresponds to the at least the second result based on the at least the second query and the second location.

43. The computer readable memory device of claim 40, wherein the processor further:
provides a map to a user; and
provides, via the map, at least a third location;
wherein the third location corresponds to the at least the second result based on the at least the second query and location-based data stored via the at least one social network media data source.

44. The computer readable memory device of claim 40,
wherein, when the system generates the at least a second query, the system generates the at least a second query based on: the first geographical search region that is associated with the first location, the second geographical search region that is associated with the second location, the search data, and the at least one social network media data source; and
wherein the at least the second result is based on the at least the second query and based on the user-provided data provided within both, the first geographical search region associated with the first location and the second geographical search region associated with the second location, to the at least one social network media data source.

45. The computer readable memory device of claim 44, wherein, when the system generates the at least the second query, the system generates the at least the second query based on: the first geographical search region that is associated with the first location, a first time that the second computing device is determined to be at the first location, the second geographical search region that is associated with the second location, a second time that the second computing device is determined to be at the second location, the search data, and the at least one social network media data source.

46. The computer readable memory device of claim 40,
wherein the second result includes information associated with a third computing device located at the second location; and
wherein the processor further:
determines a second change of location of the third computing device, from the second location to a third location;
associates a third geographical search region with the third computing device and the third location;
generates at least a third query that is based on: the third geographical search region associated with the third location, the search data, and the at least one social network media data source;
provides, via the network, the at least the third query to the at least one social network media data source; and
receives, from the at least one social network media data source via the network, at least a third result based on the at least the third query and based on the user-provided data within the second geographical search region to the at least one social network media data source.

47. The computer readable memory device of claim 46, wherein the processor further:
provides a map to a user; and
provides, via the map, at least the third location;
wherein the third location corresponds to the at least the third result based on the at least the third query and based on location-based data stored via the at least one social network media data source.

48. The computer readable memory device of claim 47, wherein the processor further:
provides, via the map, the second location;
wherein the second location corresponds to the at least the first result based on the at least the first query and based on location-based data stored via the at least one social network media data source.

49. The computer readable memory device of claim 40,
wherein the at least the second query is configured with at least one of a word, a plurality of words, a phrase, a user profile, a portion of a user profile, a regular expression, a natural language filter, a grammar, a social group, an organization, and a user identification;
wherein at least a portion of the user-provided data from the plurality of users corresponds to the at least the first result and at least one of the word, the plurality of words, the phrase, the user profile, the portion of the user profile, the regular expression, the natural language filter, the grammar, the social group, the organization, and the user identification; and
wherein the at least the second result is based on the at least the portion of the user-provided data from the plurality of users that corresponds to the at least the second result and the at least one of the word, the plurality of words, the phrase, the user profile, the portion of the user profile, the regular expression, the natural language filter, the grammar, the social group, the organization, and the user identification.

50. The computer readable memory device of claim 49,
wherein the grammar includes at least one of a set of formation rules for strings in a language, a context-free grammar, a regular grammar, a tree-adjoining grammar, an affix grammar, an attribute grammar, an adaptive grammar, an ambiguous grammar, and a categorical grammar; and
wherein the user profile includes at least one of a user name, the user identification, a mobile telephone number, an email address, a physical address, an occupation, a gender, a marital status, a past purchase, an interest, a past transaction, a shoe size, an age, a clothing size, a political affiliation, a monthly income, a yearly income, an employment status, a credit history, a credit rating, an eye color, a hair color, a music genre, and a membership.

51. The computer readable memory device of claim 40,
wherein the second geographical search region includes an unsupported geographical search region shape; and
wherein the at least the second query includes a plurality of supported geographical search region shapes, wherein the plurality of supported geographical search region shapes include the unsupported geographical search region shape.

52. The computer readable memory device of claim 40, wherein, when the processor associates the first geographical search region with the second computing device and the first location, the processor associates the first geographical search region with at least one of a user identification and a user account of a user of the second computing device.

53. The computer readable memory device of claim 47,
wherein the at least the first query is further based on at least an amount of time transpiring; and
wherein the at least the first query expires after the amount of time transpires.

54. The computer readable memory device of claim 47, wherein the at least the amount of time transpiring corresponds to the first change of location of the second computing device.

55. The computer readable memory device of claim 40, wherein the user-provided data includes at least one post to the at least one social network service.

56. The computer readable memory device of claim 40, wherein the user-provided data stored via the at least one social network media data source includes user input from the plurality of users utilizing at least one of Facebook, Twitter, YouTube, Weibo, a blog, a wiki, Foursquare, Instagram, Flickr, Vimeo, and Yelp.

57. The computer readable memory device of claim 40, wherein the first geographical search region is the second geographical search region.

58. The computer readable memory device of claim 40, wherein the search data includes at least identification information that indicates at least one of the second computing device and a user of the second computing device.
